(19) United States
(12) Patent Application Publication
(10) Pub. No.: US 2025/0144776 A1
(43) Pub. Date: May 8, 2025

(54) AUTOMATIC DIRECTION CHANGE PENDULUM-TYPE ROTARY DRIVE GEAR RATCHET TENSIONER FOR INDIRECT LIVE WIRE WITH UNLIMITED TENSION DISTANCE CONTROL AND INDIRECT LIVE WIRE NON-POWER DISTRIBUTION METHOD USING SAME

(71) Applicants: DAEWON ELECTRIC CO.,LTD., Cheongju-si (KR); DAEWON INDUSTRY COMPANY, Jeungpyeong-gun (KR)

(72) Inventor: Sae Won KWON, Jeungpyeong-gun (KR)

(21) Appl. No.: 19/015,757

(22) Filed: Jan. 10, 2025

Related U.S. Application Data
(63) Continuation of application No. PCT/KR2023/008804, filed on Jun. 26, 2023.

(30) Foreign Application Priority Data
Jul. 21, 2022 (KR) 10-2022-0090023

(51) Int. Cl. B25B 25/00

(52) U.S. Cl. CPC B25B 25/00

(57) ABSTRACT

Provided is a gear ratchet tensioner for indirect live wire and an indirect live wire non-power distribution method and, more specifically, to an automatic direction switching pendulum-type rotary drive gear ratchet tensioner for indirect live wire and an indirect live wire non-power distribution method using the same, wherein the automatic forward or reverse rotation of a roller shaft can be carried out by simply operating a rotary lever using a stick for indirect live wire, and accordingly, indirect live wire work from the wire in the live wire condition enables safe wiring work such as wire electric dip adjustment work, electric wire installation work, and suspension insulator replacement work, etc. and the roller shaft is formed to be driven by a backstop ratchet ring operated by a multi-angle bundle pearl to strongly prevent a reverse direction and prevent backlash during a reverse rotation driving process to enable strong rotation driving.

### TECHNICAL FIELD

The present invention relates to a gear ratchet tensioner for indirect live wire work and an uninterruptible power distribution method for indirect live wire work, and more particularly, to an automatic direction switching pendulum-type rotary drive gear ratchet tensioner having an unlimited tension distance adjustment function for indirect live wire work and an uninterruptible power distribution method of performing indirect live wire work using the same, configured to automatically adjust, without a separate rotational direction switching operation, a rotation direction by simply operating a rotary lever using a stick for indirect live wire work so as to pull or release an insulating rope without any limitations on the length of the rope through a gear roller and to prevent reverse rotation, wherein the gear ratchet tensioner is used to safely install or remove a suspension insulator and to perform wiring work on an electric wire in a live wire state without any limitations on the tension distance through the indirect live wire work.

### BACKGROUND ART

In general, live wire work refers to line work conducted in a state in which power transmission is continuously performed through a line without a power outage on the line. Meanwhile, since the risk of safety incidents is very high during live wire work, live wire work is conducted by a trained worker with strict adherence to specific safety and insulation standards only when it is difficult to cut off power. More specifically, when it is difficult to stop operation of transmission and distribution facilities and the like, live wire work is conducted by a trained worker. Here, the trained worker is required to use insulating protective equipment or protective equipment.

Live wire work on the electric line is divided into direct live wire work and indirect live wire work. Indirect live wire work is a method of conducting live wire work indirectly using an insulating tool such as a stick. Although indirect live wire work is safe, there is a disadvantage of being labor intensive.

In addition, direct live wire work is a method in which a worker wears an insulated glove in an insulated bucket and works in direct contact with an electric wire in a live wire state. While direct live wire work is simple and saves working time, there is a disadvantage in that the worker is exposed to a high risk of electric shock, which often causes serious injury. Live wire work includes inspection, repair, replacement, and cleaning of a wire component such as a suspension insulator. Depending on the types of live wire work, either a direct live wire work method or an indirect live wire work method may be appropriately used.

Meanwhile, utilization of a wire grip is high in various types of live wire work. The wire grip is a device configured to pull or release, during live wire work, a wire in order to obtain an appropriate dip of the wire at the time of performing a dip adjustment process of the wire and wiring work. Here, the wire grip has a drum configured for a belt to be wound therearound or for the belt to be unwound therefrom by forward and reverse rotation of the drum. An appropriate dip of a wire may be obtained through operation of the drum.

However, the conventional tensioner has a problem in that the working distance is limited because the length of a belt wound around a drum is limited to about 1 m.

Therefore, in order to address the above-mentioned problems, the applicant of the present invention has proposed a gear tensioner capable of freely adjusting a length of an insulating rope, thereby making it possible to stretch a wire, connect wires to each other, and adjust tension of a wire without any limitations on the working distance.

However, the conventional gear tensioner as described above is required to perform the operation of a reverse rotation prevention part forming a separate pawl key structure so as to control forward or reverse rotation of a roller. Accordingly, operation of the gear tensioner is significantly inconvenient, and a worker needs to perform operation in close proximity to the wire. In consideration of these circumstances, there is a problem in that a worker is exposed to safety hazards.

In addition, since an insulating rope is configured to simply pass through a roller, a worker needs to adjust tension of the insulating rope by pulling or releasing the insulating rope. Accordingly, a worker has considerable fatigue during tension adjustment of the insulating rope, and there is a limitation on tension adjustment of the insulating rope. Furthermore, the conventional gear tensioner may not be used for indirect live wire work.

### RELATED ART DOCUMENT

### Patent Document

(Patent Document 1) Korean Patent No. 10-1179056
(Patent Document 2) Korean Patent No. 10-2303614

### DISCLOSURE

### Technical Problem

Therefore, the present invention has been made in view of the above problems, and it is an object of the present invention to provide an automatic direction switching pendulum-type rotary drive gear ratchet tensioner having an unlimited tension distance adjustment function for indirect live wire work and an uninterruptible power distribution method of performing indirect live wire work using the same, configured to adjust, when an insulating rope is pulled or released by a gear roller of a tensioner without limitation, forward or reverse rotation for pulling or releasing the insulating rope by operating an automatic reversing pawl and a roller shaft operating plate in accordance with reciprocating pendulum motion of a pendulum, thereby enabling forward or reverse rotation of a roller shaft to be automatically performed by operating a rotary lever using a stick for indirect live wire work. In this manner, while the indirect live wire work is conducted on a wire in a state in which power transmission is continuously performed through the wire, a dip of the wire may be appropriately adjusted, the wire may be pulled by the tensioner so as to obtain an appropriate dip of the wire and may be installed on an electric pole, and suspension insulator replacement work may be reliably performed with unlimited tension control, thereby making it possible to stably perform wiring work using the automatic direction switching pendulum-type rotary drive gear ratchet tensioner.

It is another object of the present invention to provide an automatic direction switching pendulum-type rotary drive gear ratchet tensioner having an unlimited tension distance adjustment function for indirect live wire work and an uninterruptible power distribution method of performing indirect live wire work using the same, configured to provide a roller shaft driven by a backstop ratchet ring operated by a multi-angle bundle pawl, thereby making it possible not only to reliably prevent reverse rotation, but also to perform stable rotational driving by preventing backlash occurrence during reverse rotational driving.

### Technical Solution

In accordance with an aspect of the present invention, the above and other objects can be accomplished by the provision of an automatic direction switching pendulum-type rotary drive gear ratchet tensioner including a body formed of front and rear support plates so as to be formed open to an upper side, a lower side, and one side of the body, wherein an idle gear and an interlocking gear having a support roller are engaged with each other and are axially installed at a front middle part and one side of the front support plate, the body including an insulating rope connection part formed on one end of the body and a hook formed on the other end of the body, upper and lower guide rollers respectively formed on upper and lower portions of the one side of the body, and a lever installation part disposed on a front side of the one side of the body, the lever installation part being configured to restrict the idle gear and the interlocking gear,
a rotary operating lever including a rotary operating shaft, a cam, a rotary operating mechanism, and a buffer key, wherein the rotary operating shaft is axially installed in the lever installation part and has a rotary ring, wherein the cam is disposed at a tip portion of the rotary operating shaft and is formed at a location eccentric from a central portion of the tip portion, wherein the rotary operating mechanism is rotatably coupled to the rotary operating shaft at a rear side of the cam, has a movable long hole formed in a circumferential direction thereof, and has a locking protrusion formed to protrude from a circumference thereof, and wherein the buffer key connects the rotary operating shaft to the rotary operating mechanism,
a gear roller formed between the front and rear support plates and disposed on the other side of the body, wherein the gear roller is axially installed on a roller shaft protruding forwards from the body, has an insulating rope guide groove formed in a circumference of a middle portion thereof, and has insulating rope pressurization protrusions respectively formed on opposite inner sides of the gear roller,
a clutch part disposed on the front side of the body and coupled to a circumference of the roller shaft, wherein the clutch part conducts forward or reverse rotation of the roller shaft by preventing reverse rotation of an inner ring and simultaneously performing reverse rotation of the inner ring and an outer ring,
a roller shaft operating plate disposed on a front side of the clutch part and coupled to the circumference of the roller shaft, wherein the roller shaft operating plate has saw teeth formed on a circumference of a middle portion thereof,
a pendulum coupled to a rear side of the roller shaft operating plate and formed to protrude toward one side thereof so as to have a horizontal long hole configured to accommodate the cam therein, wherein the pendulum performs reciprocating pendulum motion relative to the roller shaft by operation of the cam and has an automatic revering pawl mounting groove formed in a front surface thereof and disposed between the rotary operating shaft and the roller shaft operating plate,
a roller shaft support plate formed to penetrate a front circumference of the roller shaft operating plate and coupled to the pendulum, wherein the roller shaft support plate is formed to protrude toward one side thereof,
an automatic reversing pawl having a pawl shaft coupled to the automatic revering pawl mounting groove, wherein the automatic reversing pawl interferes with the roller shaft operating plate and performs reciprocating motion thereof so as to provide forward or reverse rotational force of the roller shaft operating plate,
a pawl reversing key coupled to the pawl shaft with the automatic reversing pawl and formed to protrude from the roller shaft support plate toward one side thereof, wherein the pawl reversing key interferes with the locking protrusion during rotation of the rotary operating mechanism so as to provide reciprocating rotational force of the automatic reversing pawl, and wherein the pawl reversing key has first and second reversing key spring balls installed thereon so as to constantly maintain horizontality thereof, wherein the first and second reversing key spring balls are formed to be symmetrical relative to the pawl shaft,
a roller shaft rotary lever disposed on a front side of the roller shaft operating plate and coupled to the roller shaft and the roller shaft operating plate,
an insulating rope configured to enter the one side of the body and to be withdrawn from the body via the gear roller, the insulating rope being fixedly connected to the insulating rope connection part, and
a wire clip configured for the insulating rope withdrawn from the body to pass therethrough, the wire clip being configured to grip a wire.

An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner is used to perform relocation of an electric pole, replacement of the electric pole, and change of an electric pole route in a state in which power transmission is continuously performed through a wire, the uninterruptible power distribution method including the steps of
performing, within a work section, installation of a new electric pole, installation of components mounted on the new electric pole, and installation of the wire on the new electric pole in a state in which power transmission is not performed through the wire so as to prepare for wiring work in the state in which power transmission is continuously performed through the wire,
respectively fixing, to arm-shaped support members, hooks of automatic direction switching pendulum-type rotary drive gear ratchet tensioners having an unlimited tension distance adjustment function for indirect live wire work, each of the gear ratchet tensioners being configured to maintain tension of the wire located between start and end electric poles in the work section, and respectively installing wire clips of the gear ratchet tensioners on wires to be removed located between the start and end electric poles and located in a region allowing removal of the wires to be removed in the state in which power transmission is not performed through the wire,
connecting one side of each of bypass jumper means to a corresponding one of opposite ends of the wires to be removed in the work section, and connecting the other side of each of the bypass jumper means to a corresponding one of old wires respectively located outside the start and end electric poles, thereby connecting the wires to be removed and the old wires to each other through the respective bypass jumper means,
sequentially separating jumper wires of the start and end electric poles in the work section, respectively separating the wires to be removed located between the start and end electric poles from respective portions of the wires to be removed, the respective portions having the wire clips of the gear ratchet tensioners installed thereon, and securing a safe work space in the state in which power transmission is not performed through the wire,
stretching new wires, pulling the new wires to obtain an appropriate dip of each of the new wires, and respectively fixing the new wires to the start and end electric poles,
sequentially connecting, to the respective old wires, new jumper wires of the new wires connected to the start and end electric poles in the work section, and separating the installed bypass jumper means, and
removing the wires to be removed respectively tensioned by the gear ratchet tensioners and the electric pole.

An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner is used to perform, when a branch wire electric pole is installed in a work section, relocation of an electric pole, replacement of the electric pole, and change of an electric pole route in a state in which power transmission is continuously performed through a wire, the uninterruptible power distribution method including the steps of
performing, within the work section, installation of a new electric pole, installation of components mounted on the new electric pole, and installation of the wire on the new electric pole in a state in which power transmission is not performed through the wire so as to prepare for wiring work in the state in which power transmission is continuously performed through the wire,
respectively fixing, to arm-shaped support members, hooks of automatic direction switching pendulum-type rotary drive gear ratchet tensioners having an unlimited tension distance adjustment function for indirect live wire work, each of the gear ratchet tensioners being configured to maintain tension of the wire located between start and end electric poles in the work section in which the branch wire electric pole is installed, and respectively installing wire clips of the gear ratchet tensioners on wires to be removed located between the start and end electric poles and located in a region allowing removal of the wires to be removed in the state in which power transmission is not performed through the wire,
connecting one side of each of bypass jumper means to a corresponding one of the wires to be removed respectively located outside the wire clips of the gear ratchet tensioners respectively installed on the start and end electric poles in the work section, and connecting the other side of each of the bypass jumper means to a corresponding one of old wires respectively located outside the start and end electric poles, thereby connecting the wires to be removed and the old wires to each other through the respective bypass jumper means,
sequentially separating jumper wires of the start and end electric poles in the work section, respectively separating the wires to be removed located between the start and end electric poles from respective portions of the wires to be removed, the respective portions having the wire clips of the gear ratchet tensioners installed thereon, and securing a safe work space in the state in which power transmission is not performed through the wire,
stretching new wires, pulling the new wires to obtain an appropriate dip of each of the new wires, and respectively fixing the new wires to the start and end electric poles,
respectively fixing, to the arm-shaped support members, the hooks of the gear ratchet tensioners, each of the gear ratchet tensioners being configured to maintain tension of the wire located between the branch wire electric poles in the work section, and respectively installing wire clips of the gear ratchet tensioners on wires to be removed located between the branch wire electric poles and located in a region allowing removal of the wires to be removed in the state in which power transmission is not performed through the wire,
connecting one side of each of the bypass jumper means to a corresponding one of the wires to be removed respectively located outside the wire clips of the gear ratchet tensioners installed on the branch wire electric pole, and connecting the other side of each of the bypass jumper means to a corresponding one of old wires located outside the work section of the branch wire electric pole, thereby connecting the wires to be removed and the old wires to each other through the respective bypass jumper means,
sequentially separating jumper wires of the branch wire electric pole, separating the wires to be removed located between the branch wire electric poles from respective portions of the wires to be removed, the respective portions having the wire clips of the gear ratchet tensioners installed thereon, and securing a safe work space in the state in which power transmission is not performed through the wire,
stretching new wires, pulling the new wires to obtain an appropriate dip of each of the new wires, and fixing the new wires to the respective branch wire electric poles,
sequentially connecting, to the respective old wires, new jumper wires of the new wires respectively connected to the start and end electric poles and the branch wire electric poles, and separating the installed bypass jumper means, and
removing the wires to be removed respectively tensioned by the wire clips of the gear ratchet tensioners and the electric pole.

An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner is used to perform, when an electric pole for a transformer is installed in a work section, relocation of an electric pole, replacement of the electric pole, and change of an electric pole route in a state in which power transmission is continuously performed through a wire, the uninterruptible power distribution method including the steps of
performing, within a work section, installation of a new electric pole, installation of components mounted on the new electric pole, and installation of the wire on the new electric pole in a state in which power transmission is not performed through the wire so as to prepare for wiring work in the state in which power transmission is continuously performed through the wire,
respectively fixing, to arm-shaped support members, hooks of automatic direction switching pendulum-type rotary drive gear ratchet tensioners having an unlimited tension distance adjustment function for indirect live wire work, each of the gear ratchet tensioners being configured to maintain tension of the wire located between start and end electric poles in the work section, and respectively installing wire clips of the gear ratchet tensioners on wires to be removed located between the start and end electric poles and located in a region allowing removal of the wires to be removed in the state in which power transmission is not performed through the wire,
connecting one side of each of bypass jumper means to a corresponding one of the wires to be removed respectively located outside the wire clips of the gear ratchet tensioners installed within the start and end electric poles in the work section, and connecting the other side of each of the bypass jumper means to a corresponding one of old wires respectively located outside the start and end electric poles, thereby connecting the wires to be removed and the old wires to each other through the respective bypass jumper means,
sequentially separating jumper wires of the start and end electric poles in the work section, respectively separating the wires to be removed located between the start and end electric poles from respective portions of the wires to be removed, the respective portions having the wire clips of the gear ratchet tensioners installed thereon, and securing a safe work space in the state in which power transmission is not performed through the wire,
stretching new wires, pulling the new wires to obtain an appropriate dip of each of the new wires, and respectively fixing the new wires to the start and end electric poles,
sequentially connecting, to the respective old wires, new jumper wires of the new wires connected to the start and end electric poles in the work section,
connecting a secondary low-voltage cable of an uninterruptible transformer apparatus to a secondary low-voltage line of an electric pole transformer installed by installing the uninterruptible transformer apparatus on the electric pole for a transformer located within the work section for a bypass connection step, separating a secondary drop wire of the electric pole transformer, opening an electric pole transformer COS, and removing the electric pole transformer,
reusing the removed electric pole transformer on a new electric pole or installing a new electric pole transformer on the new electric pole, installing a COS of the new electric pole transformer, installing a secondary drop wire of the new electric pole transformer, turning off the uninterruptible transformer apparatus, separating the low-voltage cable of the uninterruptible transformer apparatus, and completing work of newly installing and relocating the electric pole transformer located in the work section, and
separating the bypass jumper means respectively installed on the start and end electric poles and removing the wires to be removed respectively tensioned by the wire clips of the gear ratchet tensioners within the start and end electric poles in the work section, the electric pole, and the uninterruptible transformer apparatus.

An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner is used to perform, when a branch wire electric pole and an electric pole for a transformer are installed in a work section, relocation of an electric pole, replacement of the electric pole, and change of an electric pole route in a state in which power transmission is continuously performed through a wire, the uninterruptible power distribution method including the steps of
performing, within the work section, installation of a new electric pole, installation of components mounted on the new electric pole, and installation of the wire on the new electric pole in a state in which power transmission is not performed through the wire so as to prepare for wiring work in the state in which power transmission is continuously performed through the wire,
respectively fixing, to arm-shaped support members, hooks of automatic direction switching pendulum-type rotary drive gear ratchet tensioners having an unlimited tension distance adjustment function for indirect live wire work, each of the gear ratchet tensioners being configured to maintain tension of the wire located between start and end electric poles in the work section in which the branch wire electric pole is installed, and respectively installing wire clips of the gear ratchet tensioners on wires to be removed located between the start and end electric poles and located in a region allowing removal of the wires to be removed in the state in which power transmission is not performed through the wire,
connecting one side of each of bypass jumper means to a corresponding one of the wires to be removed respectively located outside the wire clips of the gear ratchet tensioners respectively installed on the start and end electric poles in the work section, and connecting the other side of each of the bypass jumper means to a corresponding one of old wires respectively located outside the start and end electric poles, thereby connecting the wires to be removed and the old wires to each other through the respective bypass jumper means,
sequentially separating jumper wires of the start and end electric poles in the work section, and respectively separating the wires to be removed located between the start and end electric poles from respective portions of the wires to be removed, the respective portions having the wire clips of the gear ratchet tensioners installed thereon,
removing the wires to be removed from the respective portions of the wires to be removed within the start and end electric poles in the work section to suspension insulators on the electric poles so as to secure a safe work space in the state in which power transmission is not performed through the wire, stretching new wires, pulling the new wires to obtain an appropriate dip of each of the new wires, and respectively fixing the new wires to the start and end electric poles,
respectively installing wire clips of the gear ratchet tensioners, each of the gear ratchet tensioners being configured to maintain tension of the wire located between the branch wire electric poles in the work section, on wires to be removed located between the branch wire electric poles and located in a region allowing removal of the wires to be removed in the state in which power transmission is not performed through the wire,
connecting one side of each of the bypass jumper means to a corresponding one of the wires to be removed respectively located outside the wire clips of the gear ratchet tensioners installed on the branch wire electric pole, and connecting the other side of each of the bypass jumper means to a corresponding one of old wires located outside the work section of the branch wire electric pole, thereby connecting the wires to be removed and the old wires to each other through the respective bypass jumper means,
sequentially separating jumper wires of the branch wire electric pole, and respectively separating the wires to be removed located between the branch wire electric poles from respective portions of the wires to be removed, the respective portions having the wire clips of the gear ratchet tensioners installed thereon,
removing the wires to be removed from the respective portions of the wires to be removed within the branch wire electric poles to suspension insulators on the branch wire electric poles so as to secure a safe work space in the state in which power transmission is not performed through the wire, stretching new wires, pulling the new wires to obtain an appropriate dip of each of the new wires, and fixing the new wires to the respective branch wire electric poles,
sequentially connecting, to the respective old wires, new jumper wires of the new wires respectively connected to the start and end electric poles and the branch wire electric poles,
connecting a secondary low-voltage cable of an uninterruptible transformer apparatus to a secondary low-voltage line of an electric pole transformer installed by installing the uninterruptible transformer apparatus on the electric pole for a transformer located within the work section for a bypass connection step, separating a secondary drop wire of the electric pole transformer, opening an electric pole transformer COS, and removing the electric pole transformer,
reusing the removed electric pole transformer on a new electric pole or installing a new electric pole transformer on the new electric pole, installing a COS of the new electric pole transformer, installing a secondary drop wire of the new electric pole transformer, turning off the uninterruptible transformer apparatus, separating the low-voltage cable of the uninterruptible transformer apparatus, and completing work of newly installing and relocating the electric pole transformer located in the work section, and
separating the bypass jumper means respectively installed on the start and end electric poles and the branch wire electric poles, and removing the wires to be removed respectively tensioned by the wire clips of the gear ratchet tensioners respectively installed within the start and end electric poles in the work section and the branch wire electric poles, the electric pole, and the uninterruptible transformer apparatus.

An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner is used to perform replacement work for electric poles having a distance therebetween in a state in which power transmission is continuously performed through a wire, the uninterruptible power distribution method including
an electric pole installation step of installing a new electric pole to be replaced in a work section in a state in which power transmission is not performed through the wire,
a step of connecting, through a bypass jumper means, wires to be relocated respectively located on opposite sides of an electric pole to be removed to each other,
a step of sequentially separating jumper wires configured to respectively connect the wires to be relocated respectively located on the opposite sides of the electric pole to be removed so as to secure a safe work space,
a first gear ratchet tensioner installation step of fixing, to an arm-shaped support member, a hook of an automatic direction switching pendulum-type rotary drive gear ratchet tensioner having an unlimited tension distance adjustment function for indirect live wire work, the gear ratchet tensioner being configured to maintain tension of the wire and located on one side of the new electric pole, and grabbing, by a wire clip, the wire to be relocated located on one side of the electric pole to be removed so as to fixedly install the wire clip thereon,
a first wire relocation step of separating, from the electric pole to be removed, the fixed wire to be relocated located on one side of the electric pole to be removed while adjusting tension of the gear ratchet tensioner and fixedly connecting the separated wire to be relocated to one side of the new electric pole,
a first gear ratchet tensioner removal step of removing the gear ratchet tensioner configured to hold and fix the relocated wire to be relocated,
a second gear ratchet tensioner installation step of fixing, to the arm-shaped support member, the hook of the automatic direction switching pendulum-type rotary drive gear ratchet tensioner having an unlimited tension distance adjustment function for indirect live wire work, the gear ratchet tensioner being configured to maintain tension of the wire and located on the other side of the new electric pole, and grabbing, by the wire clip, the wire to be relocated located on the other side of the electric pole to be removed so as to fixedly install the wire clip thereon,
a second wire relocation step of separating, from the electric pole to be removed, the fixed wire to be relocated located on the other side of the electric pole to be removed while adjusting the tension of the gear ratchet tensioner and fixedly connecting the separated wire to be relocated to the other side of the new electric pole,
a second gear ratchet tensioner removal step of removing the gear ratchet tensioner configured to hold and fix the relocated wire to be relocated,
a step of connecting, by the existing jumper wire or a new jumper wire, the wires to be relocated respectively relocated to opposite sides of the new electric pole and separating the installed bypass jumper means, and an electric pole removal step of removing the electric pole to be removed.

### Advantageous Effects

As described above, the present invention provides an automatic direction switching pendulum-type rotary drive gear ratchet tensioner having an unlimited tension distance adjustment function for indirect live wire work and an uninterruptible power distribution method of performing indirect live wire work using the same, configured to automatically perform, using a stick for live wire work, forward or reverse rotation of a roller shaft operating plate through reciprocating pendulum motion of a pendulum in accordance with rotation direction adjustment of a rotary operating shaft, thereby having an effect of automatically pulling or releasing an insulating rope through forward rotation or reverse rotation of a roller shaft by simply conducting the indirect live wire work without performing a separate rotation direction switching operation. Accordingly, while the indirect live wire work is conducted from a long distance on a wire in a state in which power transmission is continuously performed through the wire, a dip of the wire may be appropriately adjusted, the wire may be pulled to obtain an appropriate dip of the wire and may be fixedly installed on an electric pole, the wire may be removed from the electric pole, and suspension insulator replacement work may be reliably performed with unlimited tension control, thereby having an effect of stably performing wiring work.

Additionally, a backstop ratchet ring is capable of preventing reverse rotation of the roller shaft, preventing backlash occurrence when the roller shaft is driven in the reverse direction, and constantly performing bidirectional rotation in a reliable manner, thereby having an effect of securing stability and durability of a device.

### DESCRIPTION OF DRAWINGS

The above and other objects, features and other advantages of the present invention will be more clearly understood from the following detailed description taken in conjunction with the accompanying drawings, in which:

FIG. 1 is a perspective view of an automatic direction switching pendulum-type rotary drive gear ratchet tensioner having an unlimited tension distance adjustment function for indirect live wire work according to the present invention;

FIG. 2 is a perspective view of a main part of the automatic direction switching pendulum-type rotary drive gear ratchet tensioner having an unlimited tension distance adjustment function for indirect live wire work according to the present invention;

FIG. 3 is a planar cross-sectional view of the automatic direction switching pendulum-type rotary drive gear ratchet tensioner having an unlimited tension distance adjustment function for indirect live wire work according to the present invention;

FIG. 4 is a front view of the main part of the automatic direction switching pendulum-type rotary drive gear ratchet tensioner having an unlimited tension distance adjustment function for indirect live wire work according to the present invention;

FIG. 5 is a cross-sectional view of the main part of the automatic direction switching pendulum-type rotary drive gear ratchet tensioner having an unlimited tension distance adjustment function for indirect live wire work according to the present invention;

FIG. 6 is a rear perspective view of the automatic direction switching pendulum-type rotary drive gear ratchet tensioner having an unlimited tension distance adjustment function for indirect live wire work according to the present invention;

FIG. 7 is a cross-sectional view of the main part of the automatic direction switching pendulum-type rotary drive gear ratchet tensioner having an unlimited tension distance adjustment function for indirect live wire work according to the present invention;

FIGS. 8 to 13 are views each showing a main part of a clutch part of the automatic direction switching pendulum-type rotary drive gear ratchet tensioner having an unlimited tension distance adjustment function for indirect live wire work according to the present invention;

FIG. 14 is a view showing a main part of a pawl reversing key of the automatic direction switching pendulum-type rotary drive gear ratchet tensioner having an unlimited tension distance adjustment function for indirect live wire work according to the present invention;

FIG. 15 is a view showing a forward direction operation state of the automatic direction switching pendulum-type rotary drive gear ratchet tensioner having an unlimited tension distance adjustment function for indirect live wire work according to the present invention;

FIG. 16 is a view showing a forward direction operation state of a backstop ratchet ring of the automatic direction switching pendulum-type rotary drive gear ratchet tensioner having an unlimited tension distance adjustment function for indirect live wire work according to the present invention;

FIG. 17 is a view showing a reverse direction operation state of the automatic direction switching pendulum-type rotary drive gear ratchet tensioner having an unlimited tension distance adjustment function for indirect live wire work according to the present invention;

FIG. 18 is a view showing a reverse direction operation state of the backstop ratchet ring of the automatic direction switching pendulum-type rotary drive gear ratchet tensioner having an unlimited tension distance adjustment function for indirect live wire work according to the present invention;

FIG. 19 is a view showing a usage state of the automatic direction switching pendulum-type rotary drive gear ratchet tensioner having an unlimited tension distance adjustment function for indirect live wire work according to the present invention;

FIG. 20 is a view showing an operation state of manual winding and unwinding of an insulating rope of the automatic direction switching pendulum-type rotary drive gear ratchet tensioner having an unlimited tension distance adjustment function for indirect live wire work according to the present invention;

FIGS. 21 to 26 are schematic views each showing a first embodiment of an uninterruptible power distribution method of performing indirect live wire work, using the automatic direction switching pendulum-type rotary drive gear ratchet tensioner having an unlimited tension distance adjustment function for indirect live wire work according to the present invention;

FIGS. 27 to 32 are schematic views each showing a second embodiment of the uninterruptible power distribution method of performing indirect live wire work, using the automatic direction switching pendulum-type rotary drive gear ratchet tensioner having an unlimited tension distance adjustment function for indirect live wire work according to the present invention;

FIGS. 33 to 40 are schematic views each showing a third embodiment of the uninterruptible power distribution method of performing indirect live wire work, using the automatic direction switching pendulum-type rotary drive gear ratchet tensioner having an unlimited tension distance adjustment function for indirect live wire work according to the present invention;

FIGS. 41 to 48 are schematic views each showing a fourth embodiment of the uninterruptible power distribution method of performing indirect live wire work, using the automatic direction switching pendulum-type rotary drive gear ratchet tensioner having an unlimited tension distance adjustment function for indirect live wire work according to the present invention; and

FIGS. 49 to 60 are schematic views each showing a fifth embodiment of the uninterruptible power distribution method of performing indirect live wire work, using the automatic direction switching pendulum-type rotary drive gear ratchet tensioner having an unlimited tension distance adjustment function for indirect live wire work according to the present invention.

[Description of Reference Numerals]

| | |
|---|---|
| 10: Electric pole | 10′: New electric pole |
| 10a: Electric pole for branch wire | 10b: Electric pole for transformer |
| 11, 11a: Wire to be removed | 12, 12a: Old wire |
| 13, 13a: New wire | 14, 14′: Wire to be relocated |
| 20, 20a: Jumper wire | 21, 21a: New jumper wire |
| 30: Bypass jumper means | 30a: Bypass jumper cable |
| 30b: Construction switch | 50: Electric pole transformer |
| 50a: New electric pole transformer | 51: Cos |
| 51a: New electric pole COS | 52: Secondary drop wire of transformer |
| 52a: Secondary drop wire of new transformer | 60: Uninterruptible transformer appartus |
| 70: Extra high-voltage cable | 70a: Low-voltage cable |
| 80: Secondary low-voltage line | 80a: Secondary low-voltage line of new electric pole |
| 100: Body | 110, 110′: Front and rear support plates |
| 120: Idle gear | 130: Interlocking gear |
| 131: Support roller | 140: Insulating rope connection part |
| 150: Hook | 160, 160′: Upper and lower guide rollers |
| 170: Insulating rope pressurization | 171: Guide groove |
| opening/closing means | |
| 172: Pressurizing roller | 173: Spring housing |
| 174: Vertical hole | 175: Pressurizing spring |
| 176: Housing hook | 180: Pressurization release part |
| 181: Lever housing | 182: Horizontal long hole |
| 183: Release lever | 184: Lever hook |
| 185: Spring | |
| 200: Rotary operating lever | 210: Rotary operating shaft |
| 211: Rotary ring | 220: Cam |
| 230: Rotary operating mechanism | 231: Movable long hole |
| 232: Locking protrusion | 240: Buffer key |
| 300: Gear roller | 310: Roller shaft |
| 320: Insulating rope guide groove | 330, 330′: Insulating rope |
| | pressurization protrusion |
| 400: Clutch part | 401: Backstop ratchet ring |
| 410: Outer ring | 411: Inner ring mounting hole |
| 412: Outer ring saw teeth | 412a, 412b: Front and rear stepped portions |
| 413: Stopping groove | 420: Inner ring |
| 421: Roller shaft mounting hole | 422: Bundle pawl mounting groove |
| 423: Seating protrusion | 423a: Drive gear |
| 424: Finishing plate support portion | 425: Finishing plate |
| 425a: Through hole | 430: Multi-angle bundle pawl unit |
| 431, 432, 433: First, second, and third | |
| multi-angle bundle pawls | |
| 431a, 432a, 433a: First, second, and third | 431b, 432b, |
| engagement tools | |
| 433b: First, second, and third engagement | |
| tool saw teeth | |
| 440: Rotation control lever | |
| 500: Roller shaft operating plate | 510: Saw teeth |
| 600: Pendulum | 610: Horizontal long hole |
| 620: Automatic reversing pawl mounting groove | |
| 700: Roller shaft support plate | |
| 800: Automatic reversing pawl | 801: Pawl shaft |
| 810, 810′: First and second locking protrusions | 821, 821′: First locking groove |
| 822, 822′: Second locking groove | |
| 830: Reversing key mounting groove | 840, 840′: First and second reversing |
| | pawl spring balls |
| 900: Pawl reversing key | 910, 910′: First and second reversing |
| | key spring balls |
| 1000: Roller shaft rotary lever | 1100: Insulating rope |
| 1200: Wire clip | |

### BEST MODE

Terms or words used in the description and claims should not be restrictively interpreted as having ordinary or dictionary meanings, but should be interpreted as having meanings and concepts conforming to the inventive concept on the basis of a principle that an inventor may properly define the concept of a term to explain his or her own invention in the best way.

Therefore, embodiments described in this specification and configurations shown in the drawings are only preferred embodiments of the present invention and do not represent the entire technical idea of the present invention. It should be understood that those skilled in the art will appreciate that various modifications, additions, and substitutions are possible, without departing from the scope and spirit of the invention as disclosed in the accompanying claims.

Hereinafter, preferred embodiments of the present invention will be described in detail with reference to the attached drawings.

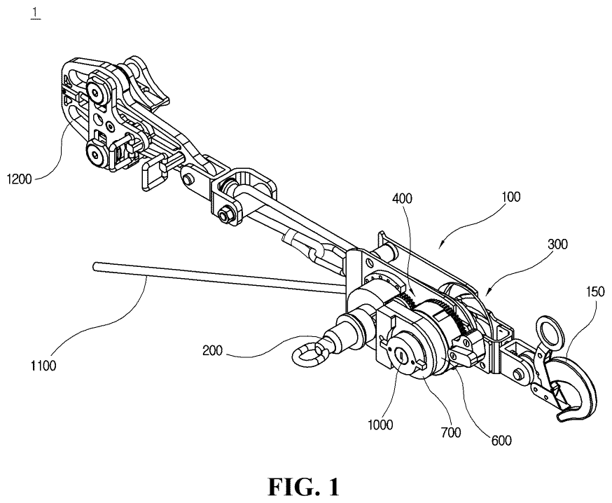

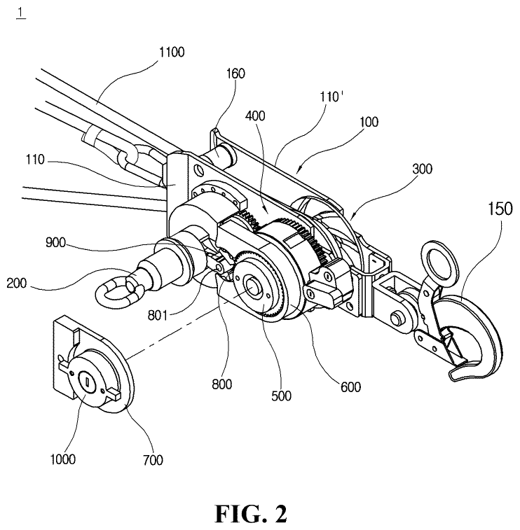

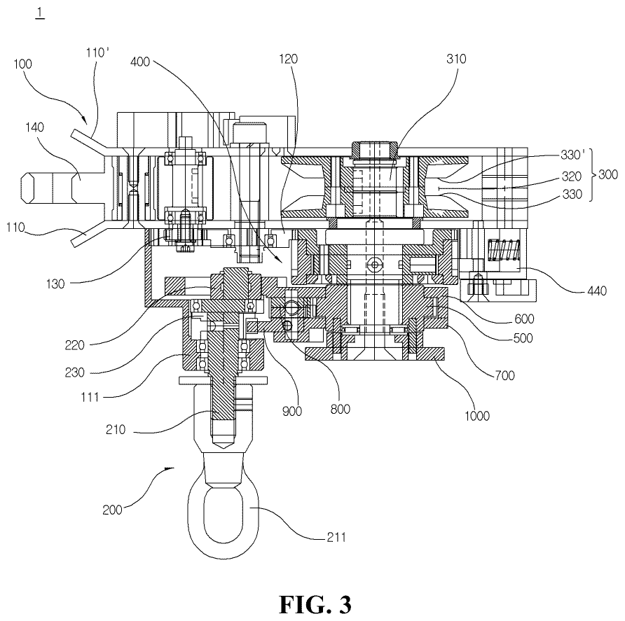

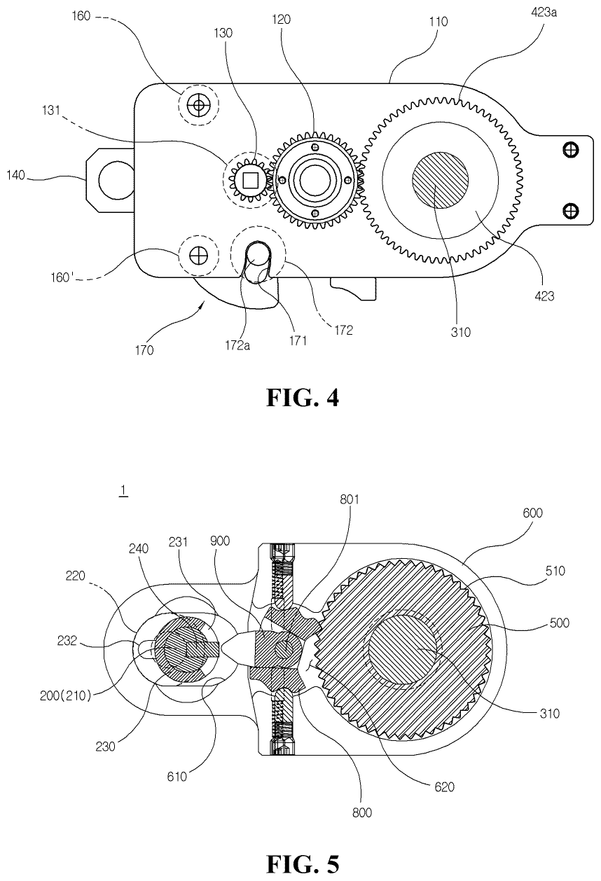

FIG. 1 is a perspective view of an automatic direction switching pendulum-type rotary drive gear ratchet tensioner having an unlimited tension distance adjustment function for indirect live wire work according to the present invention, FIG. 2 is a perspective view of a main part of the automatic direction switching pendulum-type rotary drive gear ratchet tensioner having an unlimited tension distance adjustment function for indirect live wire work according to the present invention, FIG. 3 is a planar cross-sectional view of the automatic direction switching pendulum-type rotary drive gear ratchet tensioner having an unlimited tension distance adjustment function for indirect live wire work according to the present invention, FIG. 4 is a front view of the main part of the automatic direction switching pendulum-type rotary drive gear ratchet tensioner having an unlimited tension distance adjustment function for indirect live wire work according to the present invention, and FIG. 5 is a cross-sectional view of the main part of the automatic direction switching pendulum-type rotary drive gear ratchet tensioner having an unlimited tension distance adjustment function for indirect live wire work according to the present invention.

As shown in FIGS. 1 to 5, an automatic direction switching pendulum-type rotary drive gear ratchet tensioner having an unlimited tension distance adjustment function for indirect live wire work 1 according to the present invention includes a body 100, a rotary operating lever 200, a gear roller 300, a clutch part 400, a roller shaft operating plate 500, a pendulum 600, a roller shaft support plate 700, an automatic revering pawl 800, a pawl reversing key 900, a roller shaft rotary lever 1000, an insulating rope 1100, and a wire clip 1200.

First, the body 100 is configured to form a basic structure of the automatic direction switching pendulum-type rotary drive gear ratchet tensioner having an unlimited tension distance adjustment function for indirect live wire work 1 according to the present invention. Further, the body 100 is formed of front and rear support plates 110 and 110′ so as to be formed open on the upper side, the lower side, and one side thereof. Here, one end of each of the front and rear support plates 110 and 110′ is inclined and bent in the forward-and-rearward direction so as to guide entry and exit of the insulating rope 1100 to be described later.

In addition, a front middle part of the front support plate 110 is configured to be engaged with a drive gear 423a of an inner ring 420 to be described later, and an idle gear 120 is axially installed in the front middle part.

Additionally, the front support plate 110 has an interlocking gear 130 axially installed on the front side thereof, and one side of the interlocking fear is engaged with the idle gear 120.

In this case, the interlocking gear 130 connects the front and rear support plates 110 and 110′ to each other and is axially installed therebetween. A support roller 131 is formed between the front and rear support plates 110 and 110′. The support roller 131 is made of metal, and processing such as knurling is performed on the outer circumferential surface of the support roller to prevent slippage.

Further, the body 100 includes an insulating rope connection part 140 and a hook 150 respectively disposed at central portions of one end and the other end and configured to be moved upwards and downwards between the front and rear support plates 110 and 110′.

The body 100 includes a pair of upper and lower guide rollers 160 and 160′ respectively installed at the upper side and the lower side thereof and configured to guide movement of the insulating rope 1100 between the front and rear support plates 110 and 110′. When the insulating rope 1100 is pulled or released, these upper and lower guide rollers 160 and 160′ interfere with the insulating rope 1100 and guide stable movement of the insulating rope 1100 through rolling operation thereof.

In addition, the body 100 includes a hollow lever installation part 111 formed on one front side thereof. In this case, the lever installation part 111 is configured to restrict the idle gear 120 and the interlocking gear 130.

In addition, the body 100 is configured to further include an insulating rope pressurization opening/closing means 170 formed to face the support roller 131 and configured to increase the tension limit by applying pressurizing force to the insulating rope 1100.

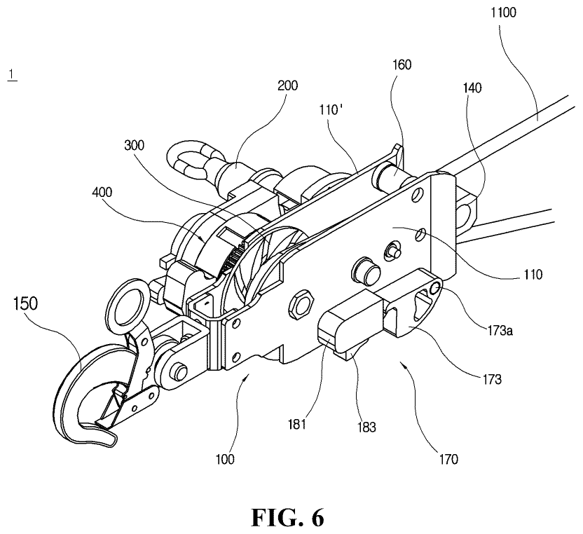

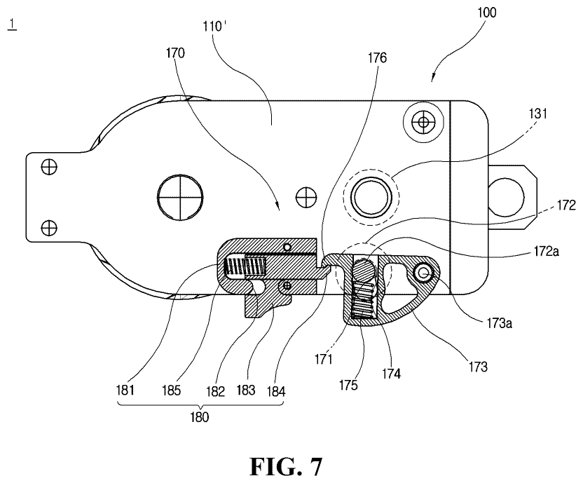

Here, referring to FIGS. 6 and 7, the insulating rope pressurization opening/closing means 170 has a pair of guide grooves 171 formed to open downwards from the lower portions of the front and rear support plates 110 and 110′.

In addition, the insulating rope pressurization opening/closing means 170 includes a pressurizing roller 172 formed to face the support roller 131 and configured to apply pressurizing force. The pressurizing roller 172 is made of a silicone material so as to provide elasticity and prevent slippage, and is formed between the front and rear support plates 110 and 110′.

In this case, the pressurizing roller 172 is formed around a pressurizing roller shaft 172a configured for both sides thereof to be accommodated in the guide groove 171. The rear side of the pressurizing roller shaft 172a is formed to protrude toward the rear side of the rear support plate 110′.

In addition, the insulating rope pressurization opening/closing means 170 includes a spring housing 173 configured to provide spring elasticity to the pressurizing roller 172. The spring housing 173 is configured to be connected to a shaft 173a on the rear side of the rear support plate 110′ so as to be rotatable upwards and downwards. The spring housing has a vertical hole 174 formed to pass through the front and rear sides thereof, thereby penetrating the protruding rear of the pressurizing roller shaft 172a.

A pressurizing spring 175 is configured to be elastically installed on the inside of the spring housing 173. Here, the pressurizing spring provides spring force to the pressurizing roller shaft 172a.

A “¬”-shaped housing hook 176 is formed on the other end of the spring housing 173.

Additionally, the insulating rope pressurization opening/closing means 170 includes a pressurization release part 180 formed to be hooked by the spring housing 173 and configured to fix the spring housing 173 and maintain pressurizing force of the pressurizing roller 172.

Here, the pressurization release part 180 is formed on the rear support plate 110′ in a state of facing the spring housing 173. The pressurizing release part is formed to be open toward the spring housing 173. Further, the pressurizing release part has a lever housing 181 formed on the circumference thereof. Here, the lever housing has a horizontal long hole 182 formed therein and configured to communicate with the inside of the spring housing 173.

The lever housing 181 includes a release lever 183 formed to penetrate the horizontal long hole 182 and configured to be accommodated in the horizontal long hole or protrude outwards therefrom. The release lever 183 includes an “L”-shaped lever hook 184 formed to protrude so as to be hooked on the housing hook 176.

A spring 185 is configured to be elastically installed on the inside of the lever housing 181 such that the release lever 183 has protruding force toward the spring housing 173.

Accordingly, the spring housing 173 of the insulating rope pressurization opening/closing means 170 is rotated around the shaft 173a so as to allow the housing hook 176 to be fixedly hooked on the lever hook 184 in a state of being accommodated in the guide groove 171. In this case, the insulating rope 1100 applies pressurizing force between the support roller 131 and the pressurizing roller 172.

Conversely, when the spring housing 173 is pressed such that the pressurizing spring 175 is compressed, the release lever 183 of the pressurization release part 180 is pulled. In this case, locking force of the housing hook 176 and the lever hook 184 is released, and the spring housing 173 is rotated to be separated from the guide groove 171. Here, pressurizing force of the insulating rope 1100 is released, and the insulating rope 1100 becomes movable, thereby allowing the insulating rope to be mounted or removed from the body 100 of the insulating rope 1100.

In the configuration of the automatic direction switching pendulum-type rotary drive gear ratchet tensioner having an unlimited tension distance adjustment function for indirect live wire work 1 according to the present invention, the rotary operating lever 200 is configured to provide operating force for forward rotation of a roller shaft 310 to be described later or reverse rotation thereof.

To this end, the rotary operating lever 200 is mainly formed of a rotary operating shaft 210 horizontally installed in the lever installation part 111. Here, the front end of the rotary operating shaft 210 is located on the inner side of the lever installation part 111, and the rear end thereof protrudes toward the outer side of the lever installation part 111 so as to form a rotary ring 211.

In addition, the rotary operating lever 200 includes a cam 220 provided at a tip portion of the rotary operating shaft 210 and disposed at a location eccentric from a central portion of the tip portion to one side.

In addition, the rotary operating lever 200 includes a rotary operating mechanism 230 provided around the rotary operating shaft 210 and disposed on the rear side of the cam 220. The rotary operating mechanism 230 is configured to be slidably coupled to the rotary operating shaft 210.

In addition, a movable long hole 231 is formed on one side of the circumference of the rotary operating mechanism 230 so as to form an angle of about 110° in the circumferential direction, and a locking protrusion 232 is formed to protrude around the other side of the circumference of the rotary operating mechanism 230.

In addition, the rotary operating lever 200 includes a buffer key 240 configured to provide connecting force between the rotary operating shaft 210 and the rotary operating mechanism 230. In this case, one side of the buffer key 240 is configured to be fixed to the rotary operating shaft 210 and the other side thereof is configured to be located on the inner side of the movable long hole 231 of the rotary operating mechanism 230.

Here, when the rotary operating shaft 210 is rotated in the forward direction or reverse direction, the buffer key 240 idles for a predetermined time within the movable long hole 231. When the buffer key 240 is caught at one end of the movable long hole 231, the buffer key 240 is configured to rotate the rotary operating mechanism 230. In this operation process, it is possible to prevent shock overload on the roller shaft operating plate 500 to be described later. Here, the shock overload is caused by sudden rotation.

In the configuration of the automatic direction switching pendulum-type rotary drive gear ratchet tensioner having an unlimited tension distance adjustment function for indirect live wire work 1 according to the present invention, the gear roller 300 is substantially configured to provide forward or reverse rotational force so as to pull or release the insulating rope 1100 to be described later.

To this end, the gear roller 300 has the roller shaft 310 disposed between the front and rear support plates 110 and 110′ and formed to be axially installed on the other side of the body 100. Here, the roller shaft 310 is formed to protrude from the front side of the body 100.

In this case, the gear roller 300 has an insulating rope guide groove 320 on the outer circumference thereof. In this manner, the insulating rope 1100 is accommodated in the insulating rope guide groove.

In the opposite inner surfaces of the insulating rope guide groove 320, a pair of insulating rope pressurization protrusions 330 and 330′ is formed to protrude, and a plurality of the pair of insulating rope pressurization protrusions are arranged radially in a spiral shape. In this case, the insulating rope pressurization protrusions 330 and 330′ are configured to face each other and protrude to intersect each other such that the insulating rope 1100 is inserted therebetween to apply pressure to the insulating rope.

In the configuration of the automatic direction switching pendulum-type rotary drive gear ratchet tensioner having an unlimited tension distance adjustment function for indirect live wire work 1 according to the present invention, the clutch part 400 is configured to implement forward rotation of the roller shaft 310 or reverse rotation thereof. The roller shaft 310 is configured to penetrate the body 100 and protrude from the front side of the body so as to be coupled to the clutch part 400.

Meanwhile, in the present invention, the configuration of the clutch part 400 is not limited. For example, the clutch part may be configured as a cam clutch in which a cam is formed between an inner ring and an outer ring, only the inner ring is rotatable when the inner ring is rotated in the forward direction, and the inner ring and the outer ring are simultaneously rotatable when the inner ring is rotated in the reverse direction.

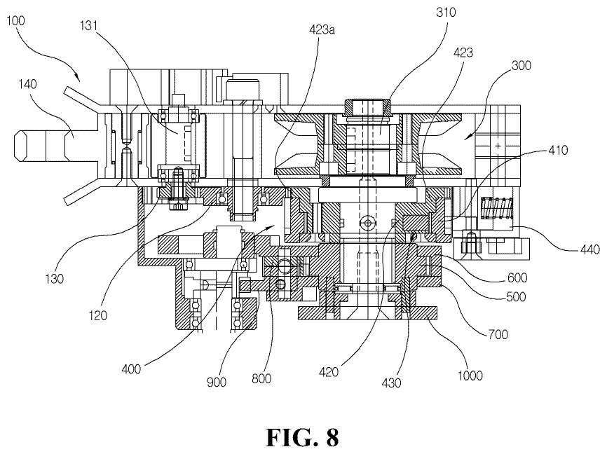

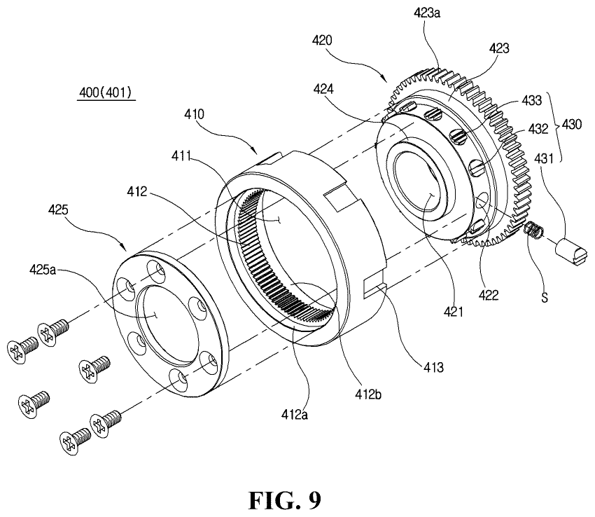

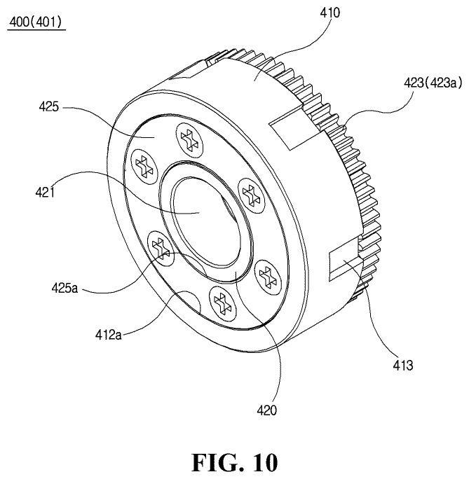

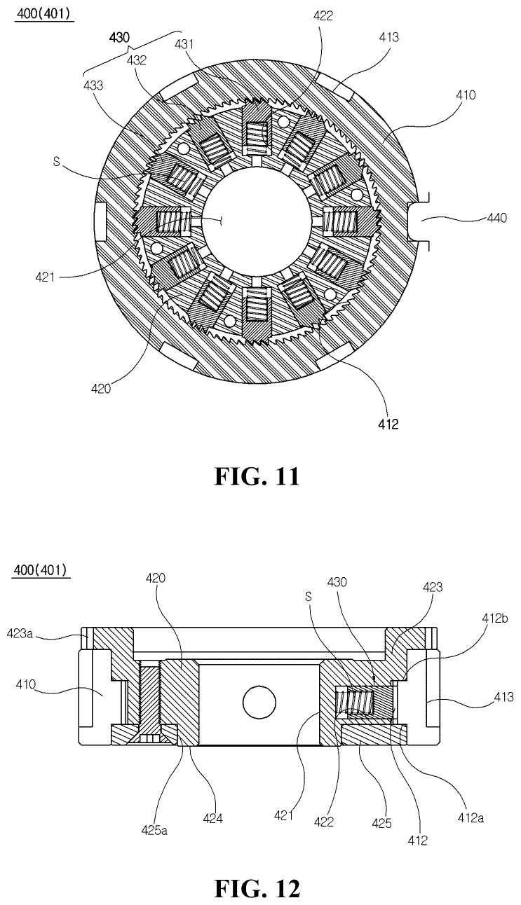

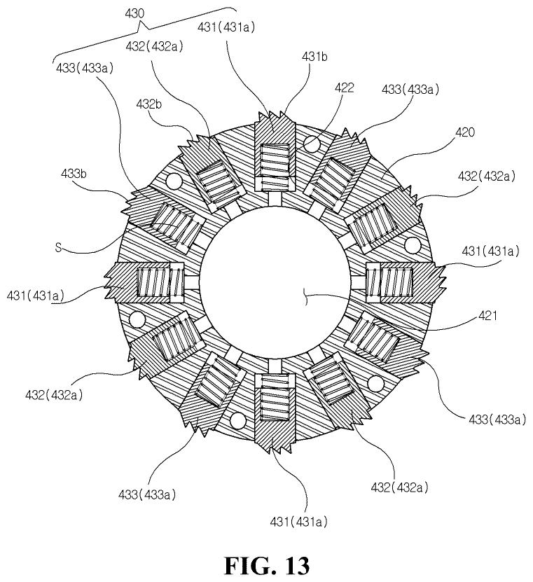

In addition, the clutch part 400 may be configured as a backstop ratchet ring 401 with reference to FIGS. 8 to 13. In the present invention, the backstop ratchet ring 401 includes an outer ring 410, an inner ring 420, a multi-angle bundle pawl unit 430, and a rotation control lever 440.

First, in the configuration of the backstop ratchet ring 401, the outer ring 410 is configured to output power to the outside. The outer ring 410 has an inner ring mounting hole 411 disposed at a central portion thereof and configured to allow the inner ring 420 to be described later to be mounted therein. Here, the inner ring mounting hole 411 is formed to have a circular shape in a state of penetrating the outer ring 410.

In this case, in the present invention, the outer ring 410 is configured to have outer ring saw teeth 412 formed on the inner peripheral surface of the inner ring mounting hole 411, and the outer ring saw teeth 412 are configured to have straight portions and inclined portions that are continuously formed.

Meanwhile, in the present invention, each of the straight portions forming the outer ring saw teeth 412 is configured to be caught during power transmission, and each of the inclined portions forming the outer ring saw teeth 412 is configured to guide slippage during idling operation.

In addition, in the present invention, the outer ring 410 may further include a plurality of stopping grooves 413 formed in the outer circumference thereof at regular intervals and configured to allow the rotation control lever 440 to be respectively caught therein or released therefrom.

In the configuration of the backstop ratchet ring 401, the inner ring 420 is configured to substantially transmit main power. Further, the inner ring 420 interferes with the outer ring 410 so as to transmit main power to the outer ring 410 or is released from the outer ring 410 so as to release the main power from the outer ring 410.

To this end, in the present invention, the inner ring 420 is configured to have a circular ring shape. Here, the inner ring 420 has a roller shaft mounting hole 421 formed to pass through a central portion thereof and configured to allow the roller shaft 310 provided to transmit rotational force to be coupled thereto. Further, the inner ring 420 is configured to be mounted in the inner ring mounting hole 411 of the outer ring 410.

In addition, the inner ring 420 has a plurality of bundle pawl mounting grooves 422 formed in the outer circumference thereof at regular intervals in the circumferential direction and configured to enable first, second, and third multi-angle bundle pawls 431, 432, and 433 to be described later to be respectively mounted therein.

Meanwhile, in the present invention, the outer ring 410 and the inner ring 420 are configured to enable close coupling therebetween. Further, sliding operation may be stably performed when the outer ring 410 and the inner ring 420 are coupled to each other.

To this end, first, each of the outer ring saw teeth 412 of the outer ring 410 is configured to protrude toward the inside of the inner ring mounting hole 411 by a predetermined amount. Accordingly, front and rear stepped portions 412a and 412b are respectively formed on the front side and the rear side of the outer ring saw teeth 412.

In addition, the inner ring 420 is configured to have a seating protrusion 423 formed to protrude from the rear circumference thereof and slidably seated on the rear stepped portion 412b of the outer ring 410. Further, the inner ring 420 is configured to have a finishing plate support portion 424 formed to protrude from the front side thereof so as to extend from the roller shaft mounting hole 421.

In this case, the drive gear 423a is formed on the rear circumference of the seating protrusion 423 of the inner ring 420. The drive gear 423a is configured to be engaged with the idle gear 120 installed on the body 100 so as to provide rotational force in the same direction as the interlocking gear 130 through the idle gear 120.

Further, the front side of the inner ring 420 is configured to be finished with a finishing plate 425. Here, the circumference of the finishing plate 425 is configured to be seated on the front stepped portion 412a of the outer ring 410 and to be bolted to the inner ring 420, thereby constraining the outer ring saw teeth 412. Further, the finishing plate 425 is configured to have a through hole 425a formed in a central portion thereof and configured to allow the finishing plate support portion 424 of the inner ring 420 to pass therethrough.

In the configuration of the backstop ratchet ring 401, the multi-angle bundle pawl unit 430 serves as a means to transmit power of the inner ring 420 to the outer ring 410 or release power of the inner ring 420 from the outer ring 410 in response to the outer ring saw teeth 412 of the outer ring 410. In the present invention, the multi-angle bundle pawl unit 430 is formed of a plurality of groups including the first, second, and third multi-angle bundle pawls 431, 432, and 433.

To this end, the first, second, and third multi-angle bundle pawls 431, 432, and 433 respectively have springs S each installed in a corresponding one of the bundle pawl mounting grooves 422, thereby allowing the first, second, and third multi-angle bundle pawls 431, 432, and 433 to protrude from the outer circumference of the inner ring 420. Further, the first, second, and third multi-angle bundle pawls 431, 432, and 433 are configured to be engaged with the outer ring saw teeth 412 of the outer ring 410, thereby providing rotational force in one direction.

In this case, in the present invention, the first, second, and third multi-angle bundle pawls 431, 432, and 433 are configured to form three groups. Here, each of the three groups may be formed of a corresponding one of first, second, and third engagement tools 431a, 432a, and 433a, in which each of the radially arranged (that is, arranged at 90° intervals) four first engagement tools 431a, four second engagement tools 432a, and four third engagement tools 433a forms one group.

In the present invention, the first, second, and third engaging tools 431a, 432a, and 433a corresponding to respective groups are configured to have protruding force by respectively inserting the springs S into the bundle pawl mounting grooves 422. The first, second, and third engaging tools 431a, 432a, and 433a have engagement tool saw teeth 431b, 432b, and 433b respectively provided on the tip portions thereof, in which each of the engagement tool saw teeth 431b, 432b, and 433b is formed to have a straight portion and an inclined portion so as to be engaged with the outer ring saw teeth 412 of the outer ring 410.

Particularly, in the present invention, when the first, second, and third engagement tools 431a, 432a, and 432a respectively corresponding to the first, second, and third multi-angle bundle pawls 431, 432, and 433 of the respective groups are respectively mounted in the bundle pawl mounting grooves 422, the first, second, and third engagement tools 431a, 432a, and 433a are respectively disposed at positions where the first, second, and third engagement tools 431a, 432a, and 433a intersect each other. That is, the first engagement tool 431a of the first multi-angle bundle pawl 431, the second engagement tool 432a of the second multi-angle bundle pawl 432, and the third engagement tool 433a of the third multi-angle bundle pawl 433 are continuously and repeatedly formed in one rotational direction. In this manner, the engagement tool saw teeth 431b, 432b, and 433b are configured to be engaged with the outer ring saw teeth 412 at sequential positions respectively having different angles.

That is, in the present invention, any one of the first, second, and third engagement tool saw teeth 431b, 432b, and 433b of the first, second, and third engagement tool 431a, 432a, and 433a of the first, second, and third multi-angle bundle pawls 431, 432, and 433 is engaged with the outer ring saw teeth 412 of the outer ring 410. For example, when the straight portions of the engagement tool saw teeth 431b of the first engagement tool 431a are respectively in contact with the straight portions of the outer ring saw teeth 412, the straight portions of the engagement tool saw teeth 432b of the second engagement tool 432a are respectively located at the ends of the inclined portions of the outer ring saw teeth 412. As a result, the engagement tool saw teeth 432b are not engaged with the outer ring saw teeth 412. In addition, the straight portions of the engagement tool saw teeth 433b of the third engagement tool 433a are respectively located at the middle portions of the inclined portions of the outer ring saw teeth 412. In this manner, segmented engagement sections of the engagement tool saw teeth 431b, 432b, and 433b are provided within one pitch of the outer ring saw teeth 412, thereby maximally reducing a gap between the saw teeth.

Meanwhile, in the embodiment of the present invention, the first, second, and third multi-angle bundle pawls 431, 432, and 433 forming a plurality of groups have been described as three groups, but the present invention is not limited thereto. The first, second, and third multi-angle bundle pawls 431, 432, and 433 may be arranged in various configurations with equal intervals therebetween.

For example, the plurality of groups may be formed of four groups of multi-angle bundle pawls, and each of the four groups may be formed of four engagement tools. Alternatively, the plurality of groups may be formed of three groups of multi-angle bundle pawls, and each of the three groups may be formed of eight engagement tools. As described above, the number of groups and the number of engagement tools are adjusted, thereby making it possible to control a degree of precision depending on the purpose of use of the backstop ratchet ring 401.

In the configuration of the backstop ratchet ring 401, the rotation control lever 440 is configured to control rotation and stoppage of the outer ring 410.

To this end, the rotation control lever 440 is configured to be axially installed in the body 100 and to have a spring installed in the body 100. In this manner, the rotation control lever 440 is configured to be inserted into and removed from the stopping groove 413 of the outer ring 410 through rotational operation thereof. When the rotation control lever 440 is inserted thereinto, rotation of the outer ring 410 is blocked, and when the rotation control lever 440 is removed therefrom, rotation of the outer ring 410 is possible.

In the automatic direction switching pendulum-type rotary drive gear ratchet tensioner having an unlimited tension distance adjustment function for indirect live wire work 1 according to the present invention, the roller shaft operating plate 500 is configured to transmit rotational force to the roller shaft 310.

To this end, the roller shaft operating plate 500 is formed to have a circular plate shape with a certain thickness so as to be coupled to the circumference of the roller shaft 310 on the front side of the clutch part 400. Here, the roller shaft operating plate 500 has triangular-shaped saw teeth 510 provided on the circumference of a middle portion thereof and formed to protrude from the middle portion.

In the configuration of the automatic direction switching pendulum-type rotary drive gear ratchet tensioner having an unlimited tension distance adjustment function for indirect live wire work 1 according to the present invention, the pendulum 600 is configured to control, through pendulum motion, reciprocating rotation operation of an automatic reversing pawl 800 to be described later.

To this end, the pendulum 600 is configured to penetrate the rear side of the roller shaft operating plate 500 without rotational interference. Further, the pendulum 600 protrudes from one side thereof and has a horizontal long hole 610 formed therein and configured to accommodate the cam 220 of the rotary operating lever 200. When the cam 220 is rotated, the cam 220 interferes with the horizontal long hole 610 so as to perform pendulum motion in which the pendulum 600 reciprocates relative to the roller shaft 310.

In addition, the pendulum 600 has an automatic reversing pawl mounting groove 620 formed therein and configured to allow the automatic reversing pawl 800 to be described later to be mounted on the front surface between the rotary operating shaft 210 and the roller shaft operating plate 500.

In the configuration of the automatic direction switching pendulum-type rotary drive gear ratchet tensioner having an unlimited tension distance adjustment function for indirect live wire work 1 according to the present invention, the roller shaft support plate 700 is configured to allow the pawl reversing key 900 to be described later to be mounted thereon.

To this end, the roller shaft support plate 700 is configured to penetrate the front side of the roller shaft operating plate 500 without rotational interference. Further, the roller shaft support plate 700 is configured to be coupled to the pendulum 600 so as to constrain the roller shaft operating plate 500, and is formed to protrude toward the rotary operating shaft 210.

In the configuration of the automatic direction switching pendulum-type rotary drive gear ratchet tensioner having an unlimited tension distance adjustment function for indirect live wire work 1 according to the present invention, the automatic reversing pawl 800 is configured to interfere with the roller shaft operating plate 500 so as to automatically perform forward rotation or reverse rotation of the roller shaft operating plate 500.

To this end, the automatic reversing pawl 800 is configured to be coupled to the automatic reversing pawl mounting groove 620 of the pendulum 600 with a pawl shaft 801, thereby enabling the roller shaft operating plate 500 to perform reciprocating pendulum motion.

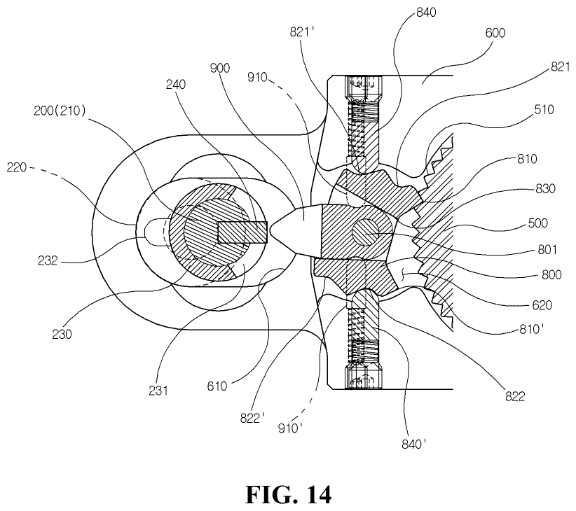

Meanwhile, in the present invention, referring to FIG. 14, the automatic reversing pawl 800 has first and second triangular locking protrusions 810 and 810′ formed on the tip portion thereof, that is, disposed toward the side of the roller shaft operating plate 500, in which the first and second triangular locking protrusions 810 and 810′ are formed to protrude symmetrically and are selectively engaged with the saw teeth 510 of the roller shaft operating plate 500.

Further, the automatic reversing pawl 800 includes first locking grooves 821 and 821′ and second locking grooves 822 and 822′ each formed to have a curved curvature and disposed around the automatic reversing pawl 800. In this case, the first locking grooves 821 821′ and the second locking grooves 822 and 822′ are configured to be symmetrical to each other so that the first locking groove 821 and the second locking groove 822 are respectively located on the first and second locking protrusions 810 and 810′.

Additionally, the automatic reversing pawl 800 has a reversing key mounting groove 830 formed at a central portion thereof and configured to allow the pawl revering key 900 to be described later to be mounted therein. The reversing key mounting groove 830 is configured to have a tapered groove shape extending from the roller shaft operating plate 500 side to the rotary operating shaft 210 side.

Meanwhile, the automatic reversing pawl 800 is configured to be installed through first and second reversing pawl spring balls 840 and 840′. The first and second reversing pawl spring balls 840 and 840′ are configured to be coupled to the pendulum 600 so as to have elasticity allowing the first and second reversing pawl spring balls 840 and 840′ to protrude toward the automatic reversing pawl 800.

In this case, in the present invention, the first and second reversing pawl spring balls 840 and 840′ are configured to interfere with the first locking grooves 821 and 821′ and the second locking grooves 822 and 822′. Here, the first reversing pawl spring ball 840 is configured to interfere with any corresponding one of the first locking grooves 821 and 821′ at a location at which the first reversing pawl spring ball 840 and the corresponding one intersect each other, and the second reversing pawl spring ball 840′ is configured to interfere with any corresponding one of the second locking grooves 822 and 822′ at a location at which the second reversing pawl spring ball 840′ and the corresponding one intersect each other.

For example, when the roller shaft operating plate 500 is rotated in the forward direction, that is, rotated clockwise, the first revering pawl spring ball 840 located on one side of the pendulum 600 is desirably caught in the first locking groove 821′ located on one side of the automatic reversing pawl 800, and the first reverse pawl spring ball 840′ located on the other side of the pendulum 600 is desirably caught in the second locking groove 822 located on the other side of the automatic reversing pawl 800. Conversely, when the roller shaft operating plate 500 is rotated counterclockwise, the first revering pawl spring ball 840 located on one side of the pendulum 600 is desirably caught in the first locking groove 821 located on one side of the automatic reversing pawl 800, and the first reverse pawl spring ball 840′ located on the other side of the pendulum 600 is desirably caught in the second locking groove 822′ located on the other side of the automatic reversing pawl 800.

In the configuration of the automatic direction switching pendulum-type rotary drive gear ratchet tensioner having an unlimited tension distance adjustment function for indirect live wire work 1 according to the present invention, the pawl reversing key 900 is configured to provide reciprocating rotational force to the automatic revering pawl 800.

To this end, the pawl reversing key 900 is accommodated in the reversing key mounting groove 830 of the automatic reversing paw1 800. Further, the pawl reversing key 900 is coupled to the roller shaft support plate 700 with the same pawl shaft 801 as the automatic reversing pawl 800 and protrudes from one side thereof, that is, protrudes toward the rotary operating shaft 210. In the process of rotating the rotary operating shaft 210, the pawl reversing key 900 is configured to interfere with the locking protrusion 232 of the rotary operating mechanism 230, thereby performing reciprocating pendulum motion.

In this case, the pawl reversing key 900 is configured to have horizontal force so as to constantly maintain horizontality thereof. To this end, opposite sides of the pawl reversing key 900 are configured to be elastically installed by first and second reversing key spring balls 910 and 910′ respectively formed on opposite sides of the roller shaft support plate 700 relative to the pawl shaft 801.

In the configuration of the automatic direction switching pendulum-type rotary drive gear ratchet tensioner having an unlimited tension distance adjustment function for indirect live wire work 1 according to the present invention, the roller shaft rotary lever 1000 is configured to transmit rotational force of the roller shaft operating plate 500 to the roller shaft 310.

To this end, the roller shaft rotary lever 1000 is configured to be coupled to the front side of the roller shaft 310 and the roller shaft operating plate 500. Further, the roller shaft rotary lever is configured to be rotated in conjunction with the roller shaft 310 and the roller shaft operating plate 500.

In the configuration of the automatic direction switching pendulum-type rotary drive gear ratchet tensioner having an unlimited tension distance adjustment function for indirect live wire work 1 according to the present invention, the insulating rope 1100 is configured to be wound through the open side of the body 100 and unwound through the insulating rope guide groove 320 of the gear roller 300. Here, the insulating rope may be wound or unwound through the insulating rope guide groove during forward rotation of the gear roller 300 or reverse rotation thereof.

Here, the insulating rope 1100 passing through the gear roller 300 is configured such that the insulating rope is pulled or released by a worker through the lower portion of the gear roller in the drawing, and the insulating rope on the upper portion of the gear roller in the drawing is fixed to the insulating rope connection part 140 and forms a tension direction of the insulating rope connected to the wire through a wire clip 1200 to be described later. The insulating rope 1100 passing through the gear roller is primarily pressurized by the pressurization protrusions 330 and 330′ of the gear roller 300. Then, the insulating rope is secondarily pressurized by the insulating rope pressurization opening/closing means 170, thereby increasing the tension limit when tension is applied to the insulating rope.

In the configuration of the automatic direction switching pendulum-type rotary drive gear ratchet tensioner having an unlimited tension distance adjustment function for indirect live wire work 1 according to the present invention, the wire clip 1200 is configured to be connected to the insulating rope connection part 140 in the tension direction of the insulating rope 1100 released from the body 100 and enables the wire to be gripped and fixed thereto during normal wiring work.

In this case, the wire clip 1200 in the present invention may not be newly implemented. For example, a normal clamp capable of gripping a wire may be applied to the wire clip.

In particular, the wire clip 1200 in the present invention may use a wire clip applied to an automatic direction switching pendulum-type rotary drive ratchet wire grip for indirect live wire work capable of gripping a wire during indirect live line work, which was invented by the applicant of the present invention and disclosed in Korean Patent No. 10-2161405.

Hereinafter, the operation of the automatic direction switching pendulum-type rotary drive gear ratchet tensioner having an unlimited tension distance adjustment function for indirect live wire work according to the present invention having the above configuration will be described in detail with reference to the attached drawings.

With reference to FIGS. 1 to 14, the automatic direction switching pendulum-type rotary drive gear ratchet tensioner having an unlimited tension distance adjustment function for indirect live wire work 1 according to the present invention is configured to apply forward or reverse rotational force to the roller shaft 310 so as to pull or release the insulating rope 1100, thereby adjusting tension of the wire. In this case, even if a separate direction switching lever is not operated, by using a stick for live wire work equipped with an electric mechanism and the like, it is possible to perform forward or reverse rotation of the roller shaft 310 by simply adjusting the rotation direction of the rotary operating shaft 210 during indirect live wire work in a state in which a safe distance is secured between a worker and a distribution line.

Here, in the automatic direction switching pendulum-type rotary drive gear ratchet tensioner having an unlimited tension distance adjustment function for indirect live wire work 1 according to the present invention, first, in order to pull the wire and the insulating rope 1100 using the gear ratchet tensioner, the roller shaft 310 is rotatably driven clockwise, that is, in the forward direction. Hereinafter, the above-described operating state will be described.

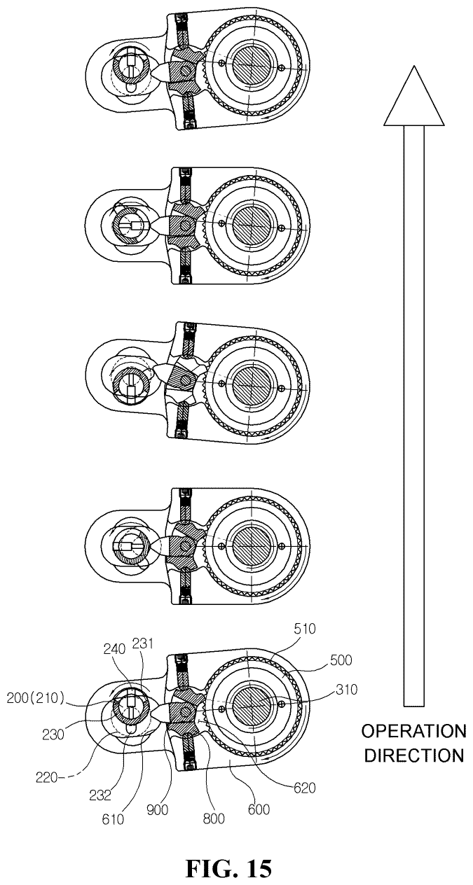

To this end, referring to FIG. 15, the rotary operating lever 200 is simply rotated counterclockwise. At this time, the rotation control lever 440 is inserted into any one of the stopping grooves 413 of the outer ring 410 so as to prevent rotation of the outer ring 410.

Accordingly, when the rotary operating lever 200 is operated to rotate the rotary operating shaft 210 counterclockwise, the cam 220 is rotated within the horizontal long hole 610 of the pendulum 600. In this process, the pendulum 600 is subjected to reciprocating pendulum motion relative to the roller shaft 310.

Simultaneously, the locking protrusion 232 of the rotary operating mechanism 230 formed on the rotary operating shaft 210 turns the pawl reversing key 900 toward the first locking grooves 821 and 821′. Accordingly, the pawl reversing key 900 pushes the automatic revering pawl 800 in the direction of the first locking grooves 821 and 821′ and rotates the same clockwise around the pawl shaft 801. In this case, the first locking protrusion 810 on the first locking groove 821 side is engaged with the saw teeth 510 of the roller shaft operating plate 500.

Accordingly, when the rotary operating shaft 210 is continuously rotated, the pendulum 600 performs reciprocating pendulum motion by operation of the cam 220 and the horizontal long hole 610. In this process, the pawl reversing key 900 rotated in the rotation direction due to interference with the locking protrusion 232 of the rotary operating mechanism 230 supports the first locking grooves 821 and 821′ side of the automatic reversing pawl 800 and rotatably pushes the roller shaft operating plate 500 that is engaged with the automatic reversing pawl 800 and performs reciprocating pendulum motion with the pendulum 600. In this case, the roller shaft 310 is rotated in conjunction with forward rotation of the roller shaft operating plate 500, thereby rotating the gear roller 300 and pulling the pressurized insulating rope.

Meanwhile, in the present invention, as described above, reverse rotation of the roller shaft 310 is prevented when rotation of the roller shaft 310 is performed to obtain tension, which is made possible by the clutch part 400.

Here, in the present invention, the clutch part 400 is formed of the backstop ratchet ring 401. Reverse rotation is prevented by the backstop ratchet ring 401, and an operation process of the backstop ratchet ring 401 will be described below.

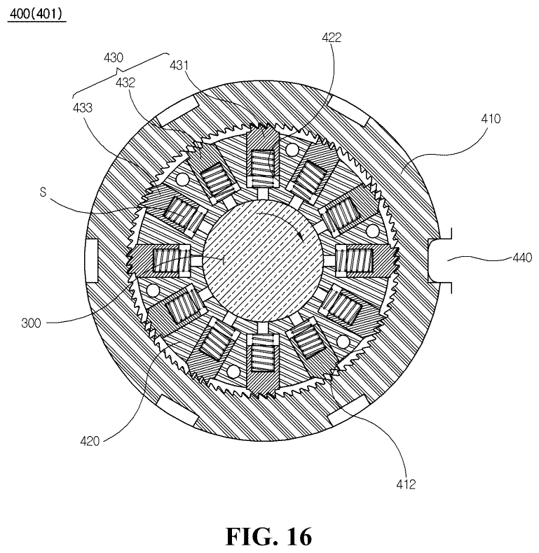

Referring to FIG. 16, when the inner ring 420 coupled to the roller shaft 310 is rotated in the forward direction, the inclined portions of the engagement tool saw teeth 431b, 432b, and 433b of the first, second, and third engagement tools 431a, 432a, and 433a respectively forming the first, second, and third multi-angle bundle pawls 431, 432, and 433 pass over the inclined portions of the outer ring saw teeth 412 of the outer ring 410.

That is, since the springs S are respectively installed in the first, second, and third engagement tools 431a, 432a, and 433a of the inner ring 420, the engagement tool saw teeth 431b, 432b, and 433b that pass over the outer ring saw teeth 412 are pushed rearwards by compressive force of the springs S, and simultaneously, the inclined portions of the outer ring saw teeth 412 and the inclined portions of the engagement tool saw teeth 431b, 432b, and 433b slide and move over each other.

Meanwhile, in a state in which the forward drive as described above is stopped, rotational force causing the inner ring 420 to be rotated in the reverse direction may be generated by tension of the insulating rope 1100. In this case, in the backstop ratchet ring 401, any one of the engagement tool saw teeth 431b, 432b, and 433b respectively formed on the first, second, and third engagement tools 431a, 432a, and 433a of the first, second, and third multi-angle bundle pawls 431, 432, and 433 is engaged with the outer ring saw teeth 412, thereby preventing reverse rotation of the inner ring 420. Accordingly, it is possible to stably wind the insulating rope 1100 and to reliably apply tension to the insulating rope 1100.

In particular, in the present invention, as described above, in the process of rotating the inner ring 420, the drive gear 423a formed on the inner ring 420 is configured to be engaged with the idle gear 120 of the body 100. Here, rotational force is transmitted to the idle gear 120. Then, rotational force is transmitted from the idle gear to the interlocking gear 130. In this process, rotational force of the interlocking gear 130 and rotational force of the drive gear 423a are applied in the same direction.

In this case, the interlocking gear 130 has the support roller 131 formed thereon. When the support roller 131 is rotated, the gear roller 300 is rotated by pressurization from the pressurizing roller 172. Accordingly, the insulating rope 1100 is pulled by rotation of the gear roller 300, thereby increasing the tension limit.

Conversely, when the insulating rope 1100 is unwound from the gear roller 300 so as to release tension of the insulating rope 1100, the roller shaft 310 is rotated counterclockwise, that is, in the reverse direction. The above-described operating state of the roller shaft 310 will be described below.

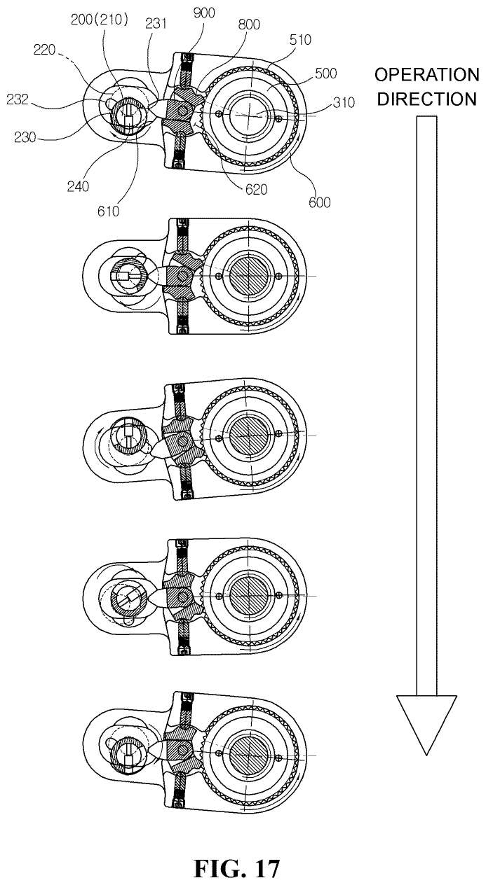

Referring to FIG. 17, when the rotary operating lever 200 is operated to rotate the rotary operating shaft 210 clockwise, the cam 220 is rotated within the horizontal long hole 610 of the pendulum 600. In this process, the pendulum 600 is subjected to reciprocating pendulum motion relative to the roller shaft 310.

In this case, the locking protrusion 232 of the rotary operating mechanism 230 formed on the rotary operating shaft 210 rotatably pushes the pawl reversing key 900 toward the second locking grooves 822 and 822′. Accordingly, the pawl reversing key 900 pushes the automatic reversing pawl 800 in the direction of the second locking grooves 822 and 822′ so as to rotate the automatic reversing pawl 800 counterclockwise around the pawl shaft 801. At this time, the second locking protrusion 810′ on the second locking groove 822 side of the automatic reversing pawl 800 is engaged with the saw teeth 510 of the roller shaft operating plate 500.

Accordingly, when the rotary operating shaft 210 is continuously rotated, the pendulum 600 performs reciprocating pendulum motion by operation of the cam 220 and the horizontal long hole 610. In this process, the pawl reversing key 900 rotated in the rotation direction due to interference with the locking protrusion 232 of the rotary operating mechanism 230 supports the second locking groove 822′ side of the automatic reversing pawl 800 and rotatably pushes the roller shaft operating plate 500 that is engaged with the automatic reversing pawl 800 and performs reciprocating pendulum motion with the pendulum 600. In this case, the roller shaft 310 is rotated in conjunction with reverse rotation of the roller shaft operating plate 500, thereby unwinding the insulating rope 1100 from the gear roller.

Meanwhile, in the present invention, as described above, when the outer ring 410 is driven by the reverse operation of the inner ring 420, backlash (backward movement) of the inner ring 420 is maximally reduced so that the possibility of backlash is close to zero, thereby making it possible to prevent impact during power transmission.

The above-described operation may be performed by the multi-angle bundle pawl unit 430 configured to transmit rotational force of the inner ring 420 to the outer ring 410.

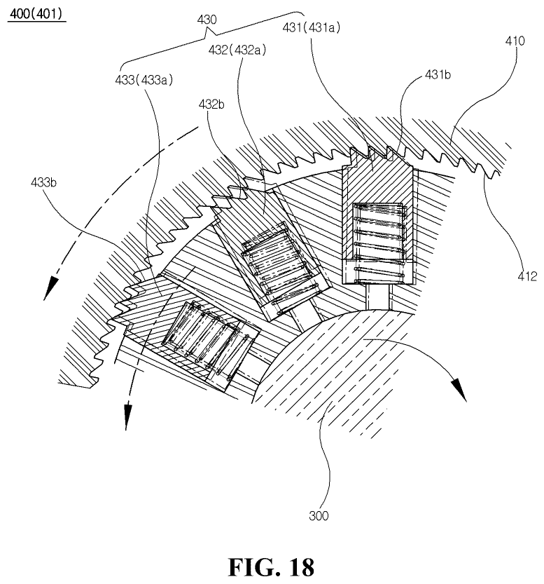

That is, with reference to FIG. 18, in the present invention, the first, second, and third engagement tool saw teeth 431b, 432b, and 433b of the first, second, and third engagement tool 431a, 432a, and 433a of the first, second, and third multi-angle bundle pawls 431, 432, and 433 are sequentially engaged with the outer ring saw teeth 412 of the outer ring 410.

For example, when the straight portions of the engagement tool saw teeth 431b of the first engagement tool 431a are respectively in contact with the straight portions of the outer ring saw teeth 412 so as to enter the engagement state therebetween, the straight portions of the engagement tool saw teeth 432b of the second engagement tool 432a are respectively located at the ends of the inclined portions of the outer ring saw teeth 412. In this manner, the engagement tool saw teeth 432b are not engaged with the outer ring saw teeth 412. In addition, the straight portions of the engagement tool saw teeth 433b of the third engagement tool 433a are respectively located at the middle portions of the inclined portions of the outer ring saw teeth 412. Accordingly, when the inner ring 420 is rotated, the first, second, and third engagement tools 431a, 432a, and 433a sequentially apply engagement force to the outer ring saw teeth 412. As a result, the multi-angle bundle pawl unit 430 is constantly engaged with the outer ring saw teeth 412 in a sequential manner.

That is, in the backstop ratchet ring 401, segmented engagement sections of the engagement tool saw teeth 431b, 432b, and 433b are provided within one pitch of the outer ring saw teeth 412. Accordingly, even if slight rotation occurs, engagement force is achieved at sequential positions respectively having different angles in a sequential manner. As a result, when reverse power is transmitted, precise power transmission may be performed without backlash occurrence.

Particularly, in the present invention, as described above, in the process of rotating the inner ring 420, the drive gear 423a formed on the inner ring 420 is configured to be engaged with the idle gear 120 of the body 100. In this case, rotational force is transmitted to the idle gear 120. Then, rotational force is transmitted from the ideal gear to the interlocking gear 130. In this process, the interlocking gear 130 has the same direction rotational force as that of the drive gear 423a.

In this case, the interlocking gear 130 has the support roller 131 formed thereon. When the support roller 131 is rotated, the gear roller 300 is rotated by pressurization from the pressurizing roller 172. Accordingly, the insulating rope 1100 is released by rotation of the gear roller, thereby preventing rapid release of the insulating rope 1100.

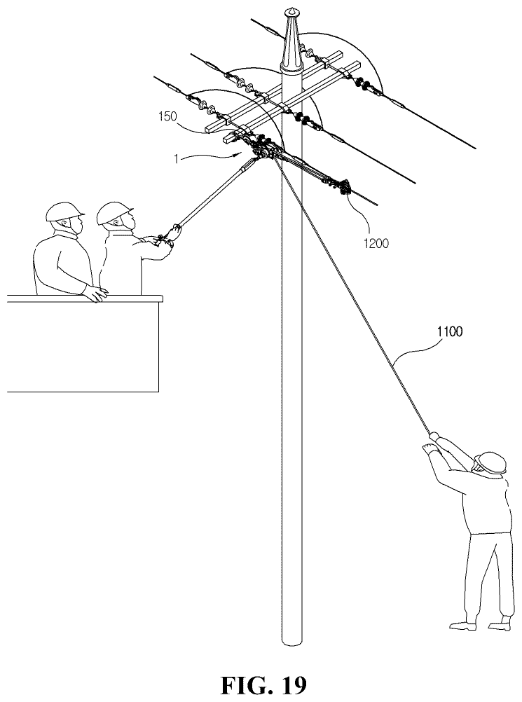

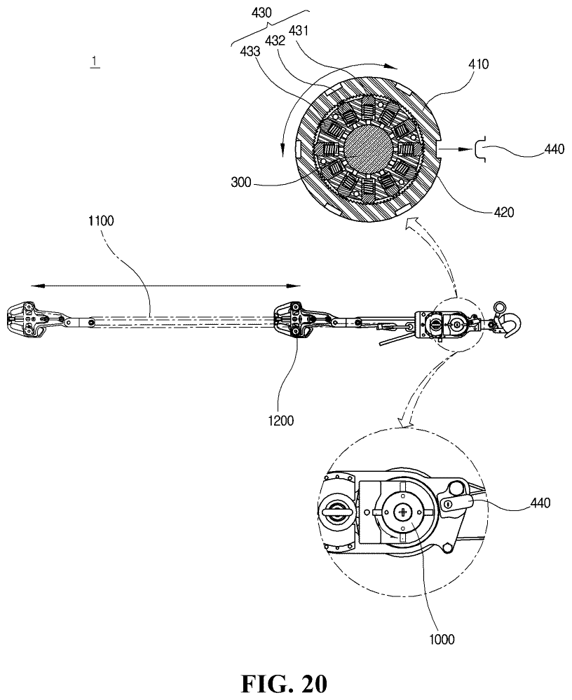

That is, referring to FIG. 19, the automatic direction switching pendulum-type rotary drive gear ratchet tensioner having an unlimited tension distance adjustment function for indirect live wire work 1 according to the present invention enables stable operation by preventing reverse rotation of the gear roller 300 during indirect live wire work. In particular, since the length of the insulating rope 1100 is not limited, the tension limit of the wire 10 is further increased.

Meanwhile, referring to FIG. 20, when a worker wants to sufficiently pull or release the insulating rope 1100 during work preparation time before or after using the automatic direction switching pendulum-type rotary drive gear ratchet tensioner having an unlimited tension distance adjustment function for indirect live wire work 1 according to the present invention, it is possible to simply perform manual rotation of the roller shaft 310 without operation of the rotary operating lever 200. Accordingly, the insulating rope may be reliably pulled or released by controlling manual rotation of the rolling shaft rotary lever 1000 connected to the roller shaft 310 in a state in which the rotation control lever 440 is separated from the stopping groove 413 of the outer ring 410.

Hereinafter, an uninterruptible power distribution method of performing indirect live wire work, using the automatic direction switching pendulum-type rotary drive gear ratchet tensioner having an unlimited tension distance adjustment function for indirect live wire work according to the present invention having the above-described configuration will be described in detail with reference to the attached drawings.

Referring to FIGS. 1 to 20, the method of performing indirect live wire work, using the automatic direction switching pendulum-type rotary drive gear ratchet tensioner having an unlimited tension distance adjustment function for indirect live wire work is capable of performing relocation of an electric pole, replacement of an electric pole, and change of an electric pole route without power interruption. The above-described work may be performed by the automatic direction switching pendulum-type rotary drive gear ratchet tensioner having an unlimited tension distance adjustment function for indirect live wire work 1 through various embodiments.

Hereinafter, the embodiments will be described.

### First Embodiment

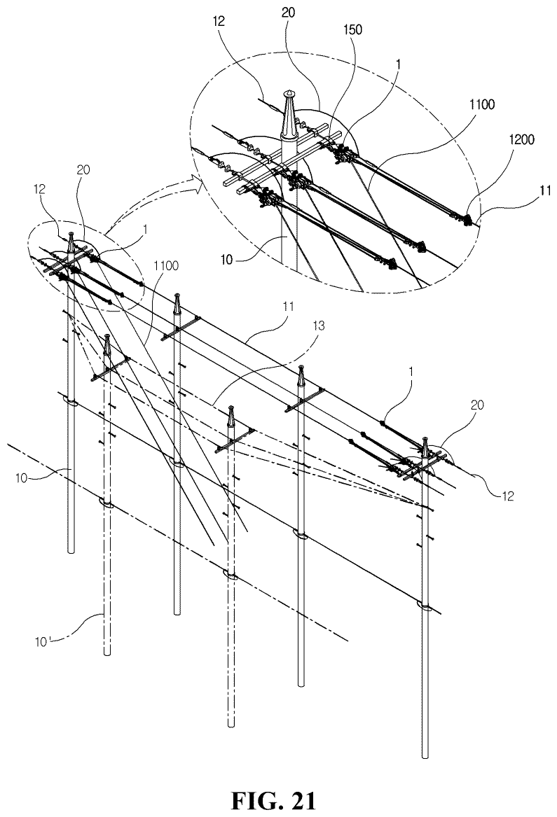

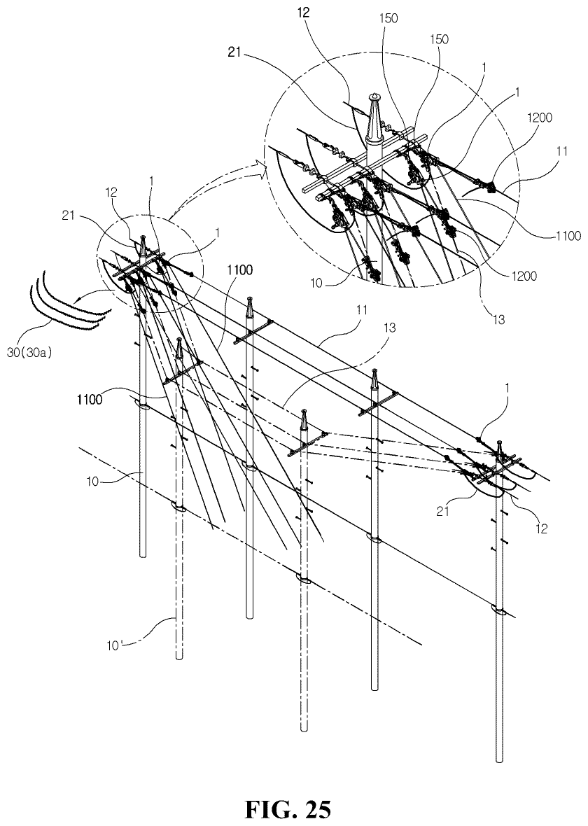

Referring to FIGS. 21 to 26, relocation of an electric pole, replacement of an electric pole, and change of an electric pole route are performed in a state in which power transmission is performed through a wire.

First, referring to FIG. 21, when relocation of an electric pole, replacement of an electric pole, and change of an electric pole route are performed in the state in which power transmission is performed through the wire, normally, the above-described work is performed on a start electric pole and an end electric pole located within a work section in the state in which power transmission is performed through the wire, and installation of a new electric pole 10′, installation of components mounted on the new electric pole, and installation of a new wire 13 on the new electric pole are performed in a state in which power transmission is not performed through the wire. In this manner, preparation work is performed for wiring work in the state in which power transmission is performed through the wire.

Afterwards, the automatic direction switching pendulum-type rotary drive gear ratchet tensioner having an unlimited tension distance adjustment function for indirect live wire work 1 according to the present invention is installed on the wire.

The hook 150 of the gear ratchet tensioner 1 is fixed to an arm-shaped support member at the inner position of each of the start electric pole 10 and the end electric pole 10 within a work section. Thereafter, on a wire located within electric poles and located in a region in which wiring work is safely performed in the state in which power transmission is not performed through the wire, the wire clip 1200 is used to grab a wire to be removed 11 and is installed thereon.

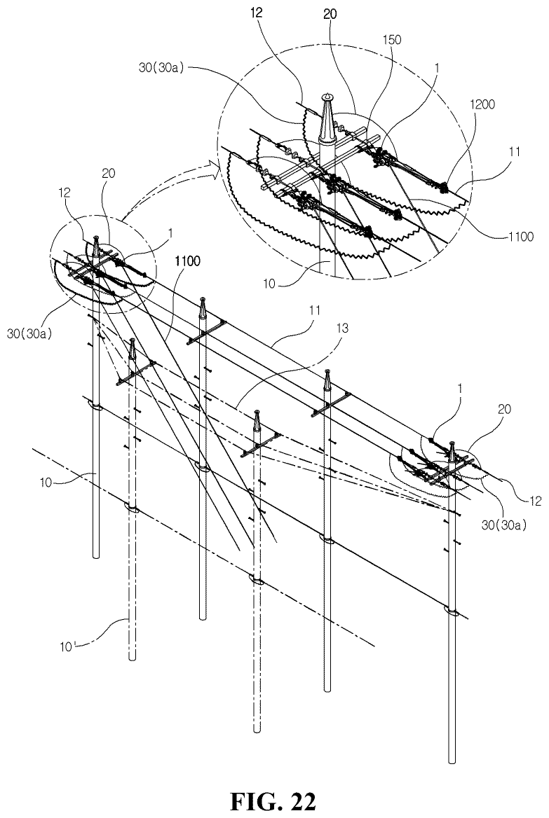

Thereafter, referring to FIG. 22, the wire to be removed 11 located inside the work section and an old wire 12 located outside the work section are bypass-connected to each other.

First, each of the bypass jumper means 30 has one end connected to a corresponding one of both ends of the wire to be removed 11 located inside the work section.

Each of the bypass jumper means 30 has the other end connected to a corresponding one of the old wires 12 located outside the work section in which the start and end electric poles 10 are installed, and the wire to be removed 11 and the old wire 12 are connected to each other through the bypass jumper means.

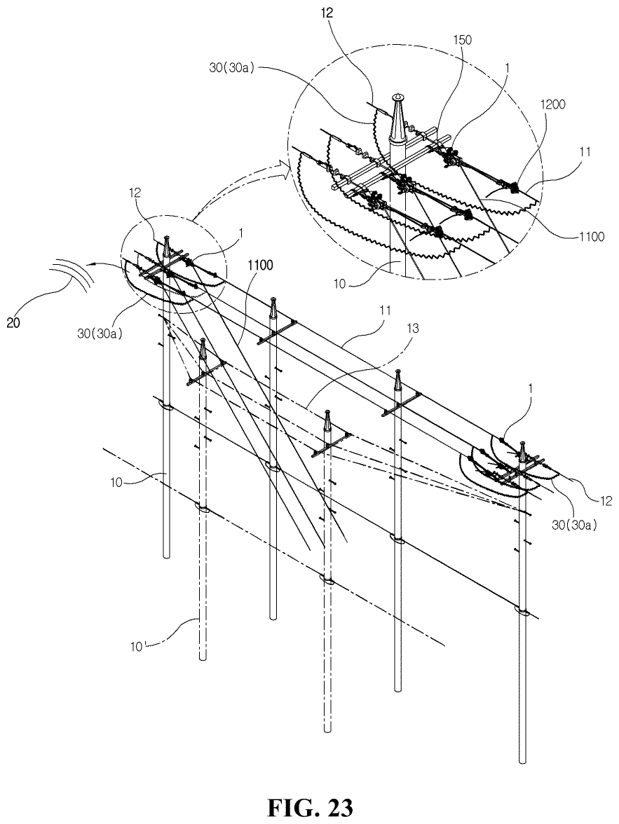

Afterwards, referring to FIG. 23, the wire to be removed 11 located inside the work section is separated.

First, jumper wires 20 configured to respectively connect the wires to be removed 11 to the old wires 12 are sequentially separated from the start and end electric poles 10 of the work section.

Then, the wire to be removed 11 is separated. Here, both ends of the wire to be removed 11 located between the electric poles within the work section are respectively separated from suspension insulators (not shown in the drawing) respectively installed on the electric poles 10, thereby securing a safe space for wiring work in the state in which power transmission is not performed through the wire. Here, stretching the new wire 13 and pulling the new wire 13 to obtain an appropriate dip thereof are performed in the safe space for wiring work.

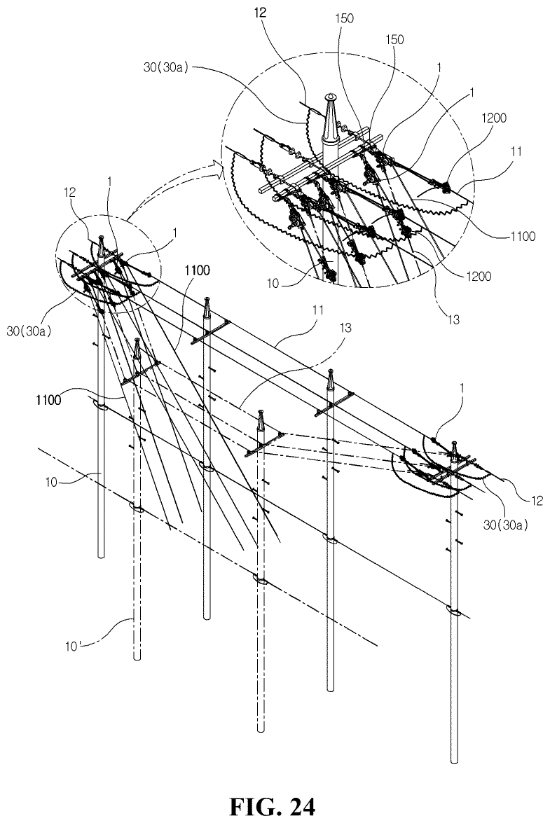

Thereafter, referring to FIG. 24, the new wire 13 is installed.

The new wire 13 of the new electric pole 10′ is stretched. Then, the stretched new wire 13 is connected to the suspension insulator from which the wire to be removed 11 is separated. Then, the new wire is pulled to obtain an appropriate dip thereof.

After this work, referring to FIG. 24, a new jumper wire 21 is installed.

Here, the new wires 13 connected to the start and end electric poles 10 located within the work section are respectively connected to the old wires 12 located outside the work section through the bypass jumper means in a sequential manner using the respective new jumper wires 21, and the already installed bypass jumper means 30 is separated from the wire so as to allow the wire to be removed 11 to enter the state in which power transmission is not performed through the wire to be removed.

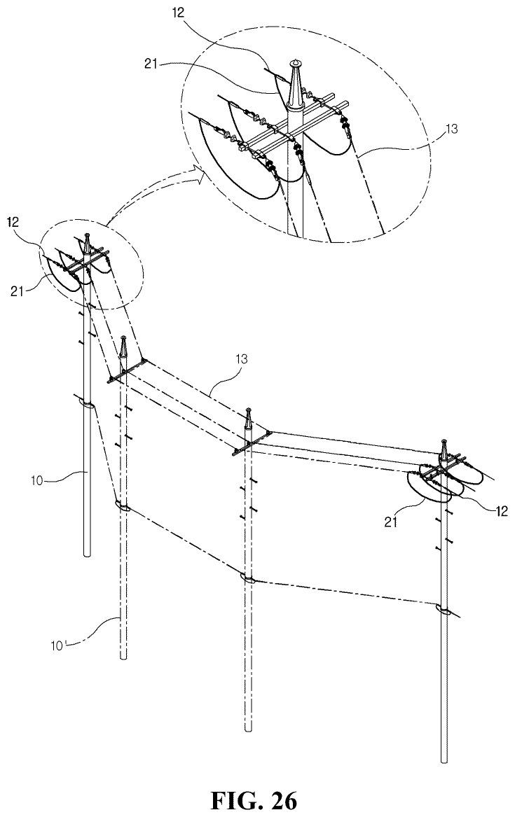

Afterwards, referring to FIG. 26, the wire to be removed 11 in the state in which power transmission is not performed through the wire to be removed is removed.

Then, while the insulating rope 1100 of the gear ratchet tensioner 1 is released, the wire to be removed 11 in the tensioned state is lowered to the ground and removed. Next, the electric poles 10 in the work section are sequentially removed, thereby completing wiring work for the new wire 13 in the state in which power transmission is performed through the wire.

Meanwhile, in the present invention, when the wire to be removed 11 located between the electric poles is separated, the new wire 13 is installed, and the wire to be removed 11 is removed by using the automatic direction switching pendulum-type rotary drive gear ratchet tensioner having an unlimited tension distance adjustment function for indirect live wire work 1 that holds the wire to be removed 11 and the new wire 13, the rotary operating lever 200 is operated in the forward or reverse direction so as to cause the pendulum 600 to perform reciprocating pendulum motion. Accordingly, it is possible to adjust tension of the insulating rope by rotating the automatic reversing pawl 800 and rotating the roller shaft 310 connected to the roller shaft operating plate 500 in the forward or reverse direction so as to pull or release the insulating rope 1100. In order to adjust tension of the wire to be removed 11 and the new wire 13, tension adjustment may be performed by stopping or rotating the outer ring 410 through attachment and detachment operation of the rotation control lever 440.

That is, in order to rotate the gear roller 300 and pull the insulating rope 1100 so as to apply tension to the wire, the rotation control lever 440 needs to be operated in a state of being fitted into the stopping groove 413 of the outer ring 410.

Thereafter, a stick for live wire work is used to rotate the rotary operating lever 200 counterclockwise in a state in which a safe distance is secured between the worker and the wire. Accordingly, the roller shaft 310 pulls the insulating rope 1100 through clockwise rotation thereof, thereby applying tension to the wire to be removed 11 and the new wire 13.

Meanwhile, in the present invention, as described above, referring to FIGS. 15 and 16, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to pull the insulating rope 1100. Since this operation has been described above, a detailed description thereof is omitted.

Thereafter, conversely, in order to release tension of the wire to be removed and the new wire, it is required to rotate the rotary operating lever 200 clockwise using the stick for live wire work in a state in which a safe distance is secured between the wire and the worker. Here, the roller shaft 310 releases the insulating rope 1100 through counterclockwise rotation thereof, thereby releasing tension of the wire to be removed 11 and the new wire 13.

Meanwhile, in the present invention, as described above, referring to FIGS. 17 and 18, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to release the insulating rope 1100. Since this operation has been described above, a detailed description thereof is omitted.

That is, when separation of the wire to be removed 11 located between the electric poles, installation of the new wire 13, and removal of the wire to be removed 11 are performed using the automatic direction switching pendulum-type rotary drive gear ratchet tensioner having an unlimited tension distance adjustment function for indirect live wire work 1 according to the present invention, as described above, forward or reverse rotation of the roller shaft 310 is performed by adjusting forward or reverse direction of the rotary operating lever 200. Accordingly, the insulating rope 1100 may be pulled or released through rotation of the gear roller 300, thereby making it possible to adjust tension of the wire to be removed 11 and the new wire 13.

Meanwhile, in the present invention, when the above-described series of processes is performed, the processes may be sequentially and repeatedly performed for each of the three-phase wires.

Meanwhile, in the first to fifth embodiments of the present invention, each process is described on the basis of a single phase, but in the case of three-phase wires, the same process may be repeatedly performed for each of the three-phase wires.

### Second Embodiment

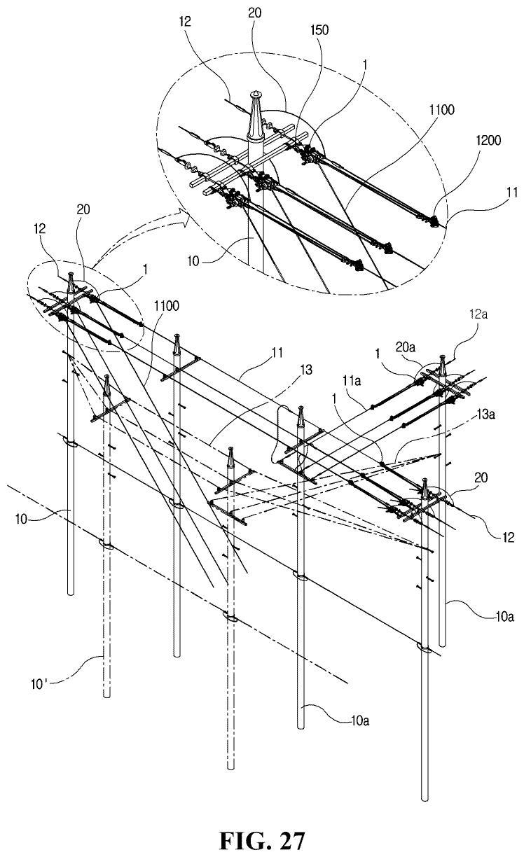

Referring to FIGS. 27 to 32, in this case, an electric pole for a branch wire 10a is located within the work section, and relocation of an electric pole, replacement of an electric pole, and change of an electric pole route are performed in a state in which power transmission is performed through a wire.

First, referring to FIG. 27, when relocation of an electric pole, replacement of an electric pole, and change of an electric pole route are performed in the state in which power transmission is performed through the wire, normally, the above-described work is performed on a start electric pole and an end electric pole located within a work section in the state in which power transmission is performed through the wire, and installation of the new electric pole 10′, installation of components mounted on the new electric pole, and wiring work of the new wire 13 are performed in a state in which power transmission is not performed through the wire. In this manner, preparation work is performed for wiring work in the state in which power transmission is performed through the wire.

Afterwards, the automatic direction switching pendulum-type rotary drive gear ratchet tensioner having an unlimited tension distance adjustment function for indirect live wire work 1 according to the present invention is installed on the wire.

The hook 150 of the gear ratchet tensioner 1 is fixed to an arm-shaped support member at the inner position of each of the start electric pole 10 and the end electric pole 10 within a work section in which the electric pole for a branch wire 10a is located. Thereafter, on a wire located between the electric poles installed in a region where wiring work is safely performed in the state in which power transmission is not performed through the wire, the wire clip 1200 is used to grab the wire to be removed 11 and is installed thereon.

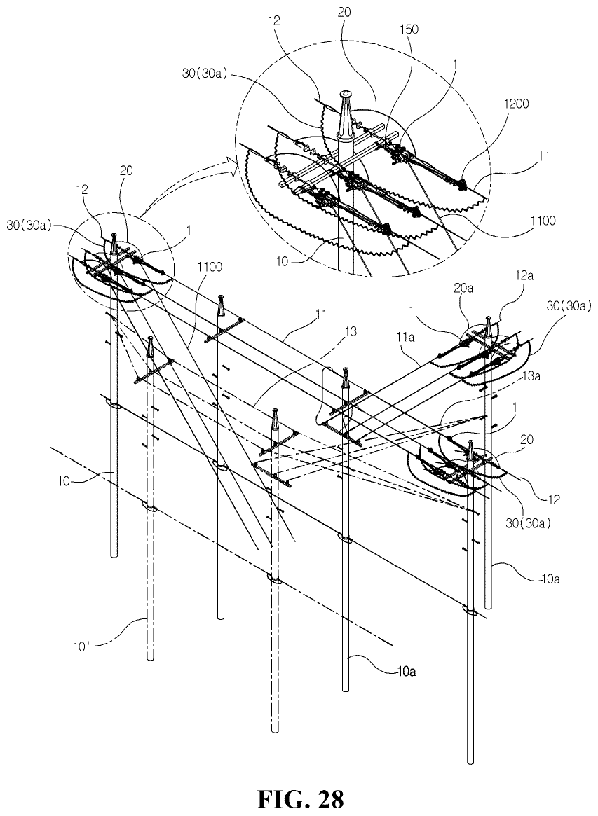

Thereafter, referring to FIG. 28, the wire to be removed 11 located inside the work section and the old wire 12 located outside the work section are connected to each other through the bypass jumper means.

First, each of the bypass jumper means 30 has one end connected to a corresponding one of both ends of the wire to be removed 11 located inside the work section.

Each of the bypass jumper means 30 has the other end connected to a corresponding one of the old wires 12 located outside the work section in which the start and end electric poles 10 are installed, and the wire to be removed 11 and the old wire 12 are connected to each other through the bypass jumper means.

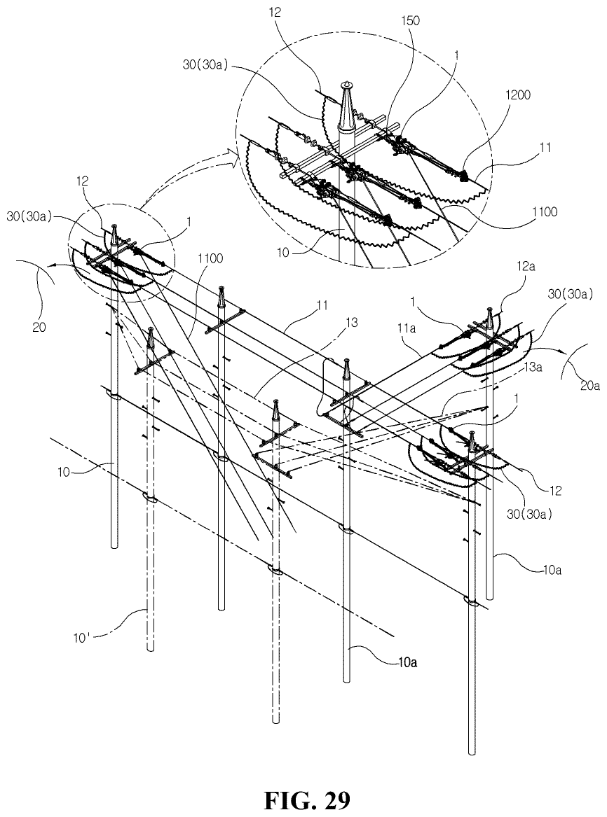

Afterwards, referring to FIG. 29, the wire to be removed 11 located inside the work section is separated.

First, the jumper wires 20 configured to respectively connect the wires to be removed 11 to the old wires 12 are sequentially separated from the start and end electric poles 10 of the work section.

Then, the wire to be removed 11 is separated. Here, both ends of the wire to be removed 11 located between the electric poles within the work section are respectively separated from suspension insulators (not shown in the drawing) respectively installed on the electric poles 10, thereby securing a safe space for wiring work in the state in which power transmission is not performed through the wire. Here, stretching the new wire 13 and pulling the new wire 13 to obtain an appropriate dip thereof are performed in the safe space for wiring work.

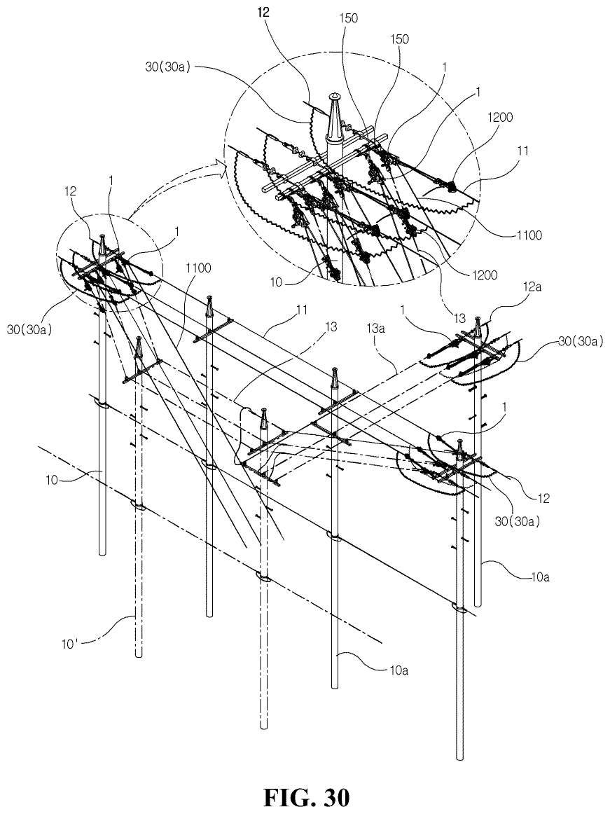

Thereafter, referring to FIG. 30, the new wire 13 is installed.

The new wire 13 of the new electric pole 10′ is stretched. Then, the stretched new wire 13 is connected to the suspension insulator from which the wire to be removed 11 is separated. Then, the new wire is pulled to obtain an appropriate dip thereof.

Afterwards, referring back to FIG. 27, the automatic direction switching pendulum-type rotary drive gear ratchet tensioner having an unlimited tension distance adjustment function for indirect live wire work 1 according to the present invention is installed on the electric pole for a branch wire 10a.

The hook 150 of the gear ratchet tensioner 1 is fixed to an arm-shaped support member at the inner position of the work section in which the electric pole for a branch wire 10a is located. Thereafter, on a wire located between the electric poles installed in a region where wiring work is safely performed in the state in which power transmission is not performed through the wire, the wire clip 1200 is used to grab a wire to be removed 11a and is installed thereon.

Thereafter, referring to FIG. 28, the wire to be removed 11a located inside the work section in which the electric pole for a branch wire 10a is installed and an old wire 12a located outside the work section are connected to each other through the bypass jumper means.

First, one end of the bypass jumper means 30 is connected to the end of the wire to be removed 11 located inside the work section.

The other end of the bypass jumper means 30 is connected to the old wire 12a located outside the work section in which the electric pole for a branch wire 10a is installed, and the wire to be removed 11a and the old wire 12a are connected to each other through the bypass jumper means.

Afterwards, referring to FIG. 29, the wire to be removed 11a located inside the work section is separated.

First, jumper wires 20a configured to respectively connect the wires to be removed 11a to the old wires 12a are sequentially separated from the electric pole for a branch wire 10a.

Then, the wire to be removed 11a is separated. Here, both ends of the wire to be removed 11a located between the electric poles within the work section are respectively separated from suspension insulators (not shown in the drawing) respectively installed on the electric poles for branch wires 10a, thereby securing a safe space for wiring work in the state in which power transmission is not performed through the wire. Here, stretching a new wire 13a and pulling the new wire to obtain an appropriate dip of the new wire are performed in the safe space for wiring work.

Thereafter, referring to FIG. 30, the new wire 13a is installed within the work section in which the electric pole for a branch wire 10a is installed.

The new wire 13a of the new electric pole 10′ is stretched. Then, the stretched new wire 13a is connected to the suspension insulator from which the wire to be removed 11a is separated. Then, the new wire is pulled to obtain an appropriate dip thereof.

Meanwhile, in the present invention, a plurality of branch wires may be installed in the work section.

In this case, in the process of installing the gear ratchet tensioner 1 on the electric pole for a branch wire 10a, the process of fixing the new wire 13a on the branch wire by stretching the new wire 13 and pulling the new wire to obtain an appropriate dip of the new wire may be repeatedly performed a plurality of times in consideration of the number of branch wires.

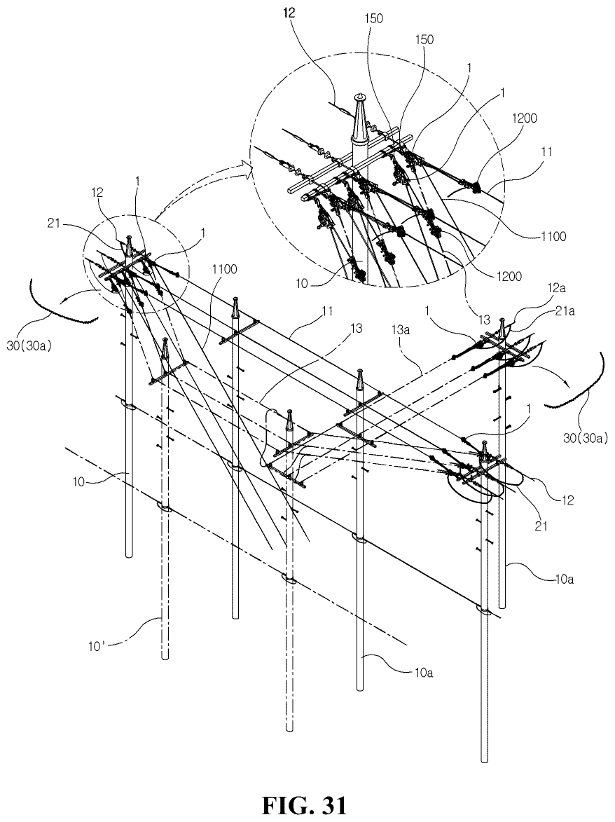

After this work, referring to FIG. 31, new jumper wires 21 and 21a are installed.

Here, the new wires 13 connected to the start and end electric poles 10 located within the work section are respectively connected to the old wires 12 located outside the work section through the bypass jumper means in a sequential manner using the respective new jumper wires 21, and the already installed bypass jumper means 30 is separated from the wire so as to allow the wire to be removed 11a to enter the state in which power transmission is not performed through the wire to be removed.

The new wires 13a respectively connected to the electric poles for branch wires 10a are sequentially connected to the respective old wires 12a located outside the work section through the respective bypass jumper means using the respective new jumper wires 21a. Here, the already installed bypass jumper means 30 is separated from the wire so as to allow the wire to be removed 11a to enter the state in which power transmission is not performed through the wire to be removed.

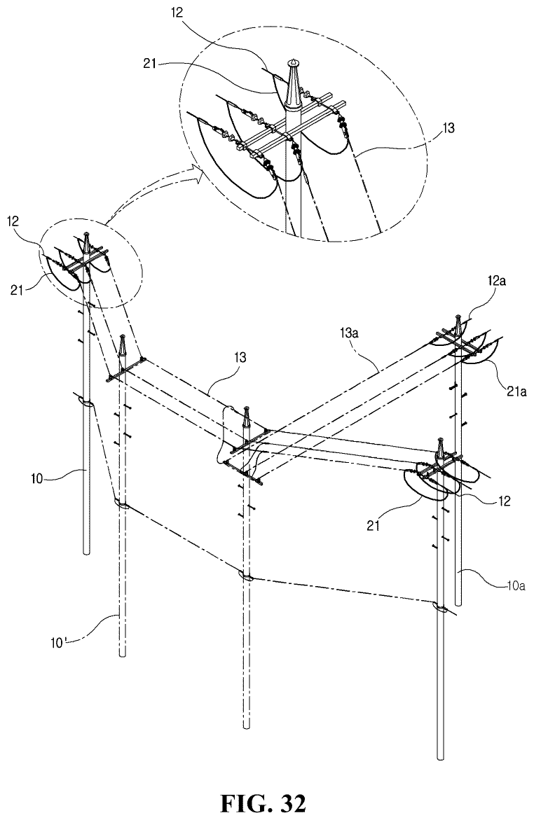

Afterwards, referring to FIG. 32, the wires to be removed 11 and 11a are removed in the state in which power transmission is not performed through the wire to be removed.

Then, while the insulating rope 1100 of the gear ratchet tensioner 1 is released, the wires to be removed 11 and 11a in the tensioned state are lowered to the ground and removed. Next, the electric poles 10 in the work section are sequentially removed, thereby completing wiring work for the new wires 13 and 13a in the state in which power transmission is performed through the wire.

Meanwhile, in the present invention, when the wires to be removed 11 and 11a located between the electric poles are separated, the new wires 13 and 13a are installed, and the wires to be removed 11 and 11a are removed by using the automatic direction switching pendulum-type rotary drive gear ratchet tensioner having an unlimited tension distance adjustment function for indirect live wire work 1 that holds the wires to be removed 11 and 11a and the new wires 13 and 13a, the rotary operating lever 200 is operated in the forward or reverse direction so as to cause the pendulum 600 to perform reciprocating pendulum motion. Accordingly, it is possible to adjust tension of the insulating rope by rotating the automatic reversing pawl 800 and rotating the roller shaft 310 connected to the roller shaft operating plate 500 in the forward or reverse direction so as to pull or release the insulating rope 1100. In order to adjust tension of the wires to be removed 11 and 11a and the new wires 13 and 13a, tension adjustment may be performed by stopping or rotating the outer ring 410 through attachment and detachment operation of the rotation control lever 440.

That is, in order to rotate the gear roller 300 and pull the insulating rope 1100 so as to apply tension to the wire, the rotation control lever 440 needs to be operated in a state of being fitted into the stopping groove 413 of the outer ring 410.

Thereafter, a stick for live wire work is used to rotate the rotary operating lever 200 counterclockwise in a state in which a safe distance is secured between the worker and the wire. Accordingly, the roller shaft 310 pulls the insulating rope 1100 through clockwise rotation thereof, thereby applying tension to the wires to be removed 11 and 11a and the new wires 13 and 13a.

Meanwhile, in the present invention, as described above, referring to FIGS. 15 and 16, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to pull the insulating rope 1100. Since this operation has been described above, a detailed description thereof is omitted.

Thereafter, conversely, in order to release tension of the wires to be removed and the new wires, it is required to rotate the rotary operating lever 200 clockwise using the stick for live wire work in a state in which a safe distance is secured between the wire and the worker. Here, the roller shaft 310 releases the insulating rope 1100 through counterclockwise rotation thereof, thereby releasing tension of the wires to be removed 11 and 11a and the new wires 13 and 13a.

Meanwhile, in the present invention, as described above, referring to FIGS. 17 and 18, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to release the insulating rope 1100. Since this operation has been described above, a detailed description thereof is omitted.

That is, when separation of the wires to be removed 11 and 11a located between the electric poles, installation of the new wires 13 and 13a, and removal of the wires to be removed 11 and 11a are performed using the automatic direction switching pendulum-type rotary drive gear ratchet tensioner having an unlimited tension distance adjustment function for indirect live wire work 1 according to the present invention, as described above, forward or reverse rotation of the roller shaft 310 is performed by adjusting forward or reverse direction of the rotary operating lever 200. Accordingly, the insulating rope 1100 may be pulled or released through rotation of the gear roller 300, thereby making it possible to adjust tension of the wires to be removed 11 and 11a and the new wires 13 and 13a.

Meanwhile, in the present invention, when the above-described series of processes are performed, the processes may be sequentially and repeatedly performed for each of the three-phase wires.

### Third Embodiment

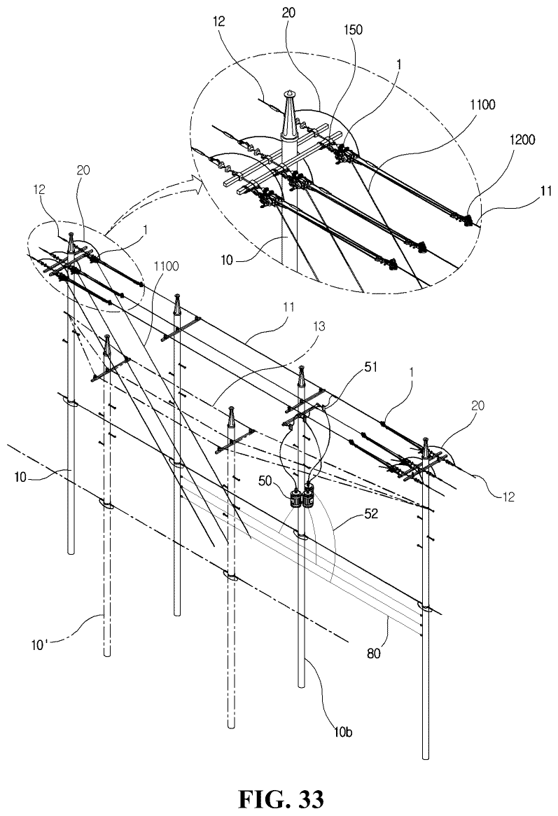

Referring to FIGS. 33 to 40, in this case, an electric pole for a transformer 10b is located within the work section, and relocation of an electric pole, replacement of an electric pole, and change of an electric pole route are performed in a state in which power transmission is performed through a wire.

First, referring to FIG. 33, when relocation of an electric pole, replacement of an electric pole, and change of an electric pole route are performed in the state in which power transmission is performed through the wire, normally, the above-described work is performed on a start electric pole and an end electric pole located within a work section in the state in which power transmission is performed through the wire, and installation of the new electric pole 10′, installation of components mounted on the new electric pole, and wiring work of the new wire 13 are performed in a state in which power transmission is not performed through the wire. In this manner, preparation work is performed for wiring work in the state in which power transmission is performed through the wire.

Afterwards, the automatic direction switching pendulum-type rotary drive gear ratchet tensioner having an unlimited tension distance adjustment function for indirect live wire work 1 according to the present invention is installed on the wire.

The hook 150 of the gear ratchet tensioner 1 is fixed to an arm-shaped support member at the inner position of each of the start electric pole 10 and the end electric pole 10 within a work section in which an electric pole for a transformer 10b is located. Thereafter, on a wire located between the electric poles installed in a region where wiring work is safely performed in the state in which power transmission is not performed through the wire, the wire clip 1200 is used to grab the wire to be removed 11 and is installed thereon.

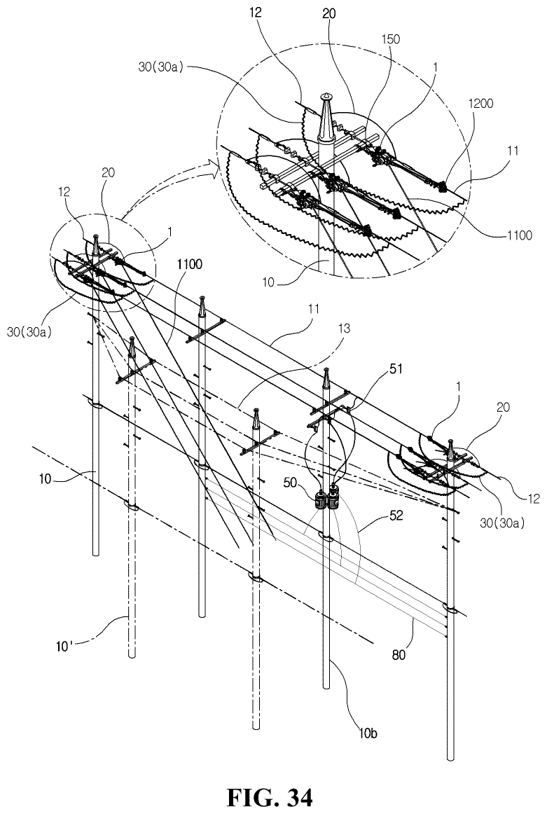

Thereafter, referring to FIG. 34, the wire to be removed 11 located inside the work section and the old wire 12 located outside the work section are connected to each other through the bypass jumper means.

First, each of the bypass jumper means 30 has one end connected to a corresponding one of both ends of the wire to be removed 11 located inside the work section.

Each of the bypass jumper means 30 has the other end connected to a corresponding one of the old wires 12 located outside the work section in which the start and end electric poles 10 are installed, and the wire to be removed 11 and the old wire 12 are connected to each other through the bypass jumper means.

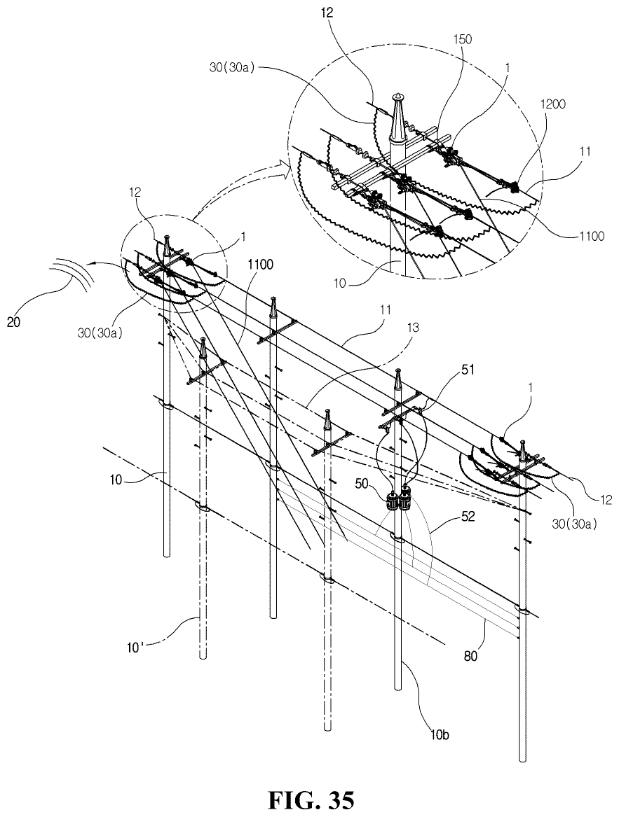

Afterwards, referring to FIG. 35, the wire to be removed 11 located inside the work section is separated.

First, the jumper wires 20 configured to respectively connect the wires to be removed 11 to the old wires 12 are sequentially separated from the start and end electric poles 10 of the work section.

Then, the wire to be removed 11 is separated. Here, both ends of the wire to be removed 11 located between the electric poles within the work section are respectively separated from suspension insulators (not shown in the drawing) respectively installed on the electric poles 10, thereby securing a safe space for wiring work in the state in which power transmission is not performed through the wire. Here, stretching the new wire 13 and pulling the new wire 13 to obtain an appropriate dip thereof are performed in the safe space for wiring work.

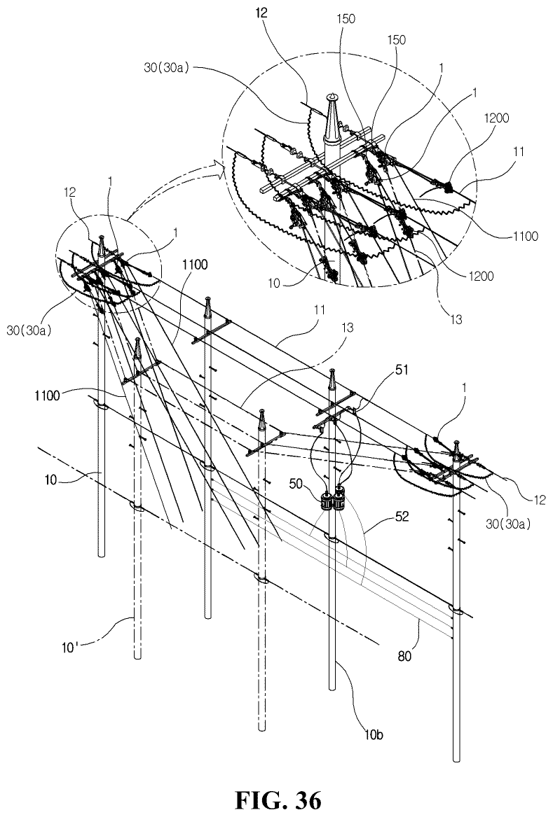

Thereafter, referring to FIG. 36, the new wire 13 is installed.

The new wire 13 of the new electric pole 10′ is stretched. Then, the stretched new wire 13 is connected to the suspension insulator from which the wire to be removed 11 is separated. Then, the new wire is pulled to obtain an appropriate dip thereof.

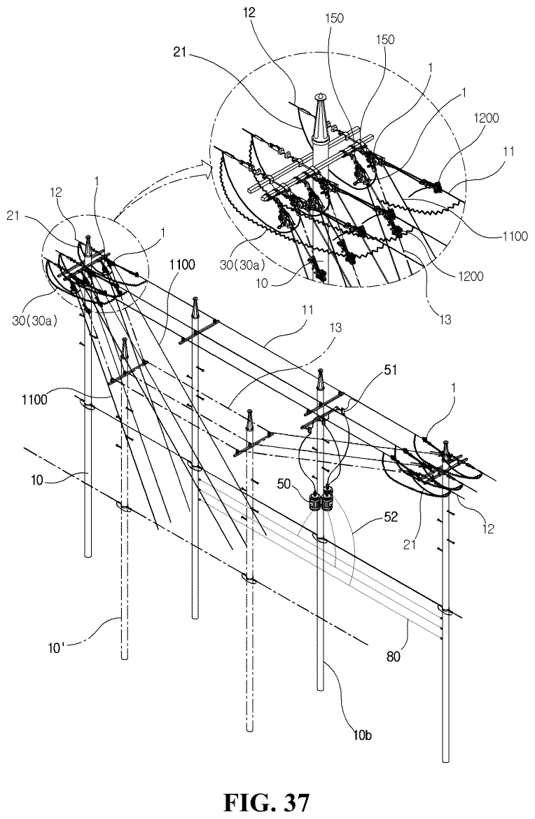

After this work, referring to FIG. 37, the new jumper wire 21 is installed.

Here, the new wires 13 connected to the start and end electric poles 10 located within the work section are respectively connected to the old wires 12 located outside the work section through the bypass jumper means in a sequential manner using the respective new jumper wires 21.

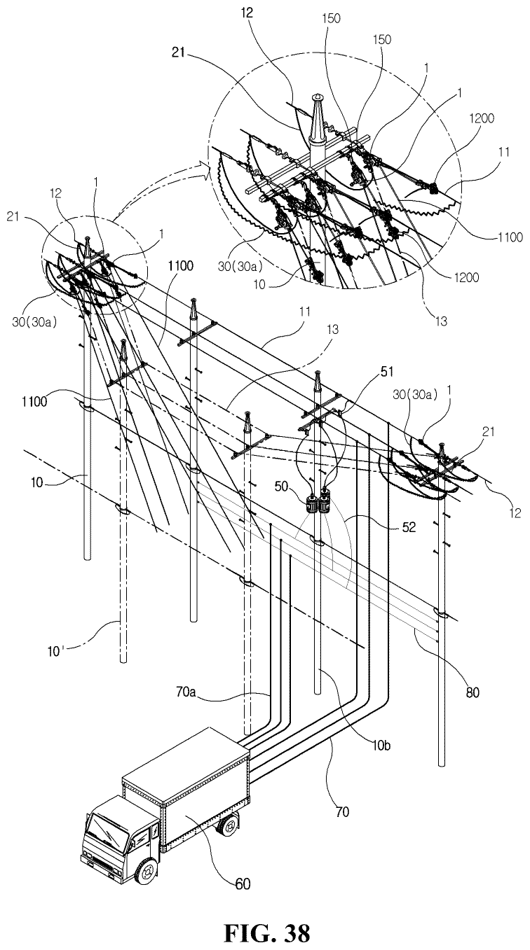

Afterwards, referring to FIG. 38, an electric pole transformer 50 is removed.

First, a secondary low-voltage cable 70a of the uninterruptible transformer apparatus 60 is connected to a secondary low-voltage line 80 of the electric pole transformer 50 installed by installing the uninterruptible transformer apparatus 60 on the electric pole for a transformer 10b for a bypass connection step.

Then, a secondary drop wire 52 of the electric pole transformer 50 is separated, an electric pole transformer COS 51 is opened, and the electric pole transformer 50 is removed. The removed electric pole transformer 50 is reusable.

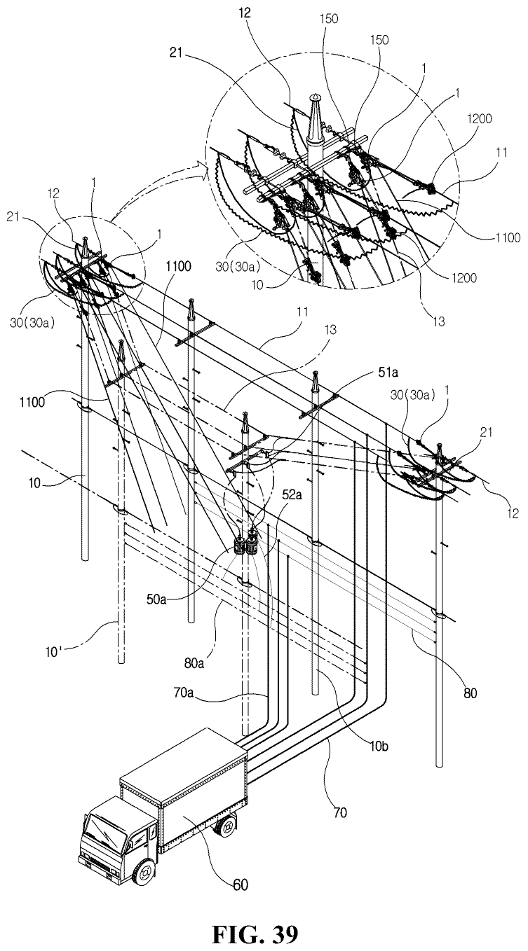

Thereafter, referring to FIG. 39, the old electric pole transformer is replaced with a new electric pole transformer 50a and is newly installed on the electric pole.

First, the removed electric pole transformer is reusable, or the new electric pole transformer 50a is installed on the new electric pole 10′.

Then, a COS 51a of the new electric pole transformer 50a is installed, a secondary drop wire of the new electric pole transformer 52a is installed, the uninterruptible transformer apparatus 60 is turned off, and the low-voltage cable 70a of the uninterruptible transformer apparatus 60 is separated, thereby completing work of newly installing and relocating the transformer located in the work section in the state in which power transmission is not performed through the wire.

Meanwhile, in the present invention, a plurality of the electric poles for a transformer 10b may be installed in the work section.

In this case, in the process of installing the uninterruptible transformer apparatus 60 on the electric pole for a transformer 10b in the work section, the process of reusing the removed electric pole transformer by installing the same on the new electric pole 10′, replacing an old electric pole transformer with a new electric pole transformer, installing the new electric pole transformer on the new electric pole, and relocating the electric pole transformer in the state in which power transmission is performed through the wire may be repeatedly performed a plurality of times in consideration of the number of electric poles for transformers 10b.

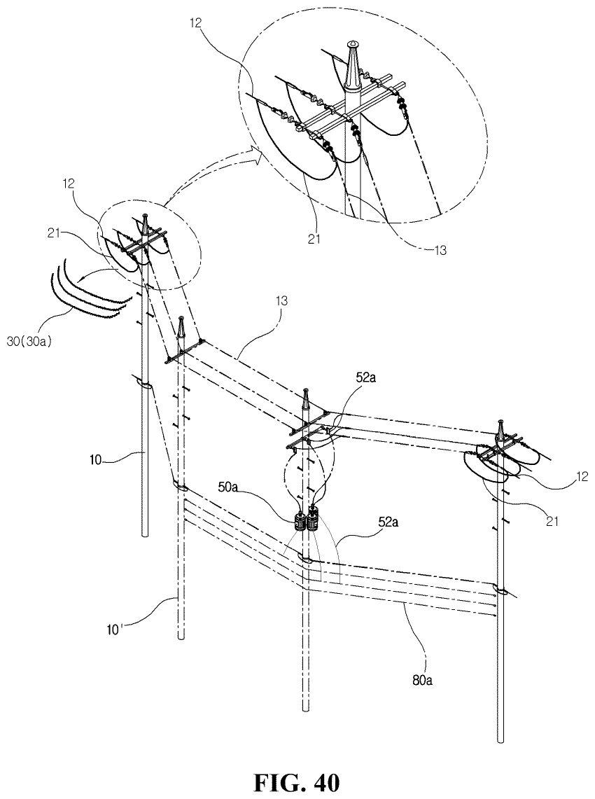

Afterwards, referring to FIG. 40, the bypass jumper means 30, the wire to be removed 11, the electric pole 10, and the uninterruptible transformer apparatus 60 are removed in the state in which power transmission is not performed through the wire to be removed.

Then, the bypass jumper means 30 is separated. Thereafter, while the insulating rope 1100 of the gear ratchet tensioner 1 is released, the wire to be removed 11 in the tensioned state is lowered to the ground and removed.

Next, the electric poles 10 in the work section are sequentially removed, and the uninterruptible transformer apparatus 60 is removed. Accordingly, when the electric pole for a transformer 10b is installed in the work section, it is possible to complete wiring work for the new wire 13 in the state in which power transmission is performed through the wire.

Meanwhile, in the present invention, when the wire to be removed 11 located between the electric poles is separated, the new wire 13 is installed, and the wire to be removed 11 is removed by using the automatic direction switching pendulum-type rotary drive gear ratchet tensioner having an unlimited tension distance adjustment function for indirect live wire work 1 that holds the wire to be removed 11 and the new wire 13, the rotary operating lever 200 is operated in the forward or reverse direction so as to cause the pendulum 600 to perform reciprocating pendulum motion. Accordingly, it is possible to adjust tension of the insulating rope by rotating the automatic reversing pawl 800 and rotating the roller shaft 310 connected to the roller shaft operating plate 500 in the forward or reverse direction so as to pull or release the insulating rope 1100. In order to adjust tension of the wire to be removed 11 and the new wire 13, tension adjustment may be performed by stopping or rotating the outer ring 410 through attachment and detachment operation of the rotation control lever 440.

That is, in order to rotate the gear roller 300 and pull the insulating rope 1100 so as to apply tension to the wire, the rotation control lever 440 needs to be operated in a state of being fitted into the stopping groove 413 of the outer ring 410.

Thereafter, a stick for live wire work is used to rotate the rotary operating lever 200 counterclockwise in a state in which a safe distance is secured between the worker and the wire. Accordingly, the roller shaft 310 pulls the insulating rope 1100 through clockwise rotation thereof, thereby applying tension to the wire to be removed 11 and the new wire 13.

Meanwhile, in the present invention, as described above, referring to FIGS. 15 and 16, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to pull the insulating rope 1100. Since this operation has been described above, a detailed description thereof is omitted.

Thereafter, conversely, in order to release tension of the wire to be removed and the new wire, it is required to rotate the rotary operating lever 200 clockwise using the stick for live wire work in a state in which a safe distance is secured between the wire and the worker. Here, the roller shaft 310 releases the insulating rope 1100 through counterclockwise rotation thereof, thereby releasing tension of the wire to be removed 11 and the new wire 13.

Meanwhile, in the present invention, as described above, referring to FIGS. 17 and 18, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to release the insulating rope 1100. Since this operation has been described above, a detailed description thereof is omitted.

That is, when separation of the wire to be removed 11 located between the electric poles, installation of the new wire 13, and removal of the wire to be removed 11 are performed using the automatic direction switching pendulum-type rotary drive gear ratchet tensioner having an unlimited tension distance adjustment function for indirect live wire work 1 according to the present invention, as described above, forward or reverse rotation of the roller shaft 310 is performed by adjusting forward or reverse direction of the rotary operating lever 200. Accordingly, the insulating rope 1100 may be pulled or released through rotation of the gear roller 300, thereby making it possible to adjust tension of the wire to be removed 11 and the new wire 13.

Meanwhile, in the present invention, when the above-described series of processes is performed, the processes may be sequentially and repeatedly performed for each of the three-phase wires.

### Fourth Embodiment

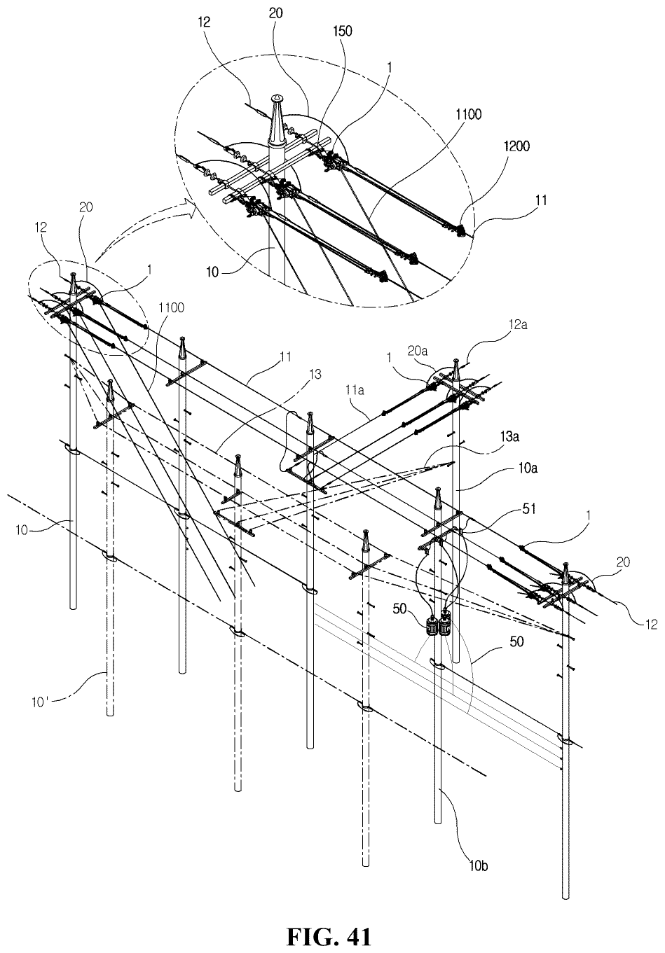

Referring to FIGS. 41 to 48, in this case, the electric pole for a branch wire 10a and the electric pole for a transformer 10b are located within the work section, and relocation of an electric pole, replacement of an electric pole, and change of an electric pole route are performed in a state in which power transmission is performed through a wire.

First, referring to FIG. 41, when relocation of an electric pole, replacement of an electric pole, and change of an electric pole route are performed in the state in which power transmission is performed through the wire, normally, the above-described work is performed on a start electric pole and an end electric pole located within a work section in the state in which power transmission is performed through the wire, and installation of the new electric pole 10′, installation of components mounted on the new electric pole, and wiring work of the new wire 13 are performed in a state in which power transmission is not performed through the wire. In this manner, preparation work is performed for wiring work in the state in which power transmission is performed through the wire.

Afterwards, the automatic direction switching pendulum-type rotary drive gear ratchet tensioner having an unlimited tension distance adjustment function for indirect live wire work 1 according to the present invention is installed on the wire.

The hook 150 of the gear ratchet tensioner 1 is fixed to an arm-shaped support member at the inner position of each of the start electric pole 10 and the end electric pole 10 within a work section in which the electric pole for a branch wire 10a is located. Thereafter, on a wire located between the electric poles installed in a region where wiring work is safely performed in the state in which power transmission is not performed through the wire, the wire clip 1200 is used to grab the wire to be removed 11 and is installed thereon.

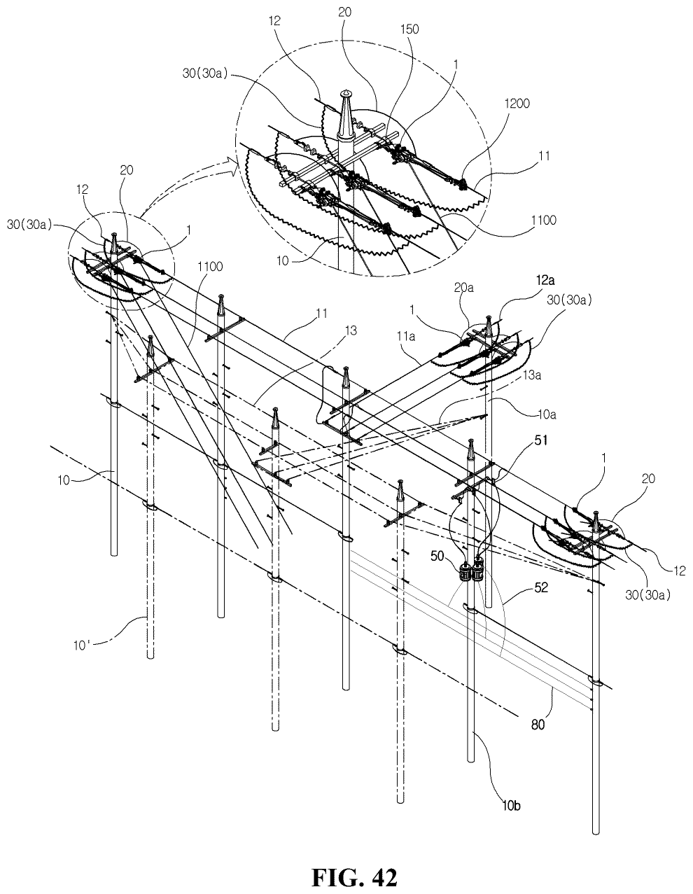

Thereafter, referring to FIG. 42, the wire to be removed 11 located inside the work section and the old wire 12 located outside the work section are connected to each other through the bypass jumper means.

First, each of the bypass jumper means 30 has one end connected to a corresponding one of both ends of the wire to be removed 11 located inside the work section.

Each of the bypass jumper means 30 has the other end connected to a corresponding one of the old wires 12 located outside the work section in which the start and end electric poles 10 are installed, and the wire to be removed 11 and the old wire 12 are connected to each other through the bypass jumper means.

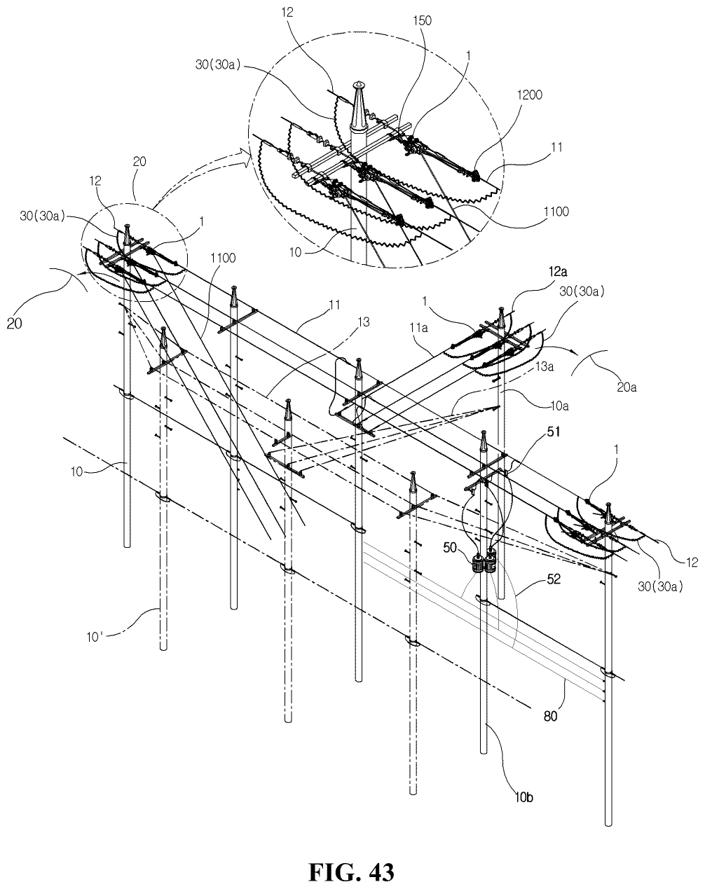

Afterwards, referring to FIG. 43, the wire to be removed 11 located inside the work section is separated.

First, the jumper wires 20 configured to respectively connect the wires to be removed 11 to the old wires 12 are sequentially separated from the start and end electric poles 10 of the work section.

Then, the wire to be removed 11 is separated. Here, both ends of the wire to be removed 11 located between the electric poles within the work section are respectively separated from suspension insulators (not shown in the drawing) respectively installed on the electric poles 10, thereby securing a safe space for wiring work in the state in which power transmission is not performed through the wire. Here, stretching the new wire 13 and pulling the new wire 13 to obtain an appropriate dip thereof are performed in the safe space for wiring work.

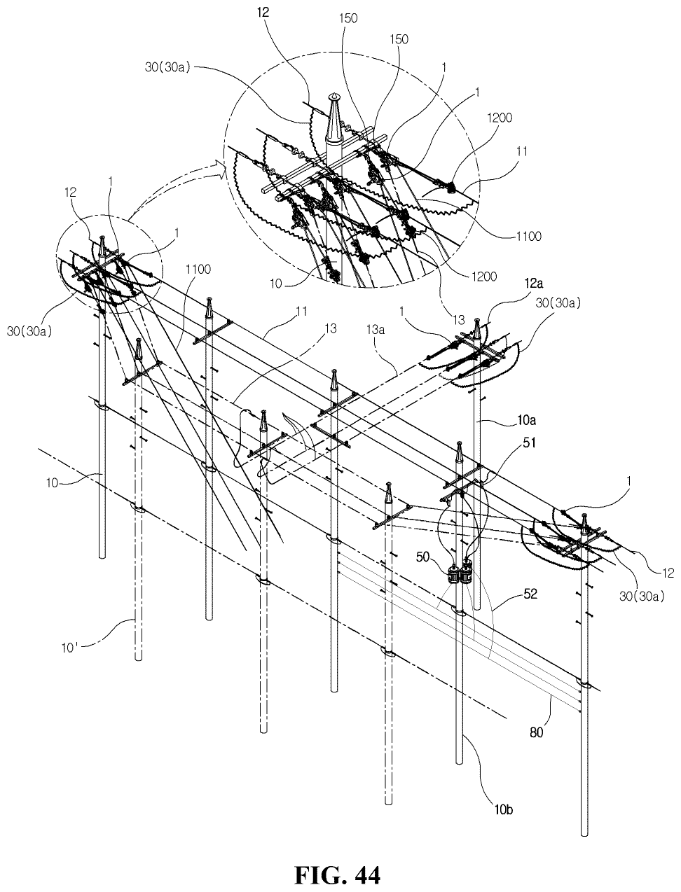

Thereafter, referring to FIG. 44, the new wire 13 is installed.

The new wire 13 of the new electric pole 10′ is stretched. Then, the stretched new wire 13 is connected to the suspension insulator from which the wire to be removed 11 is separated. Then, the new wire is pulled to obtain an appropriate dip thereof.

Afterwards, referring back to FIG. 41, the automatic direction switching pendulum-type rotary drive gear ratchet tensioner having an unlimited tension distance adjustment function for indirect live wire work 1 according to the present invention is installed on the electric pole for a branch wire 10a.

The hook 150 of the gear ratchet tensioner 1 is fixed to an arm-shaped support member at the inner position of the work section in which the electric pole for a branch wire 10a is located. Thereafter, on a wire located between the electric poles installed in a region where wiring work is safely performed in the state in which power transmission is not performed through the wire, the wire clip 1200 is used to grab the wire to be removed 11a and is installed thereon.

Thereafter, referring to FIG. 42, the wire to be removed 11a located inside the work section in which the electric pole for a branch wire 10a is installed and an old wire 12a located outside the work section are connected to each other through the bypass jumper means.

First, one end of the bypass jumper means 30 is connected to the end of the wire to be removed 11 located inside the work section.

The other end of the bypass jumper means 30 is connected to the old wire 12a located outside the work section in which the electric pole for a branch wire 10a is installed, and the wire to be removed 11a and the old wire 12a are connected to each other through the bypass jumper means.

Afterwards, referring to FIG. 43, the wire to be removed 11a located inside the work section is separated.

First, the jumper wires 20a configured to respectively connect the wires to be removed 11a to the old wires 12a are sequentially separated from the electric pole for a branch wire 10a.

Then, the wire to be removed 11a is separated. Here, both ends of the wire to be removed 11a located between the electric poles within the work section are respectively separated from suspension insulators (not shown in the drawing) respectively installed on the electric poles for branch wires 10a, thereby securing a safe space for wiring work in the state in which power transmission is not performed through the wire. Here, stretching a new wire 13a and pulling the new wire to obtain an appropriate dip of the new wire are performed in the safe space for wiring work.

Thereafter, referring to FIG. 44, the new wire 13a is installed within the work section in which the electric pole for a branch wire 10a is installed.

The new wire 13a of the new electric pole 10′ is stretched. Then, the stretched new wire 13a is connected to the suspension insulator from which the wire to be removed 11a is separated. Then, the new wire is pulled to obtain an appropriate dip thereof.

Meanwhile, in the present invention, a plurality of the branch wires and the electric poles for transformers 10b may be installed in the work section.

In this case, in the process of installing the gear ratchet tensioner 1 on the electric pole for a branch wire 10a, the process of fixing the new wire 13a on the branch wire by stretching the new wire 13 and pulling the new wire to obtain an appropriate dip of the new wire may be repeatedly performed a plurality of times in consideration of the number of branch wires.

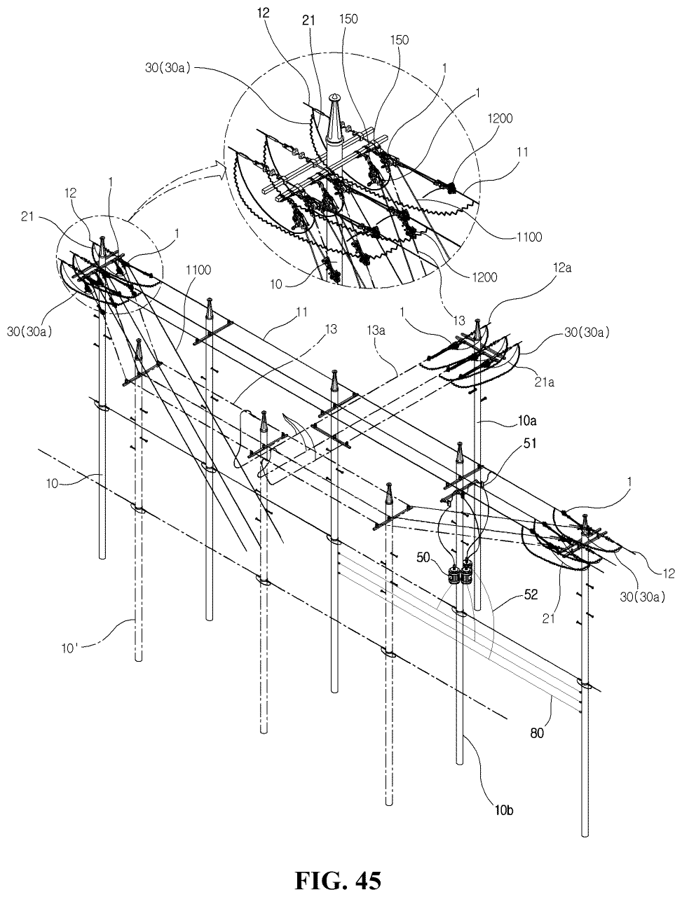

After this work, referring to FIG. 45, the new jumper wires 21 and 21a are installed.

Here, the new wires 13 connected to the start and end electric poles 10 located within the work section are respectively connected to the old wires 12 located outside the work section through the bypass jumper means in a sequential manner using the respective new jumper wires 21.

The new wires 13a respectively connected to the electric poles for branch wires 10a are sequentially connected to the respective old wires 12a located outside the work section through the respective bypass jumper means using the respective new jumper wires 21a.

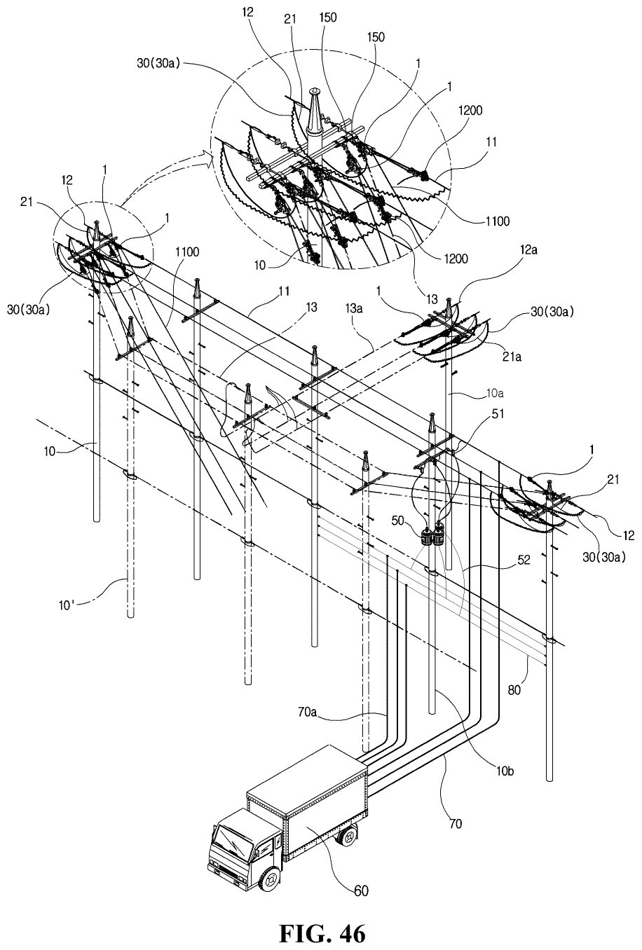

Afterwards, referring to FIG. 46, the electric pole transformer 50 is removed.

First, the secondary low-voltage cable 70a of the uninterruptible transformer apparatus 60 is connected to the secondary low-voltage line 80 of the electric pole transformer 50 installed by installing the uninterruptible transformer apparatus 60 on the electric pole for a transformer 10b for a bypass connection step.

Then, the secondary drop wire 52 of the electric pole transformer 50 is separated, the electric pole transformer COS 51 is opened, and the electric pole transformer 50 is removed. The removed electric pole transformer 50 is reusable.

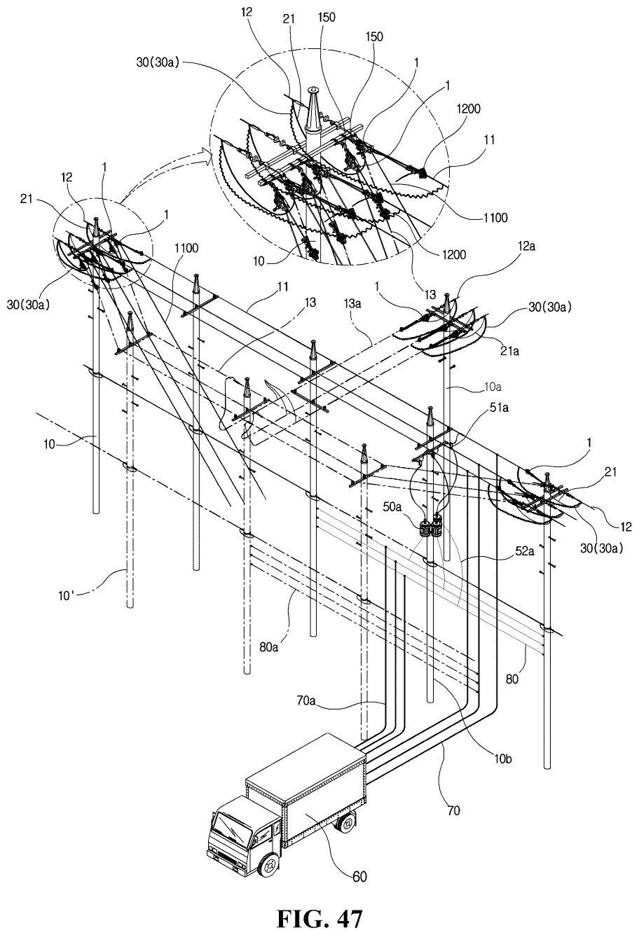

Thereafter, referring to FIG. 47, the new electric pole transformer 50a is newly installed on the electric pole.

First, the removed electric pole transformer is reusable, or the new electric pole transformer 50a is installed on the new electric pole 10′.

Then, the COS 51a of the new electric pole transformer 50a is installed, the secondary drop wire of the new electric pole transformer 52a is installed, the uninterruptible transformer apparatus 60 is turned off, and the low-voltage cable 70a of the uninterruptible transformer apparatus 60 is separated, thereby completing work of newly installing and relocating the transformer located in the work section in the state in which power transmission is not performed through the wire.

Meanwhile, in the present invention, a plurality of branch wires may be installed in the work section.

In this case, in the process of installing the uninterruptible transformer apparatus 60 on the electric pole for a transformer 10b in the work section, the process of reusing the removed electric pole transformer by installing the same on the new electric pole 10′, replacing an old electric pole transformer with a new electric pole transformer, installing the new electric pole transformer on the new electric pole, and relocating the electric pole transformer in the state in which power transmission is performed through the wire may be repeatedly performed a plurality of times in consideration of the number of electric poles for transformers 10b.

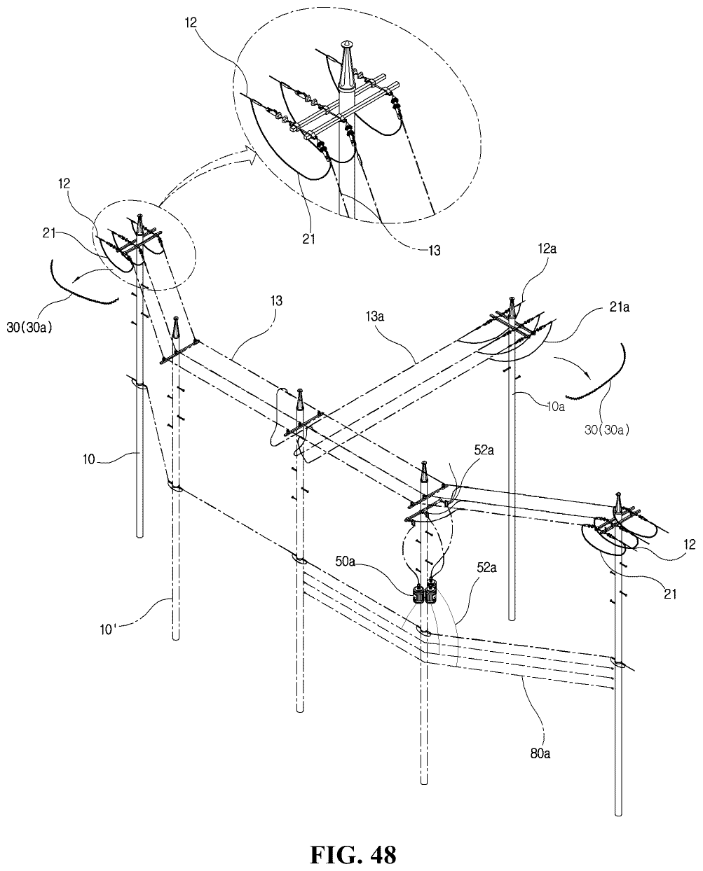

Afterwards, referring to FIG. 48, the bypass jumper means 30, the wires to be removed 11 and 11a, the electric pole 10, and the uninterruptible transformer apparatus 60 are removed in the state in which power transmission is not performed through the wires to be removed.

Then, the bypass jumper means 30 is separated. Thereafter, while the insulating rope 1100 of the gear ratchet tensioner 1 is released, the wire to be removed 11 in the tensioned state is lowered to the ground and removed.

Next, the electric poles 10 in the work section are sequentially removed, and the uninterruptible transformer apparatus 60 is removed. Accordingly, when the electric pole for a branch wire 10a and the electric pole for a transformer 10b are installed in the work section, it is possible to complete wiring work for the new wires 13 and 13a in the state in which power transmission is performed through the wire.

Meanwhile, in the present invention, when the wires to be removed 11 and 11a located between the electric poles are separated, the new wires 13 and 13a are installed, and the wires to be removed 11 and 11a are removed by using the automatic direction switching pendulum-type rotary drive gear ratchet tensioner having an unlimited tension distance adjustment function for indirect live wire work 1 that holds the wires to be removed 11 and 11a and the new wires 13 and 13a, the rotary operating lever 200 is operated in the forward or reverse direction so as to cause the pendulum 600 to perform reciprocating pendulum motion. Accordingly, it is possible to adjust tension of the insulating rope by rotating the automatic reversing pawl 800 and rotating the roller shaft 310 connected to the roller shaft operating plate 500 in the forward or reverse direction so as to pull or release the insulating rope 1100. In order to adjust tension of the wires to be removed 11 and 11a and the new wires 13 and 13a, tension adjustment may be performed by stopping or rotating the outer ring 410 through attachment and detachment operation of the rotation control lever 440.

That is, in order to rotate the gear roller 300 and pull the insulating rope 1100 so as to apply tension to the wire, the rotation control lever 440 needs to be operated in a state of being fitted into the stopping groove 413 of the outer ring 410.

Thereafter, a stick for live wire work is used to rotate the rotary operating lever 200 counterclockwise in a state in which a safe distance is secured between the worker and the wire. Accordingly, the roller shaft 310 pulls the insulating rope 1100 through clockwise rotation thereof, thereby applying tension to the wires to be removed 11 and 11a and the new wires 13 and 13a.

Meanwhile, in the present invention, as described above, referring to FIGS. 15 and 16, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to pull the insulating rope 1100. Since this operation has been described above, a detailed description thereof is omitted.

Thereafter, conversely, in order to release tension of the wires to be removed and the new wires, it is required to rotate the rotary operating lever 200 clockwise using the stick for live wire work in a state in which a safe distance is secured between the wire and the worker. Here, the roller shaft 310 releases the insulating rope 1100 through counterclockwise rotation thereof, thereby releasing tension of the wires to be removed 11 and 11a and the new wires 13 and 13a.

Meanwhile, in the present invention, as described above, referring to FIGS. 17 and 18, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to release the insulating rope 1100. Since this operation has been described above, a detailed description thereof is omitted.

That is, when separation of the wires to be removed 11 and 11a located between the electric poles, installation of the new wires 13 and 13a, and removal of the wires to be removed 11 and 11a are performed using the automatic direction switching pendulum-type rotary drive gear ratchet tensioner having an unlimited tension distance adjustment function for indirect live wire work 1 according to the present invention, as described above, forward or reverse rotation of the roller shaft 310 is performed by adjusting forward or reverse direction of the rotary operating lever 200. Accordingly, the insulating rope 1100 may be pulled or released through rotation of the gear roller 300, thereby making it possible to adjust tension of the wires to be removed 11 and 11a and the new wires 13 and 13a.

Meanwhile, in the present invention, when the above-described series of processes is performed, the processes may be sequentially and repeatedly performed for each of the three-phase wires.

### Fifth Embodiment

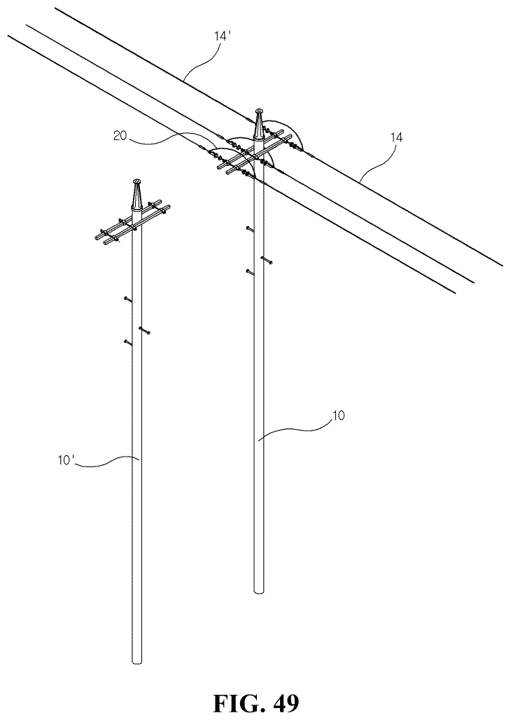

Referring to FIGS. 49 to 60, replacement work for electric poles having a distance therebetween is performed in a state in which power transmission is performed through a wire.

First, referring to FIG. 49, when electric pole replacement work is performed, an electric pole installation process is performed to install the new electric pole 10′ at a location corresponding to a location of an electric pole to be removed 10 which is to be replaced with the new electric pole, thereby preparing for wiring work in the state in which power transmission is performed through the wire.

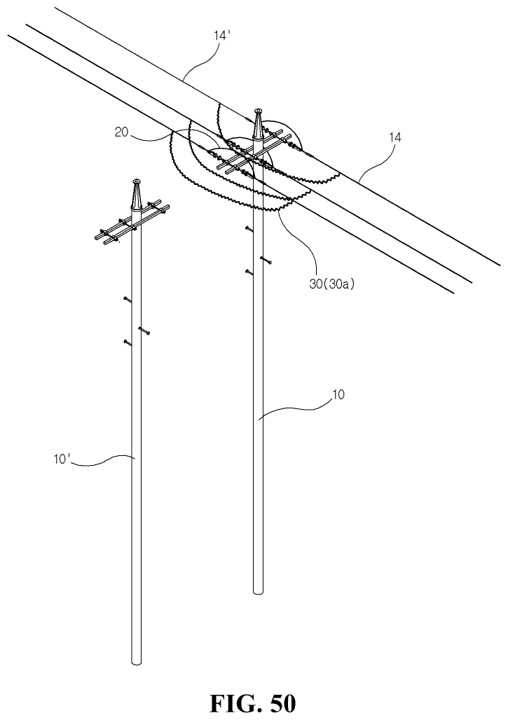

Thereafter, referring to FIG. 50, wires to be relocated 14 and 14′ respectively located on opposite sides of the electric pole to be removed are connected to each other through the bypass jumper means.

First, the wires to be relocated 14 and 14′ respectively located on opposite sides of the electric pole to be removed are connected to each other through the bypass jumper means 30 in a state in which the electric pole to be removed 10 is disposed at a central portion of the bypass jumper means.

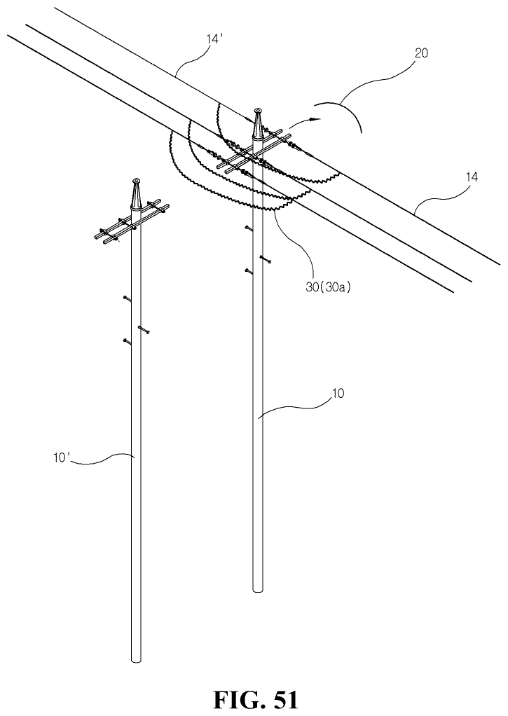

Then, referring to FIG. 51, the jumper wires 20 configured to respectively connect the wires to be relocated 14 and 14′ respectively located on opposite sides of the electric pole to be removed are sequentially separated so as to secure a safe work space.

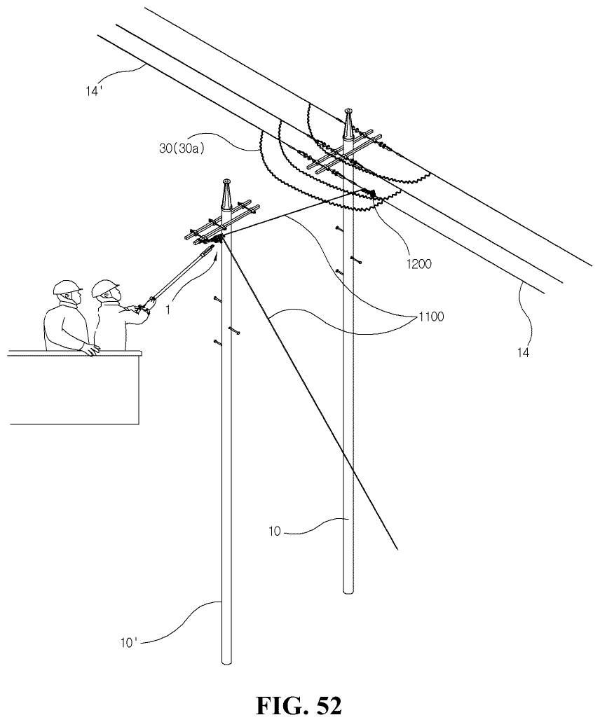

Thereafter, referring to FIG. 52, first, the automatic direction switching pendulum-type rotary drive gear ratchet tensioner having an unlimited tension distance adjustment function for indirect live wire work 1 according to the present invention is installed on the wire.

First, the new electric pole 10′ needs to be installed at a location corresponding to a location of the wire to be relocated 14 located on one side of the electric pole to be removed. The hook 150 of the gear ratchet tensioner 1 is fixed to an arm-shaped support member. Thereafter, on a wire located between electric poles installed in a region where wiring work is safely performed, the wire clip 1200 is used to grab the wire to be relocated 14 located on one side of the electric pole to be removed 10 and is fixedly installed thereon.

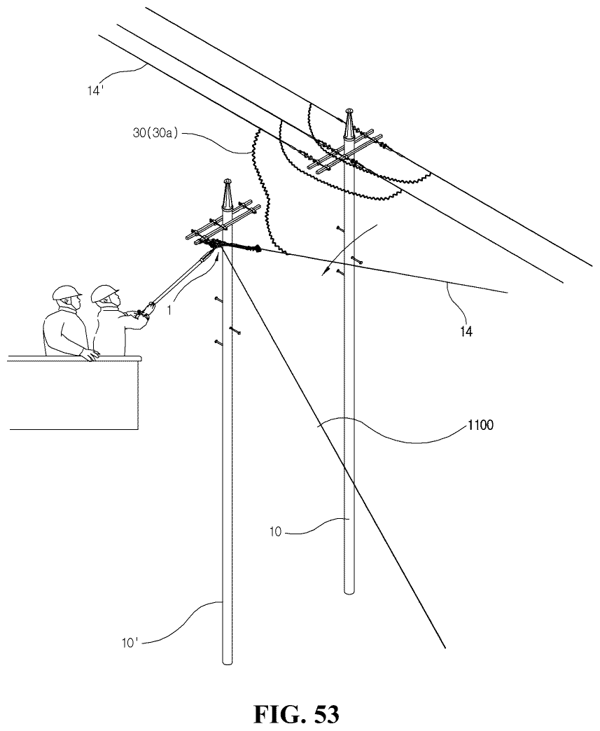

Afterwards, referring to FIG. 53, the wire to be relocated 14 fixed by the gear ratchet tensioner 1 as described above is first relocated to the new electric pole 10′.

While tension of the wire to be relocated 14 is adjusted by pulling or releasing the insulating rope 1100 of the gear ratchet tensioner 1, the wire to be relocated 14 fixed to one side of the electric pole to be removed 10 is separated.

Then, by pulling the insulating rope 1100, the separated wire to be relocated 14 is pulled toward one side of the new electric pole 10′ and is fixedly connected thereto.

Thereafter, in a state in which the wire to be relocated 14 located on one side of the electric pole to be removed is completely relocated to the new electric pole, the gear ratchet tensioner 1 installed to relocate the wire to be relocated is removed. In this manner, relocation of the wire to be relocated 14 located on one side of the electric pole to be removed is completed.

Then, a second ratchet gear ratchet tensioner installation process is performed to relocate the wire to be relocated 14′ located on the other side of the electric pole to be removed 10. The second ratchet gear ratchet tensioner installation process is performed in the same manner as the process shown in FIGS. 52 and 53. Referring to the drawings, location of the wire to be relocated is different. That is, the wire to be relocated is located on the other side of the electric pole to be removed (the other side).

Therefore, the automatic direction switching pendulum-type rotary drive gear ratchet tensioner having an unlimited tension distance adjustment function for indirect live wire work 1 according to the present invention is installed on the wire secondarily.

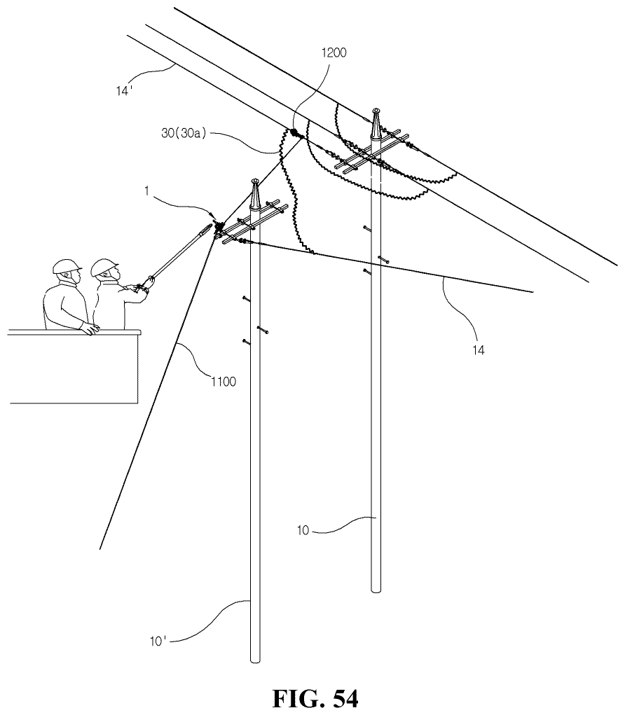

Referring to FIG. 54, the new electric pole 10′ needs to be installed at a location corresponding to a location of the wire to be relocated 14′ located on the other side of the electric pole to be removed. The hook 150 of the gear ratchet tensioner 1 is fixed to an arm-shaped support member. Thereafter, in a region where wiring work is safely performed, the wire clip 1200 is used to grab the wire to be relocated 14′ located on the other side of the electric pole to be removed 10 and is fixedly installed thereon.

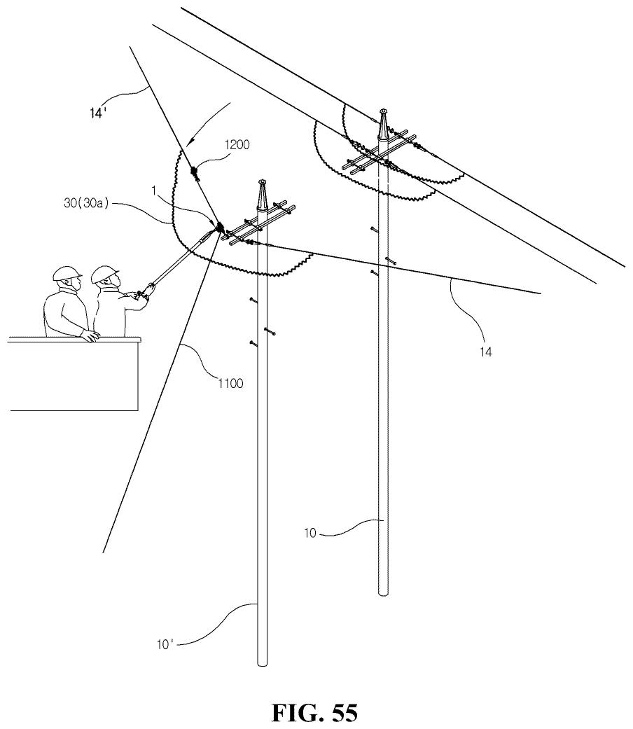

Afterwards, referring to FIG. 55, the wire to be relocated 14 fixed by the gear ratchet tensioner 1 as described above is relocated to the new electric pole 10′, secondarily.

While tension of the wire to be relocated 14′ is adjusted by pulling or releasing the insulating rope 1100 of the gear ratchet tensioner 1, the wire to be relocated 14′ fixed to the other side of the electric pole to be removed 10 is separated.

Then, by pulling the insulating rope 1100 using the gear ratchet tensioner 1, the separated the wire to be relocated 14′ is pulled toward the other side of the new electric pole 10′ and is fixedly connected thereto.

Thereafter, in a state in which the wire to be relocated 14′ located on the side of the electric pole to be removed is completely relocated to the new electric pole, the gear ratchet tensioner 1 installed to relocate the wire to be relocated is removed, secondarily. In this manner, relocation of the wire to be relocated 14′ located on the other side of the electric pole to be removed is completed. As described above, referring to FIGS. 54 and 55 relocation work of the wires to be relocated 14 and 14′ respectively located on both sides of the electric pole to be removed is completed.

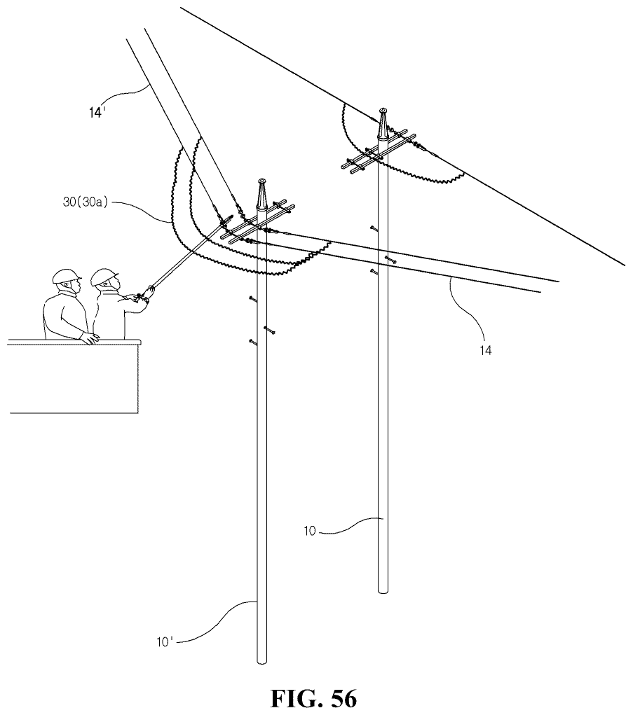

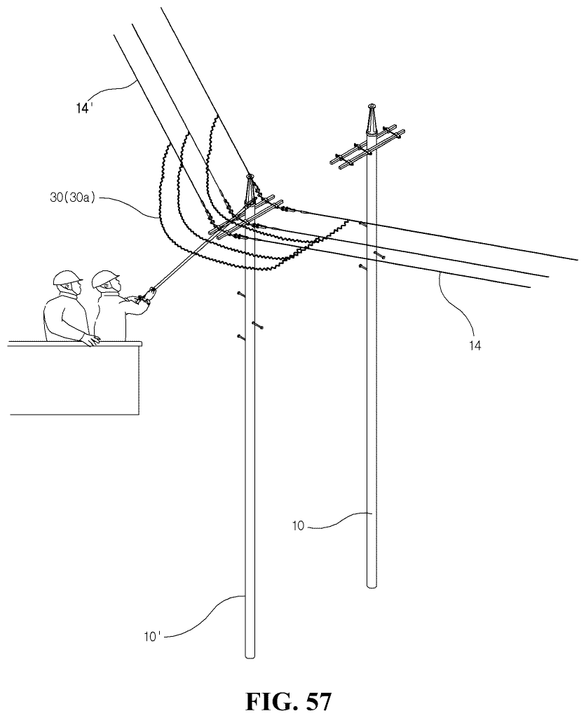

In this case, in order to relocate all of the three-phase wires to be relocated 14 and 14′ in the present invention, referring to FIGS. 56 and 57, a first wire relocation step and a second wire relocation step are sequentially performed one by one. In this manner, relocation work of the three-phase wires to be relocated 14 and 14′ may be performed.

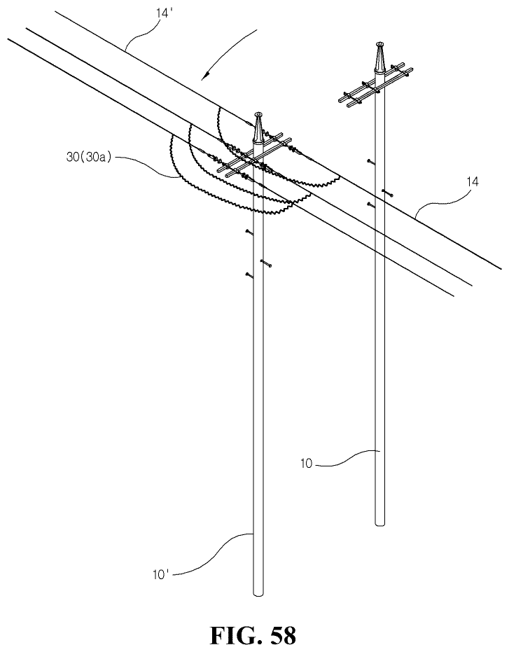

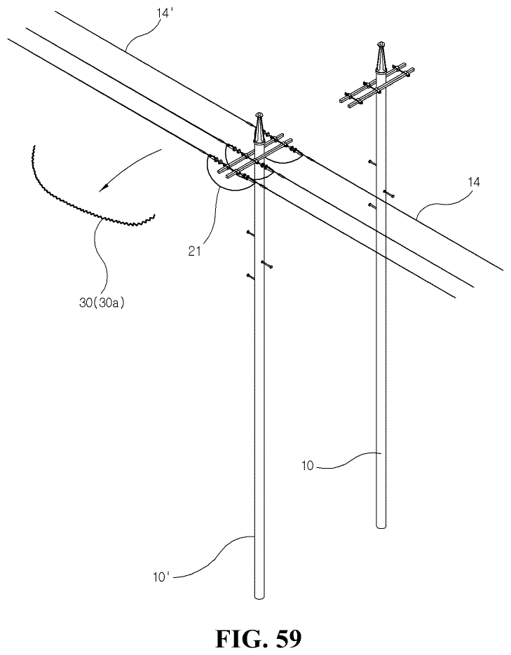

Thereafter, referring to FIG. 58, the wires to be relocated 14 and 14′ relocated to the new electric pole 10′ are sequentially connected to each other through the respective bypass jumper means 30 using the respective new jumper wires 21. Then, referring to FIG. 59, the previously installed bypass jumper means 30 are separated.

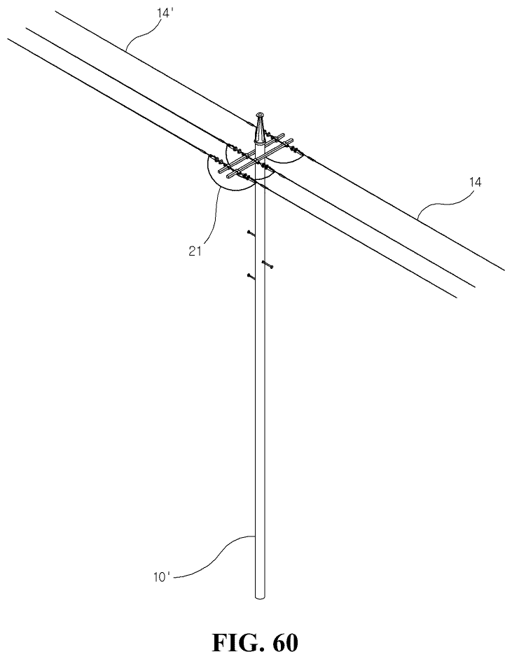

Afterwards, referring to FIG. 60, in a state in which relocation work of the wires to be relocated 14 and 14′ is completed as described above, the electric pole to be removed 10 is removed. In this manner, replacement work of the electric pole is completed.

Meanwhile, in the present invention, when the wires to be relocated 14 and 14′ are separated and installed by using the automatic direction switching pendulum-type rotary drive gear ratchet tensioner having an unlimited tension distance adjustment function for indirect live wire work 1 that holds the wires to be relocated 14 and 14′, the rotary operating lever 200 is operated in the forward or reverse direction so as to cause the pendulum 600 to perform reciprocating pendulum motion. Accordingly, it is possible to adjust tension of the insulating rope by rotating the automatic reversing pawl 800 and rotating the roller shaft 310 connected to the roller shaft operating plate 500 in the forward or reverse direction so as to pull or release the insulating rope 1100. In order to adjust tension of the wires to be relocated 14 and 14′, tension adjustment may be performed by stopping or rotating the outer ring 410 through attachment and detachment operation of the rotation control lever 440.

That is, in order to rotate the gear roller 300 and pull the insulating rope 1100 so as to apply tension to the wire, the rotation control lever 440 needs to be operated in a state of being fitted into the stopping groove 413 of the outer ring 410.

Thereafter, a stick for live wire work is used to rotate the rotary operating lever 200 counterclockwise in a state in which a safe distance is secured between the worker and the wire. Accordingly, the roller shaft 310 pulls the insulating rope 1100 through clockwise rotation thereof, thereby applying tension to the wires to be relocated 14 and 14′.

Meanwhile, in the present invention, as described above, referring to FIGS. 15 and 16, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to pull the insulating rope 1100. Since this operation has been described above, a detailed description thereof is omitted.

Thereafter, conversely, in order to release tension of the wires to be relocated 14 and 14′, it is required to rotate the rotary operating lever 200 clockwise using the stick for live wire work in a state in which a safe distance is secured between the wire and the worker. Here, the roller shaft 310 releases the insulating rope 1100 through counterclockwise rotation thereof, thereby releasing tension of the wires to be relocated 14 and 14′.

Meanwhile, in the present invention, as described above, referring to FIGS. 17 and 18, regarding clockwise rotation adjustment of the roller shaft 310, the roller shaft operating plate 500 is rotated through pendulum motion of the pendulum 600 by operation of the rotary operating lever 200 and interlocking operation of the pawl reversing key 900 and the automatic reversing pawl 800 linked to the pendulum 600, thereby making it possible to release the insulating rope 1100. Since this operation has been described above, a detailed description thereof is omitted.

That is, when replacement work of the electric pole is performed using the automatic direction switching pendulum-type rotary drive gear ratchet tensioner having an unlimited tension distance adjustment function for indirect live wire work 1 according to the present invention, as described above, forward or reverse rotation of the roller shaft 310 is performed by adjusting forward or reverse direction of the rotary operating lever 200. Accordingly, the insulating rope 1100 may be pulled or released through rotation of the gear roller 300, thereby making it possible to adjust tension of the wires to be relocated 14 and 14′.

In particular, in the present invention, when replacement work of the electric pole is performed as described above, it is obvious that replacement work may be performed in various ways regardless of a wire relocation distance between the electric pole to be removed 10 and the new electric poles 10′. Here, examples of the wire relocation distance include a case in which there is a distance between the electric pole to be removed 10 and the new electric pole 10′ and a case in which the height of the new electric pole 10′ to which the wire is to be relocated is higher than that of the electric pole to be removed.

Meanwhile, in carrying out the uninterruptible power distribution method of performing indirect live wire work, using the automatic direction switching pendulum-type rotary drive gear ratchet tensioner having an unlimited tension distance adjustment function for indirect live wire work according to the present invention, the bypass jumper means 30 configured to connect the wires to be removed 11 and 11a to the old wires 12 and 12a or to connect the wires to be relocated 14 and 14′ respectively located on opposite sides of the electric pole to be removed to each other is not limited to the above-described embodiment, and may be implemented in various ways.

Here, first, referring to FIGS. 21 to 60, in a conventional manner, a bypass jumper cable 30a forming a single line is applied as the bypass jumper means 30. In this case, the bypass jumper cable 30a may be used to connect the wires to be removed 11 and 11a to the old wires 12 and 12a or to connect the wires to be relocated 14 and 14′ respectively located on opposite sides of the electric pole to be removed to each other. Here, each of the above-described wires to be removed, old wires, and wires to be relocated corresponds to each of the three-phase wires. When work is performed, work may be performed for each of the three-phase wires, or work may be simultaneously performed on the three-phase wires.

As described above, in the automatic direction switching pendulum-type rotary drive gear ratchet tensioner having an unlimited tension distance adjustment function for indirect live wire work and the uninterruptible power distribution method of performing indirect live wire work using the same, it is possible not only to reliably secure operational stability and simplicity regardless of a distance between a worker and an electric pole, but also to quickly and conveniently perform power distribution work in a state in which power transmission is performed through a wire by structurally improving the automatic direction switching pendulum-type rotary drive gear ratchet tensioner having an unlimited tension distance adjustment function for indirect live wire work.

### INDUSTRIAL APPLICABILITY

The present invention provides an automatic direction switching pendulum-type rotary drive gear ratchet tensioner having an unlimited tension distance adjustment function for indirect live wire work and an uninterruptible power distribution method of performing indirect live wire work using the same, configured to automatically pull or release an insulating rope through forward rotation or reverse rotation of a roller shaft by simply conducting the indirect live wire work without performing a separate rotation direction switching operation. Accordingly, while the indirect live wire work is conducted from a long distance on a wire in a state in which power transmission is continuously performed through the wire, a dip of the wire may be appropriately adjusted, the wire may be pulled to obtain an appropriate dip of the wire and may be fixedly installed on an electric pole, the wire may be removed from the electric pole, and suspension insulator replacement work may be reliably performed with unlimited tension control, thereby making it possible to stably perform wiring work. Additionally, a backstop ratchet ring is capable of preventing reverse rotation of the roller shaft, preventing backlash occurrence when the roller shaft is driven in the reverse direction, and constantly performing bidirectional rotation in a reliable manner, thereby having an effect of securing stability and durability of the device.

1. An automatic direction switching pendulum-type rotary drive gear ratchet tensioner having an unlimited tension distance adjustment function for indirect live wire work, the automatic direction switching pendulum-type rotary drive gear ratchet tensioner comprising:
a body (100) formed of front and rear support plates (110) and (110′) so as to be formed open to an upper side, a lower side, and one side of the body, wherein an idle gear (120) and an interlocking gear (130) having a support roller (131) are engaged with each other and are axially installed at a front middle part and one side of the front support plate (110), the body comprising: an insulating rope connection part (140) formed on one end of the body and a hook (150) formed on the other end of the body; upper and lower guide rollers (160) and (160′) respectively formed on upper and lower portions of the one side of the body; and a lever installation part (111) disposed on a front side of the one side of the body, the lever installation part being configured to restrict the idle gear (120) and the interlocking gear (130);
a rotary operating lever (200) comprising a rotary operating shaft (210), a cam (220), a rotary operating mechanism (230), and a buffer key (240), wherein the rotary operating shaft (210) is axially installed in the lever installation part (111) and has a rotary ring (211), wherein the cam (220) is disposed at a tip portion of the rotary operating shaft (210) and is formed at a location eccentric from a central portion of the tip portion, wherein the rotary operating mechanism (230) is rotatably coupled to the rotary operating shaft (210) at a rear side of the cam (220), has a movable long hole (231) formed in a circumferential direction thereof, and has a locking protrusion (232) formed to protrude from a circumference thereof, and wherein the buffer key (240) connects the rotary operating shaft (210) to the rotary operating mechanism (230);
a gear roller (300) formed between the front and rear support plates (110) and (110′) and disposed on the other side of the body (100), wherein the gear roller is axially installed on a roller shaft (310) protruding forwards from the body, has an insulating rope guide groove (320) formed in a circumference of a middle portion thereof, and has insulating rope pressurization protrusions (330) and (330′) respectively formed on opposite inner sides of the gear roller;
a clutch part (400) disposed on the front side of the body (100) and coupled to a circumference of the roller shaft (310), wherein the clutch part (400) conducts forward or reverse rotation of the roller shaft (310) by preventing reverse rotation of an inner ring and simultaneously performing reverse rotation of the inner ring and an outer ring;
a roller shaft operating plate (500) disposed on a front side of the clutch part (400) and coupled to the circumference of the roller shaft (310), wherein the roller shaft operating plate has saw teeth (510) formed on a circumference of a middle portion thereof;
a pendulum (600) coupled to a rear side of the roller shaft operating plate (500) and formed to protrude toward one side thereof so as to have a horizontal long hole (610) configured to accommodate the cam (220) therein, wherein the pendulum performs reciprocating pendulum motion relative to the roller shaft (310) by operation of the cam (220) and has an automatic revering pawl mounting groove (620) formed in a front surface thereof and disposed between the rotary operating shaft (210) and the roller shaft operating plate (500);
a roller shaft support plate (700) formed to penetrate a front circumference of the roller shaft operating plate (500) and coupled to the pendulum (600), wherein the roller shaft support plate is formed to protrude toward one side thereof;
an automatic reversing pawl (800) having a pawl shaft (801) coupled to the automatic revering pawl mounting groove (620), wherein the automatic reversing pawl interferes with the roller shaft operating plate (500) and performs reciprocating motion thereof so as to provide forward or reverse rotational force of the roller shaft operating plate (500);
a pawl reversing key (900) coupled to the pawl shaft (801) with the automatic reversing pawl (800) and formed to protrude from the roller shaft support plate (700) toward one side thereof, wherein the pawl reversing key interferes with the locking protrusion (232) during rotation of the rotary operating mechanism (230) so as to provide reciprocating rotational force of the automatic reversing pawl (800), and wherein the pawl reversing key has first and second reversing key spring balls (910) and (910′) installed thereon so as to constantly maintain horizontality thereof, wherein the first and second reversing key spring balls are formed to be symmetrical relative to the pawl shaft (801);
a roller shaft rotary lever (1000) disposed on a front side of the roller shaft operating plate (500) and coupled to the roller shaft (310) and the roller shaft operating plate (500);
an insulating rope (1100) configured to enter the one side of the body (100) and to be withdrawn from the body via the gear roller (300), the insulating rope being fixedly connected to the insulating rope connection part (140); and
a wire clip (1200) configured for the insulating rope (1100) withdrawn from the body (100) to pass therethrough, the wire clip being configured to grip a wire, wherein:
the body (100) further comprises an insulating rope pressurization opening/closing means (170) formed to face the support roller (131), the insulating rope pressurization opening/closing means being configured to increase a tension limit by applying pressurizing force to the insulating rope (1100),
the insulating rope pressurization opening/closing means (170) comprises:
a guide groove (171) formed to be open downwards in the front and rear support plates (110) and (110′) of the body (100);
a pressurizing roller (172) formed around a pressurizing roller shaft (172a) configured for both sides thereof to be accommodated in the guide groove (171), the pressurizing roller shaft having a rear side formed to protrude outwards from the rear support plate (110′), the pressurizing roller being configured to apply the pressurizing force to the insulating rope (1100) with the support roller (131) between the front and rear support plates (110) and (110′); and
a spring housing (173) having one side pivotally coupled to a rear side of the rear support plate (110′) so as to be rotatable, the spring housing having a vertical hole (174) formed in the other side thereof and configured for a protruding portion of the pressurizing roller shaft (172a) to pass therethrough, the spring housing having a pressurizing spring (175) elastically installed on an inner side thereof in a vertical direction, the pressuring spring being configured to provide elasticity to the pressurizing roller shaft (172a), the spring housing having a housing hook (176) formed on the other end thereof, and
the body further comprises a pressurization release part (180) comprising a lever housing (181) formed to face the spring housing (173), the lever housing having a horizontal long hole (182) formed in a circumference thereof and being open toward the spring housing (173), a release lever (183) accommodated in the lever housing (181) and formed to penetrate the horizontal long hole (182) so as to protrude outwards, the release lever having a lever hook (184) formed on a front end thereof and configured to be hooked with the housing hook (176), and a spring (185) elastically installed on an inner side of the lever housing (181) and configured to provide protruding force to the release lever (183).

2. The automatic direction switching pendulum-type rotary drive gear ratchet tensioner according to claim 1, wherein:
the buffer key (240) has one side fixed to the rotary operating shaft (210) and the other side located in the movable long hole (231) of the rotary operating mechanism (230),
the buffer key (240) is configured to perform, when rotating the rotary operating shaft (210) in a forward or reverse direction, idle rotation for a predetermined period of time within the movable long hole (231), and
the buffer key (240) is configured to rotate, when caught at one end of the movable long hole (231), the rotary operating mechanism (230).

3. The automatic direction switching pendulum-type rotary drive gear ratchet tensioner according to claim 1, wherein:
the clutch part (400) is formed as a backstop ratchet ring (401),
the backstop ratchet ring (401) comprises:
an outer ring (410) having an inner ring mounting hole (411) formed to penetrate a central portion thereof, wherein the inner ring mounting hole (411) has outer ring saw teeth (412) formed on an inner peripheral surface thereof, wherein the outer ring saw teeth have straight portions and inclined portions continuously formed in a circumferential direction, wherein the outer ring has stopping grooves (413) formed on an outer circumference thereof and disposed with regular intervals therebetween;
a circular ring-shaped inner ring (420) having a roller shaft mounting hole (421) formed to penetrate a central portion thereof and configured to allow the roller shaft (300) to be coupled thereto, wherein the inner ring is mounted in the inner ring mounting hole (411) of the outer ring (410) and has a plurality of bundle pawl mounting grooves (422) formed on a circumference thereof with regular intervals therebetween;
a multi-angle bundle pawl unit (430) having springs(S) each installed in a corresponding one of the bundle pawl mounting grooves (422), wherein the multi-angle bundle pawl unit is operated to protrude outwards by spring elasticity of the spring and is engaged with the outer ring saw teeth (412) of the outer ring (410) so as to provide rotational force in one direction; and
a rotation control lever (440) formed on the front support plate (110) of the body (100) and configured to interfere with a corresponding one of the stopping grooves (413) of the outer ring (410) or to be released therefrom so as to control rotation and stoppage of the outer ring (410), and
the multi-angle bundle pawl unit (430) is formed of plural groups of first, second, and third multi-angle bundle pawls (431), (432), and (433), wherein the respective first, second, and third multi-angle bundle pawls (431), (432), and (433) are configured to be engaged with the outer ring saw teeth (412) of the outer ring (410) at sequential positions respectively having different angles.

4. The automatic direction switching pendulum-type rotary drive gear ratchet tensioner according to claim 3, wherein:
the outer ring saw teeth (412) of the outer ring (410) are formed to protrude inwards so as to have front and rear stepped portions (412a) and (412b) respectively formed at a front side of the outer ring saw teeth and a rear side thereof,
the inner ring (420) has a seating protrusion (423) and a finishing plate support portion (424), wherein the seating protrusion is formed on a circumference of a rear side of the inner ring, is seated on the rear stepped portion (412b) of the outer ring (410), and has a drive gear (423a) formed on a circumference of a rear end thereof and engaged with the idle gear (120), and wherein the finishing plate support portion is formed to protrude from a front side of the inner ring so as to extend from the roller shaft mounting hole (421), and
the finishing plate support portion (424) formed on the front side of the inner ring (420) penetrates a finishing plate (425) having a through hole (425a) formed therein, wherein the finishing plate is seated on and coupled to the front stepped portion (412a) so as to constrain the outer ring (410).

5. The automatic direction switching pendulum-type rotary drive gear ratchet tensioner according to claim 3, wherein:
the first, second, and third multi-angle bundle pawls (431), (432), and (433) are configured to form three groups, wherein each of the three groups is formed of a corresponding one of first, second, and third engagement tools (431a), (432a), and (433a), wherein each of the radially arranged four first engagement tools, four second engagement tools, and four third engagement tools forms one group,
each of the first, second, and third engagement tools (431a), (432a), and (433a) has a corresponding one of the springs(S) respectively installed in the bundle pawl mounting grooves (422) so as to have protruding force, wherein the first, second, and third engagement tools are positioned to intersect each other, and the first, second, and third engagement tools have engagement tool saw teeth (431b), (432b), and (433b) respectively formed at tip portions thereof, wherein each of the engagement tool saw teeth has straight portions and inclined portions formed to be engaged with the outer ring saw teeth (412) of the outer ring (410), and,
when the inner ring (420) is rotated in one direction, the engagement tool saw teeth (431b), (432b), and (433b) of the first, second, and third multi-angle bundle pawls (431), (432), and (433) do not interfere with the outer ring saw teeth (412), thereby enabling idling rotation of the inner ring (420), and when the inner ring is rotated in the other direction, the engagement tool saw teeth (431b), (432b), and (433b) of the first, second, and third multi-angle bundle pawls (431), (432), and (433) are sequentially engaged with the outer ring saw teeth (412), thereby preventing the reverse rotation of the inner ring.

6. The automatic direction switching pendulum-type rotary drive gear ratchet tensioner according to claim 1, wherein:
the automatic reversing pawl (800) has a pair of first and second locking protrusions (810) and (810′) formed on one side thereof and configured to be selectively engaged with the saw teeth (510) of the roller shaft operating plate (500),
the automatic reversing pawl has first locking grooves (821) and (821′) and second locking grooves (822) and (822′) provided around a circumference thereof and formed to be symmetrical with each other,
the automatic reversing pawl has a tapered revering key mounting groove (830) provided at a central portion thereof and formed to extend from the roller shaft operating plate (500) to the rotary operating shaft 210, wherein the revering key mounting groove is configured to allow the pawl revering key (900) to be coupled to the pawl shaft (801) with the automatic reversing pawl (800),
the pendulum (600) has first and second reversing pawl spring balls (840) and (840′) elastically installed therein and configured to control a reciprocating rotation direction of the automatic reversing pawl (800), and
the first reversing pawl spring ball (840) is configured to be caught in any one of the first locking grooves (821) and (821′) of the automatic reversing pawl so as to intersect the any one of the first locking grooves, and the second reversing pawl spring ball (840′) is configured to be caught in any one of the second locking grooves (822) and (822′) of the automatic reversing pawl so as to intersect the any one of the second locking grooves.

7. An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner according to claim 1 is used to perform relocation of an electric pole, replacement of the electric pole, and change of an electric pole route in a state in which power transmission is continuously performed through a wire, the uninterruptible power distribution method comprising the steps of:
performing, within a work section, installation of a new electric pole, installation of components mounted on the new electric pole, and installation of the wire on the new electric pole in a state in which power transmission is not performed through the wire so as to prepare for wiring work in the state in which power transmission is continuously performed through the wire;
respectively fixing, to arm-shaped support members, hooks (150) of automatic direction switching pendulum-type rotary drive gear ratchet tensioners having an unlimited tension distance adjustment function for indirect live wire work (1), each of the gear ratchet tensioners being configured to maintain tension of the wire located between start and end electric poles (10) in the work section, and respectively installing wire clips (1200) of the gear ratchet tensioners on wires to be removed (11) located between the start and end electric poles and located in a region allowing removal of the wires to be removed in the state in which power transmission is not performed through the wire;
connecting one side of each of bypass jumper means (30) to a corresponding one of opposite ends of the wires to be removed (11) in the work section, and connecting the other side of each of the bypass jumper means (30) to a corresponding one of old wires (12) respectively located outside the start and end electric poles (10), thereby connecting the wires to be removed and the old wires to each other through the respective bypass jumper means;
sequentially separating jumper wires (20) of the start and end electric poles (10) in the work section, respectively separating the wires to be removed (11) located between the start and end electric poles (10) from respective portions of the wires to be removed, the respective portions having the wire clips (1200) of the gear ratchet tensioners (1) installed thereon, and securing a safe work space in the state in which power transmission is not performed through the wire;
stretching new wires (13), pulling the new wires to obtain an appropriate dip of each of the new wires, and respectively fixing the new wires to the start and end electric poles;
sequentially connecting, to the respective old wires (12), new jumper wires (21) of the new wires (13) connected to the start and end electric poles (10) in the work section, and separating the installed bypass jumper means (30); and
removing the wires to be removed (11) respectively tensioned by the gear ratchet tensioners (1) and the electric pole.

8. The uninterruptible power distribution method according to claim 7, wherein, when separation of the wires to be removed (11), installation of the new wires (13), and removal of the wires to be removed (11) are performed,
stoppage or rotation of an outer ring (410) is controlled by attachment/detachment operation of a rotation control lever (440) of each of the gear ratchet tensioners (1),
the rotary operating lever (200) is rotated counterclockwise in a state of causing the rotation control lever (440) to be fitted into a stopping groove (413) of the outer ring (410), thereby rotating an inner ring (420) clockwise and pulling the insulating rope (1100) so as to apply the tension to the wire,
the rotary operating lever (200) is rotated clockwise in a state of causing the rotation control lever (440) to be separated from the stopping groove (413) of the outer ring (410), thereby rotating the inner ring (420) and the outer ring (410) counterclockwise and releasing the insulating rope (1100) so as to adjust the tension, and
the tension is adjusted by rotating, in a state of securing a safe distance from the wire, the rotary operating lever (200) in the forward or reverse direction using a stick for live wire work and rotating the gear roller (300) so as to pull or release the wire.

9. The uninterruptible power distribution method according to claim 7, wherein:
the relocation of the electric pole, the replacement of the electric pole, and the change of the electric pole route are performed in the state in which power transmission is continuously performed through the wire, and
the steps are sequentially and repeatedly performed for each of the three-phase wires.

10. An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner according to claim 1 is used to perform, when a branch wire electric pole (10a) is installed in a work section, relocation of an electric pole, replacement of the electric pole, and change of an electric pole route in a state in which power transmission is continuously performed through a wire, the uninterruptible power distribution method comprising the steps of:
performing, within the work section, installation of a new electric pole, installation of components mounted on the new electric pole, and installation of the wire on the new electric pole in a state in which power transmission is not performed through the wire so as to prepare for wiring work in the state in which power transmission is continuously performed through the wire;
respectively fixing, to arm-shaped support members, hooks (150) of automatic direction switching pendulum-type rotary drive gear ratchet tensioners having an unlimited tension distance adjustment function for indirect live wire work (1), each of the gear ratchet tensioners being configured to maintain tension of the wire located between start and end electric poles (10) in the work section in which the branch wire electric pole (10a) is installed, and respectively installing wire clips (1200) of the gear ratchet tensioners on wires to be removed (11) located between the start and end electric poles and located in a region allowing removal of the wires to be removed in the state in which power transmission is not performed through the wire;
connecting one side of each of bypass jumper means (30) to a corresponding one of the wires to be removed (11) respectively located outside the wire clips (1200) of the gear ratchet tensioners (1) respectively installed on the start and end electric poles (10) in the work section, and connecting the other side of each of the bypass jumper means (30) to a corresponding one of old wires (12) respectively located outside the start and end electric poles (10), thereby connecting the wires to be removed and the old wires to each other through the respective bypass jumper means;
sequentially separating jumper wires (20) of the start and end electric poles (10) in the work section, respectively separating the wires to be removed (11) located between the start and end electric poles (10) from respective portions of the wires to be removed, the respective portions having the wire clips (1200) of the gear ratchet tensioners (1) installed thereon, and securing a safe work space in the state in which power transmission is not performed through the wire;
stretching new wires (13), pulling the new wires to obtain an appropriate dip of each of the new wires, and respectively fixing the new wires to the start and end electric poles;
respectively fixing, to the arm-shaped support members, the hooks (150) of the gear ratchet tensioners (1), each of the gear ratchet tensioners being configured to maintain tension of the wire located between the branch wire electric poles (10a) in the work section, and respectively installing wire clips (1200) of the gear ratchet tensioners on wires to be removed (11a) located between the branch wire electric poles and located in a region allowing removal of the wires to be removed in the state in which power transmission is not performed through the wire;
connecting one side of each of the bypass jumper means (30) to a corresponding one of the wires to be removed (11a) respectively located outside the wire clips (1200) of the gear ratchet tensioners (1) installed on the branch wire electric pole (10a), and connecting the other side of each of the bypass jumper means (30) to a corresponding one of old wires (12a) located outside the work section of the branch wire electric pole (10a), thereby connecting the wires to be removed and the old wires to each other through the respective bypass jumper means;
sequentially separating jumper wires (20a) of the branch wire electric pole (10a), separating the wires to be removed (11a) located between the branch wire electric poles (10a) from respective portions of the wires to be removed, the respective portions having the wire clips (1200) of the gear ratchet tensioners (1) installed thereon, and securing a safe work space in the state in which power transmission is not performed through the wire;
stretching new wires (13a), pulling the new wires to obtain an appropriate dip of each of the new wires, and fixing the new wires to the respective branch wire electric poles (10a);
sequentially connecting, to the respective old wires (12) and (12a), new jumper wires (21) and (21a) of the new wires (13) and (13a) respectively connected to the start and end electric poles (10) and the branch wire electric poles (10a), and separating the installed bypass jumper means (30); and
removing the wires to be removed (11) and (11a) respectively tensioned by the wire clips (1200) of the gear ratchet tensioners (1) and the electric pole.

11. The uninterruptible power distribution method according to claim 10, wherein, when separation of the wires to be removed (11) and (11a) located between the electric poles, installation of the new wires (13) and (13a), and removal of the wires to be removed (11) and (11a) are performed,
stoppage or rotation of an outer ring (410) is controlled by attachment/detachment operation of a rotation control lever (440) of each of the gear ratchet tensioners (1),
the rotary operating lever (200) is rotated counterclockwise in a state of causing the rotation control lever (440) to be fitted into a stopping groove (413) of the outer ring (410), thereby rotating an inner ring (420) clockwise and pulling the insulating rope (1100) so as to apply the tension to the wire,
the rotary operating lever (200) is rotated clockwise in a state of causing the rotation control lever (440) to be separated from the stopping groove (413) of the outer ring (410), thereby rotating the inner ring (420) and the outer ring (410) counterclockwise and releasing the insulating rope (1100) so as to adjust the tension, and
the tension is adjusted by rotating, in a state of securing a safe distance from the wire, the rotary operating lever (200) in the forward or reverse direction using a stick for live wire work and rotating the gear roller (300) so as to pull or release the wire.

12. The uninterruptible power distribution method according to claim 10, wherein, when a plurality of branch wires is installed in the work section,
the step of stretching the new wires (13a), pulling the new wires to obtain the appropriate dip of each of the new wires, and fixing the new wires to the respective branch wire electric poles (10a) is repeatedly performed for each of the branch wires.

13. The uninterruptible power distribution method according to claim 10, wherein:
when the branch wire electric pole (10a) is installed in the work section, the relocation of the electric pole, the replacement of the electric pole, and the change of the electric pole route are performed in the state in which power transmission is continuously performed through the wire, and
the steps are sequentially and repeatedly performed for each of the three-phase wires.

14. An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner according to claim 1 is used to perform, when an electric pole for a transformer (10b) is installed in a work section, relocation of an electric pole, replacement of the electric pole, and change of an electric pole route in a state in which power transmission is continuously performed through a wire, the uninterruptible power distribution method comprising the steps of:
performing, within a work section, installation of a new electric pole, installation of components mounted on the new electric pole, and installation of the wire on the new electric pole in a state in which power transmission is not performed through the wire so as to prepare for wiring work in the state in which power transmission is continuously performed through the wire;
respectively fixing, to arm-shaped support members, hooks (150) of automatic direction switching pendulum-type rotary drive gear ratchet tensioners having an unlimited tension distance adjustment function for indirect live wire work (1), each of the gear ratchet tensioners being configured to maintain tension of the wire located between start and end electric poles (10) in the work section, and respectively installing wire clips (1200) of the gear ratchet tensioners on wires to be removed (11) located between the start and end electric poles and located in a region allowing removal of the wires to be removed in the state in which power transmission is not performed through the wire;
connecting one side of each of bypass jumper means (30) to a corresponding one of the wires to be removed (11) respectively located outside the wire clips (1200) of the gear ratchet tensioners (1) installed within the start and end electric poles (10) in the work section, and connecting the other side of each of the bypass jumper means (30) to a corresponding one of old wires (12) respectively located outside the start and end electric poles (10), thereby connecting the wires to be removed and the old wires to each other through the respective bypass jumper means;
sequentially separating jumper wires (20) of the start and end electric poles (10) in the work section, respectively separating the wires to be removed (11) located between the start and end electric poles (10) from respective portions of the wires to be removed, the respective portions having the wire clips (1200) of the gear ratchet tensioners (1) installed thereon, and securing a safe work space in the state in which power transmission is not performed through the wire;
stretching new wires (13), pulling the new wires to obtain an appropriate dip of each of the new wires, and respectively fixing the new wires to the start and end electric poles;
sequentially connecting, to the respective old wires (12), new jumper wires (21) of the new wires (13) connected to the start and end electric poles (10) in the work section;
connecting a secondary low-voltage cable (70a) of an uninterruptible transformer apparatus (60) to a secondary low-voltage line (80) of an electric pole transformer (50) installed by installing the uninterruptible transformer apparatus (60) on the electric pole for a transformer (10b) located within the work section for a bypass connection step, separating a secondary drop wire (52) of the electric pole transformer (50), opening an electric pole transformer COS (51), and removing the electric pole transformer (50);
reusing the removed electric pole transformer on a new electric pole (10′) or installing a new electric pole transformer (50a) on the new electric pole, installing a COS (51a) of the new electric pole transformer (50a), installing a secondary drop wire (52a) of the new electric pole transformer (50a), turning off the uninterruptible transformer apparatus (60), separating the low-voltage cable (70a) of the uninterruptible transformer apparatus (60), and completing work of newly installing and relocating the electric pole transformer located in the work section; and
separating the bypass jumper means (30) respectively installed on the start and end electric poles (10) and removing the wires to be removed (11) respectively tensioned by the wire clips (1200) of the gear ratchet tensioners (1) installed within the start and end electric poles (10) in the work section, the electric pole, and the uninterruptible transformer apparatus (60).

15. The uninterruptible power distribution method according to claim 14, wherein, when separation of the wires to be removed (11) located between the electric poles, installation of the new wires (13), and removal of the wires to be removed (11) are performed,
stoppage or rotation of an outer ring (410) is controlled by attachment/detachment operation of a rotation control lever (440) of each of the gear ratchet tensioners (1),
the rotary operating lever (200) is rotated counterclockwise in a state of causing the rotation control lever (440) to be fitted into a stopping groove (413) of the outer ring (410), thereby rotating an inner ring (420) clockwise and pulling the insulating rope (1100) so as to apply the tension to the wire,
the rotary operating lever (200) is rotated clockwise in a state of causing the rotation control lever (440) to be separated from the stopping groove (413) of the outer ring (410), thereby rotating the inner ring (420) and the outer ring (410) counterclockwise and releasing the insulating rope (1100) so as to adjust the tension, and
the tension is adjusted by rotating, in a state of securing a safe distance from the wire, the rotary operating lever (200) in the forward or reverse direction using a stick for live wire work and rotating the gear roller (300) so as to pull or release the wire.

16. The uninterruptible power distribution method according to claim 14, wherein, when a plurality of the electric poles for transformers (10b) is located within the work section,
in the step of installing the uninterruptible transformer apparatus (60) on the electric pole for a transformer (10b) located within the work section,
the step of reusing the removed electric pole transformer on the new electric pole (10′), replacing the old electric pole transformer with the new electric pole transformer, installing the new electric pole transformer on the new electric pole, and relocating the electric pole transformer in the state in which power transmission is continuously performed through the wire is repeatedly performed for each of the electric poles for transformers (10b).

17. The uninterruptible power distribution method according to claim 14, wherein:
when the electric pole for a transformer (10b) is installed in the work section, the relocation of the electric pole, the replacement of the electric pole, and the change of the electric pole route are performed in the state in which power transmission is continuously performed through the wire, and
the steps are sequentially and repeatedly performed for each of the three-phase wires.

18. An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner according to claim 1 is used to perform, when a branch wire electric pole (10a) and an electric pole for a transformer (10b) are installed in a work section, relocation of an electric pole, replacement of the electric pole, and change of an electric pole route in a state in which power transmission is continuously performed through a wire, the uninterruptible power distribution method comprising the steps of:
performing, within the work section, installation of a new electric pole, installation of components mounted on the new electric pole, and installation of the wire on the new electric pole in a state in which power transmission is not performed through the wire so as to prepare for wiring work in the state in which power transmission is continuously performed through the wire;
respectively fixing, to arm-shaped support members, hooks (150) of automatic direction switching pendulum-type rotary drive gear ratchet tensioners having an unlimited tension distance adjustment function for indirect live wire work (1), each of the gear ratchet tensioners being configured to maintain tension of the wire located between start and end electric poles (10) in the work section in which the branch wire electric pole (10a) is installed, and respectively installing wire clips (1200) of the gear ratchet tensioners on wires to be removed (11) located between the start and end electric poles and located in a region allowing removal of the wires to be removed in the state in which power transmission is not performed through the wire;
connecting one side of each of bypass jumper means (30) to a corresponding one of the wires to be removed (11) respectively located outside the wire clips (1200) of the gear ratchet tensioners (1) respectively installed on the start and end electric poles (10) in the work section, and connecting the other side of each of the bypass jumper means (30) to a corresponding one of old wires (12) respectively located outside the start and end electric poles (10), thereby connecting the wires to be removed and the old wires to each other through the respective bypass jumper means;
sequentially separating jumper wires (20) of the start and end electric poles (10) in the work section, and respectively separating the wires to be removed (11) located between the start and end electric poles (10) from respective portions of the wires to be removed, the respective portions having the wire clips (1200) of the gear ratchet tensioners (1) installed thereon;
removing the wires to be removed (11) from the respective portions of the wires to be removed within the start and end electric poles (10) in the work section to suspension insulators on the electric poles (10) so as to secure a safe work space in the state in which power transmission is not performed through the wire, stretching new wires (13), pulling the new wires to obtain an appropriate dip of each of the new wires, and respectively fixing the new wires to the start and end electric poles;
respectively installing wire clips (1200) of the gear ratchet tensioners (1), each of the gear ratchet tensioners being configured to maintain tension of the wire located between the branch wire electric poles (10a) in the work section, on wires to be removed (11a) located between the branch wire electric poles and located in a region allowing removal of the wires to be removed in the state in which power transmission is not performed through the wire;
connecting one side of each of the bypass jumper means (30) to a corresponding one of the wires to be removed (11a) respectively located outside the wire clips (1200) of the gear ratchet tensioners (1) installed on the branch wire electric pole (10a), and connecting the other side of each of the bypass jumper means (30) to a corresponding one of old wires (12a) located outside the work section of the branch wire electric pole (10a), thereby connecting the wires to be removed and the old wires to each other through the respective bypass jumper means;
sequentially separating jumper wires (21a) of the branch wire electric pole (10a), and respectively separating the wires to be removed (11a) located between the branch wire electric poles (10a) from respective portions of the wires to be removed, the respective portions having the wire clips (1200) of the gear ratchet tensioners (1) installed thereon;
removing the wires to be removed (11a) from the respective portions of the wires to be removed within the branch wire electric poles (10a) to suspension insulators on the branch wire electric poles (10a) so as to secure a safe work space in the state in which power transmission is not performed through the wire, stretching new wires (13a), pulling the new wires to obtain an appropriate dip of each of the new wires, and fixing the new wires to the respective branch wire electric poles;
sequentially connecting, to the respective old wires (12) and (12a), new jumper wires (21) and (21a) of the new wires (13) and (13a) respectively connected to the start and end electric poles (10) and the branch wire electric poles (10a);
connecting a secondary low-voltage cable (70a) of an uninterruptible transformer apparatus (60) to a secondary low-voltage line (80) of an electric pole transformer (50) installed by installing the uninterruptible transformer apparatus (60) on the electric pole for a transformer (10b) located within the work section for a bypass connection step, separating a secondary drop wire (52) of the electric pole transformer (50), opening an electric pole transformer COS (51), and removing the electric pole transformer (50);
reusing the removed electric pole transformer on a new electric pole (100b) or installing a new electric pole transformer (50a) on the new electric pole, installing a COS (51a) of the new electric pole transformer (50a), installing a secondary drop wire (52a) of the new electric pole transformer (50a), turning off the uninterruptible transformer apparatus (60), separating the low-voltage cable (70a) of the uninterruptible transformer apparatus (60), and completing work of newly installing and relocating the electric pole transformer located in the work section; and
separating the bypass jumper means (30) respectively installed on the start and end electric poles (10) and the branch wire electric poles (10a), and removing the wires to be removed (11) and (11a) respectively tensioned by the wire clips (1200) of the gear ratchet tensioners (1) respectively installed within the start and end electric poles (10) in the work section and the branch wire electric poles (10a), the electric pole, and the uninterruptible transformer apparatus (60).

19. The uninterruptible power distribution method according to claim 18, wherein, when separation of the wires to be removed (11) and (11a) located between the electric poles and removal of the wires to be removed (11) and (11a) are performed,
stoppage or rotation of an outer ring (410) is controlled by attachment/detachment operation of a rotation control lever (440) of each of the gear ratchet tensioners (1),
the rotary operating lever (200) is rotated counterclockwise in a state of causing the rotation control lever (440) to be fitted into a stopping groove (413) of the outer ring (410), thereby rotating an inner ring (420) clockwise and pulling the insulating rope (1100) so as to apply the tension to the wire,
the rotary operating lever (200) is rotated clockwise in a state of causing the rotation control lever (440) to be separated from the stopping groove (413) of the outer ring (410), thereby rotating the inner ring (420) and the outer ring (410) counterclockwise and releasing the insulating rope (1100) so as to adjust the tension, and
the tension is adjusted by rotating, in a state of securing a safe distance from the wire, the rotary operating lever (200) in the forward or reverse direction using a stick for live wire work and rotating the gear roller (300) so as to pull or release the wire.

20. The uninterruptible power distribution method according to claim 18, wherein:
when a plurality of the branch wires and a plurality of the electric poles for transformers are installed in the work section,
in the step of respectively installing the gear ratchet tensioners (1) on the branch wire electric poles (10a), the step of stretching the new wires (13a) of the branch wires, pulling the new wires to obtain the appropriate dip of each of the new wires, and fixing the new wires to the respective branch wire electric poles (10a) is repeatedly performed for each of the branch wires, and
when a plurality of the electric poles for transformers (10b) is located within the work section,
in the step of installing the uninterruptible transformer apparatus (60) on the electric pole for a transformer (10b) located within the work section,
the step of reusing the removed electric pole transformer on the new electric pole (10′), replacing the old electric pole transformer with the new electric pole transformer, installing the new electric pole transformer on the new electric pole, and relocating the electric pole transformer in the state in which power transmission is continuously performed through the wire is repeatedly performed for each of the electric poles for transformers (10b).

21. The uninterruptible power distribution method according to claim 18, wherein:
when the branch wire electric pole (10a) and the electric pole for a transformer (10b) are installed in the work section, the relocation of the electric pole, the replacement of the electric pole, and the change of the electric pole route are performed in the state in which power transmission is continuously performed through the wire, and
the steps are sequentially and repeatedly performed for each of the three-phase wires.

22. An uninterruptible power distribution method of performing indirect live wire work using an automatic direction switching pendulum-type rotary drive gear ratchet tensioner having an unlimited tension distance adjustment function for indirect live wire work, wherein the automatic direction switching pendulum-type rotary drive gear ratchet tensioner according to claim 1 is used to perform replacement work for electric poles having a distance therebetween in a state in which power transmission is continuously performed through a wire, the uninterruptible power distribution method comprising:
an electric pole installation step of installing a new electric pole (10′) in a work section in a state in which power transmission is not performed through the wire;
a step of connecting, through a bypass jumper means (30), wires to be relocated (14) and (14′) respectively located on opposite sides of an electric pole to be removed (10) to each other;
a step of sequentially separating jumper wires (20) configured to respectively connect the wires to be relocated (14) and (14′) respectively located on the opposite sides of the electric pole to be removed (10) so as to secure a safe working space;
a first gear ratchet tensioner installation step of fixing, to an arm-shaped support member, a hook (150) of an automatic direction switching pendulum-type rotary drive gear ratchet tensioner having an unlimited tension distance adjustment function for indirect live wire work (1), the gear ratchet tensioner being configured to maintain tension of the wire and located on one side of the new electric pole (10′), and grabbing, by a wire clip (1200), the wire to be relocated (14) located on one side of the electric pole to be removed so as to fixedly install the wire clip thereon;
a first wire relocation step of separating, from the electric pole to be removed (10), the fixed wire to be relocated (14) located on one side of the electric pole to be removed while adjusting tension of the gear ratchet tensioner (1) and fixedly connecting the separated wire to be relocated to one side of the new electric pole (10′);
a first gear ratchet tensioner removal step of removing the gear ratchet tensioner (1) configured to hold and fix the relocated wire to be relocated (14);
a second gear ratchet tensioner installation step of fixing, to the arm-shaped support member, the hook (150) of the automatic direction switching pendulum-type rotary drive gear ratchet tensioner having an unlimited tension distance adjustment function for indirect live wire work (1), the gear ratchet tensioner being configured to maintain tension of the wire and located on the other side of the new electric pole (10′), and grabbing, by the wire clip (1200), the wire to be relocated (14′) located on the other side of the electric pole to be removed so as to fixedly install the wire clip thereon;
a second wire relocation step of separating, from the electric pole to be removed (10), the fixed wire to be relocated (14′) located on the other side of the electric pole to be removed while adjusting the tension of the gear ratchet tensioner (1) and fixedly connecting the separated wire to be relocated to the other side of the new electric pole (10′);
a second gear ratchet tensioner removal step of removing the gear ratchet tensioner (1) configured to hold and fix the relocated wire to be relocated (14′);
a step of connecting, by the existing jumper wire (20) or a new jumper wire (21), the wires to be relocated (14) and (14′) respectively relocated to opposite sides of the new electric pole and separating the installed bypass jumper means (30); and
an electric pole removal step of removing the electric pole to be removed (10).

23. The uninterruptible power distribution method according to claim 22, wherein:
in the first wire relocation step or the second wire relocation step, other two-phase wires to be relocated (14) and (14′) are sequentially and repeatedly relocated so as to complete relocation of the three-phase wires to be relocated, and
in the step of separating the bypass jumper means (30), the bypass jumper means (30) is separated in a state in which the three-phase wires to be relocated (14) and (14′) are relocated and then are sequentially connected to the new electric pole by the existing jumper wire (20) or the new jumper wire (21).

24. The uninterruptible power distribution method according to claim 22, wherein, when the wire to be relocated (10) is separated and installed,
stoppage or rotation of an outer ring (410) is controlled by attachment/detachment operation of a rotation control lever (440) of each of the gear ratchet tensioners (1),
the rotary operating lever (200) is rotated counterclockwise in a state of causing the rotation control lever (440) to be fitted into a stopping groove (413) of the outer ring (410), thereby rotating an inner ring (420) clockwise and pulling the insulating rope (1100) so as to apply the tension to the wire,
the rotary operating lever (200) is rotated clockwise in a state of causing the rotation control lever (440) to be separated from the stopping groove (413) of the outer ring (410), thereby rotating the inner ring (420) and the outer ring (410) counterclockwise and releasing the insulating rope (1100) so as to adjust the tension, and
the tension is adjusted by rotating, in a state of securing a safe distance from the wire, the rotary operating lever (200) in the forward or reverse direction using a stick for live wire work and rotating the gear roller (300) so as to pull or release the wire.
